(19) United States
(12) Patent Application Publication
(10) Pub. No.: US 2024/0321471 A1
(43) Pub. Date: Sep. 26, 2024

(54) SHIELDING APPLICATIONS OF METAL BORIDES AND COMPOSITES THEREOF

(71) Applicant: SuperMetalix, Inc., Sunny Isles Beach, FL (US)

(72) Inventor: Christopher Lawrence TURNER, Los Angeles, CA (US)

(21) Appl. No.: 18/572,963

(22) PCT Filed: Jun. 27, 2022
(86) PCT No.: PCT/US2022/035152

§ 371 Date: Dec. 21, 2023

Related U.S. Application Data
(60) Provisional application No. 63/215,518, filed on Jun. 27, 2021.

(51) Int. Cl. G21F 1/06; C04B 35/58; C04B 35/657

(52) U.S. Cl. CPC G21F 1/06; C04B 35/58064; C04B 35/657; C04B 2235/3813; C04B 2235/3821; C04B 2235/3826

(57) ABSTRACT

Disclosed herein are applications of metal borides and metal boride composites. Such applications include uses as materials for neutron shielding, radiation shielding, electromagnetic shielding, physical shielding such as armor, and wear resistance to mechanical and thermal cycling.

### CROSS-REFERENCE

This application claims the benefit of U.S. Provisional Application No. 63/215,518, filed Jun. 27, 2021, which is hereby incorporated by reference in its entirety herein.

### BACKGROUND OF THE INVENTION

There are substantial challenges to developing radiation shielding. For example, heavy metals can be used for shielding, but are expensive to source, difficult to work or manipulate such as shaping, forming, machining, heavy, and/or potentially toxic.

### SUMMARY OF THE INVENTION

Disclosed herein are radiation shielding devices and compositions comprising a composite matrix utilizing W₁₋ₓMoₓB₄ and WB₄ compositions. The radiation shielding devices and compositions disclosed herein can be used to shield against one or more of various forms of radiation including neutrons, alpha radiation, beta radiation, and electromagnetic radiation such as X-rays and gamma radiation. Moreover, such radiation shields can also have a hardness and/or toughness that provide resistance to wear such as arising from mechanical and/or thermal cycling (e.g., within a nuclear reactor). The physical composition of the radiation shield can take on a variety of forms including, as non-limiting illustrations, a solid, densified material (e.g., solely tungsten tetraboride composition and binder), optionally with a porosity threshold (e.g., porosity no greater than 50%), a solid material comprised of tungsten tetraboride and binder in a polymer (e.g., plastic) matrix (e.g., hard particles dispersed or “cast” in a plastic body similar to a fiberglass reinforced plastic), a dispersion of tungsten tetraboride and binder in an organic carrier (e.g., like epoxy, resin, or paint) that may be applied to a surface as an adhered coating. The composite matrix can have a structure of Formula I (W₁₋ₓMoₓB₄), II ((W₁₋ₓMoₓB₄)_{z}(Q)ₙ), III ((W₁₋ₓMoₓB₄)_{z}(T)_{q}), or IV ((W₁₋ₓMoₓB₄)_{z}(T)_{q}(Q)ₙ).

Such shielding devices and compositions can be used to block or absorb radiation in a variety of environments including a vacuum (e.g., space or vacuum chamber), a vacuum in the presence of an electromagnetic radiation source (e.g., plasma), a vacuum in the presence of a neutron source (e.g., a nuclear reactor), ambient pressure and high temperature, and transient high pressure and high temperature in a reductive or oxidative environment The shielding devices or materials can be shaped or configured according to the specific shielding purpose. For example, the radiation shielding device can be configured as one or more plates (e.g., high aspect ratio x/y vs. z) that is flat or curved (e.g., to follow a radius, such as lining a cylinder), cylinders (both hollow and solid), tiles (small plates that are flat, partially spherical, conical, or cylindrical), or short, hollow cylinders.

A protective layer of the composite may also be applied in the form of a paint or resin to the surface of materials or equipment susceptible to degradation by radiation exposure. The protective layer may also be fabricated and attached to the material or equipment. One additional benefit of the composite matrices described herein is the compatibility with key manufacturing techniques such as Electrical Discharge Manufacturing (EDM). EDM is a favorable manufacturing technique to its high precision and low cost. With the use of EDM, intricate and abnormally shaped materials can precisely fabricated to coat delicate technical machinery, such as that used in fusion reactors. Existing technologies used for radiation shieling, such as pure B₄C and pure cubic boronitirde, are incompatible with EDM due to the limited conductivity of the material.

In one aspect, disclosed herein is a method of shielding a protected target, the method comprising:
a) positioning a radiation shield comprising a composite matrix of Formula I, Formula II, Formula III, or Formula IV in the path of a potential source of radiation travelling to a protected target, wherein the radiation comprises atomic bombardment, nuclear radiation, or electromagnetic radiation, and optionally physical impingement; and
b) reducing the exposure of the protected target to the radiation, wherein a composite matrix of Formula I, Formula II, Formula III, or Formula IV comprises:

W₁₋ₓMoₓB₄ (Formula I);

(W₁₋ₓMoₓB₄)_{z}(Q)ₙ (Formula II);

(W₁₋ₓMoₓB₄)_{z}(T)_{q} (Formula III); or

(W₁₋ₓMoₓB₄)_{z}(T)_{q}(Q)ₙ (Formula IV),

wherein,
M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al);
Q is one or more ceramics, wherein each of the one or more ceramics comprises at least two elements, and at least one of the two elements is B (boron), C (carbon), Si (silicon), N (nitrogen), or O (oxygen);
T is (i) at least one element that comprises a group 4, 5, 6, 7, 8, 9, 10, 11, 12, 13, or 14 transition metal element in the Periodic Table of Elements or (ii) an alloy which is a combination of two or more group 4, 5, 6, 7, 8, 9, 10, 11, 12, 13, or 14 transition metal elements in the Periodic Table of Elements;
x is a molar ratio from 0 to 0.999;
z is a volume percent from 0.001 to 0.999 (0.1% to 99.9%);
n is a volume percent from 0.001 to 0.999 (0.1% to 99.9%);
q is a volume percent from 0.001 to 0.999 (0.1% to 99.9%);
the sum of n and z is 1 (100%) in Formula II;
the sum of z and q is 1 (100%) in Formula III;
the sum of z, q, and n is 1 (100%) in Formula IV;
and optionally, the boron content of a composite matrix of Formula I, Formula II, Formula III, or Formula IV is isotopically enriched with boron-10 (¹⁰B), and
wherein x is from 0.001 to 0.999 for a composite matrix of Formula I.

In some embodiments, W₁₋ₓMoₓB₄ is a crystalline solid characterized by at least one X-ray diffraction pattern reflection at 2 theta=24.2±±0.3.

In some embodiments, the crystalline solid is further characterized by at least one X-ray diffraction pattern reflection at 2 theta=34.5±±0.3 or 45.1±±0.3. In some embodiments, the crystalline solid is further characterized by at least one X-ray diffraction pattern reflection at 2 theta=47.5±0.3, 61.8±0.3, 69.2±0.3, 69.4±0.3, 79.7±0.3, 89.9 0.3, or 110.2±0.3. In some embodiments, the crystalline solid is further characterized by at least five X-ray diffraction pattern reflections at 2 theta=28.1±0.3, 34.5±0.3, 42.5±0.3, 45.1±0.3, 47.5±0.3, 55.9±0.3, 61.8±0.3, 69.2±0.3, 69.4±0.3, 79.7±0.3, 89.9±0.3, or 110.2±0.3.

In some embodiments, x is 0.001 to 0.6. In some embodiments, x is 0.001 to 0.4. In some embodiments, M is one or more of Cr, Ta, Mo, or Mn. In some embodiments, M is Cr; Mn; Mo; Ta and Cr; or Ta and Mo. In some embodiments, M is Cr, and x is at least 0.001 and less than 0.4. In some embodiments, x is at least 0.01 and less than 0.3. In some embodiments, x is at least 0.01 and less than 0.10. In some embodiments, x is about 0.05. In some embodiments, M is Mo, and x is at least 0.001 and less than 0.4. In some embodiments, x is at least 0.001 and less than 0.2.

In some embodiments, x is at least 0.001 and less than 0.05. In some embodiments, x is about 0.025. In some embodiments, M is Mn, and x is at least 0.001 and less than 0.4. In some embodiments, x is at least 0.001 and less than 0.2. In some embodiments, x is at least 0.001 and less than 0.06.

In some embodiments, x is about 0.03. In some embodiments, M is Cr and Ta, and x is at least 0.001 and less than 0.4. In some embodiments, x is at least 0.001 and less than 0.3. In some embodiments, x is at least 0.03 and less than 0.2. In some embodiments, x is about 0.07.

In some embodiments, W₁₋ₓMoₓB₄ is W_{0.93}Ta_{0.02}Cr_{0.05}B₄. In some embodiments, M is Ta and Mo, and x is at least 0.01 and less than 0.4. In some embodiments, x is at least 0.001 and less than 0.3. In some embodiments, x is about 0.06. In some embodiments, wherein W₁₋ₓMoₓB₄ is W_{0.94}Ta_{0.02}Mo_{0.0.04}B₄. In some embodiments, x is 0.

In some embodiments, wherein the one or more ceramics comprises at least B, C, Si, or N. In some embodiments, the one or more ceramics comprises at least B, C, or Si. In some embodiments, the one or more ceramics comprises at least O. In some embodiments, the one or more ceramics comprises at least B. In some embodiments, the one or more ceramics comprises at least C. In some embodiments, the one or more ceramics comprises at least N. In some embodiments, the one or more ceramics comprises at least Si. In some embodiments, the one or more ceramics comprises one or more metal selected from Ti, Zr, Hf, V, Nb, Ta, Cr, Mo, W, Mn, Re, Fe, and Ru. In some embodiments, the one or more ceramics comprises one or more metal selected from Cr, Mo, W, Mn, Re, Fe, and Ru. In some embodiments, the one or more ceramics comprises one or more metal selected from Ti, Zr, Hf, V, Nb, and Ta. In some embodiments, Q is one or more ceramics selected from TiB₂, TaB₂, FeB₄, RuB₂, Ru₂B₃, ReB₂, B₄C, B₄Si, cubic-BN, BCN, BC₂N, B₂O₃, B₆O, TiC, ZrC, VC, NbC, NbC₂, TaC, Cr₃C₂, MoC, MoC₂, SiC, TiN, ZrN, TiSi, TiSi₂, Ti₅Si₃, SiAlON, Si₃N₄, TiO₂, ZrO₂, Al₂O₃, and SiO₂. In some embodiments, Q is one or more ceramics selected from TiB₂, TaB₂, FeB₄, RuB₂, Ru₂B₃, ReB₂, B₄C, B₄Si, cubic-BN, BCN, BC₂N, B₂O₃, and B₆O. In some embodiments, Q is one or more ceramics selected from B₄C, BCN, BC₂N, TiC, ZrC, VC, NbC, NbC₂, TaC, MoC, MoC₂, and SiC. In some embodiments, Q is one or more ceramics selected from cubic-BN, BCN, BC₂N, TiN, ZrN, SiAlON, and Si₃N₄. In some embodiments, Q is one or more ceramics selected from B₂O₃, B₆O, TiO₂, ZrO₂, Al₂O₃, and SiO₂. In some embodiments, Q is one or more ceramics selected from SiC, TiSi, TiSi₂, Ti₅Si₃, SiAlON, Si₃N₄, and SiO₂. In some embodiments, Q is one or more ceramics selected from TiB₂, SiC, or B₄C. In some embodiments, the M is Cr; x is 0.05; and Q is a ceramic selected from TiB₂, SiC, or B₄C, and n is 5-20%.

In some embodiments, n is from 1% to 50%. In some embodiments, n is from 5% to 40%. In some embodiments, n is from 10% to 30%. In some embodiments, n is from 10% to 20%. In some embodiments, n is from 10% to 15%.

In some embodiments, the Vicker's Hardness of the composite is from 18-30 GPa measured at 9.8 N (1 kg force load). In some embodiments, the Palmquist Toughness of the composite is from 1-10 MPam^{1/2}. In some embodiments, the Palmquist Toughness of the composite is from 2-8. In some embodiments, the density is from 3-8 g/cm³. In some embodiments, the density is from 5-7 g/cm³.

In some embodiments, T is an alloy comprising two or more Group 4, 5, 6, 7, 8, 9, 10, 11, 12, 13, or 14 elements. In some embodiments, T is an alloy comprising two to eight Group 4, 5, 6, 7, 8, 9, 10, 11, 12, 13, or 14 elements. In some embodiments, T is an alloy comprising at least one Group 8, 9, 10, 11, 12, 13 or 14 element in the Periodic Table of Elements. In some embodiments, T is an alloy comprising two or more, three or more, four or more, five or more, or six or more Group 4, 5, 6, 7, 8, 9, 10, 11, 12, 13, or 14 elements in the Periodic Table of Elements. In some embodiments, T is an alloy comprising at least one element selected from Cu, Ni, Co, Fe, Si, Al and Ti, or any combinations thereof. In some embodiments, T is an alloy comprising at least one element selected from Co, Ni, Fe, Si, Ti, W, Sn, Ta, or any combinations thereof. In some embodiments, T is an alloy comprising Co. In some embodiments, T is an alloy comprising Fe. In some embodiments, T is an alloy comprising Ni. In some embodiments, T is an alloy comprising Co and Ni. In some embodiments, T is an alloy comprising Co, Fe, and Ni. In some embodiments, T is an alloy comprising Sn. In some embodiments, T is an alloy comprising W. In some embodiments, T is an alloy comprising Cu. In some embodiments, T is an alloy comprising Al. In some embodiments, T is an alloy comprising Cr. In some embodiments, T is an alloy comprising Ti. In some embodiments, T is an alloy comprising from about 40 wt. % to about 60 wt. % of Cu, from about 10 wt. % to about 20 wt. % of Co, from 0 wt. % to about 7 wt. % of Sn, from about 5 wt. % to about 15 wt. % of Ni, and from about 10 wt. % to about 20 wt. % W. In some embodiments, T is an alloy comprising about 50 wt. % of Cu, about 20 wt. % of Co, about 5 wt. % of Sn, about 10 wt. % of Ni, and about 15 wt. % of W. In some embodiments, q is from 1% to 80%. In some embodiments, q is from 1% to 50%. In some embodiments, q is from 1% to 30%. In some embodiments, q is from 5% to 30%.

In some embodiments, the radiation is a byproduct of an atomic fusion or atomic fission reaction. In some embodiments, the radiation is atomic bombardment. In some embodiments, atomic bombardment comprises the bombardment of any atom, particle, or energy emitted from an atomic fusion or atomic fission reaction. In some embodiments, atomic bombardment comprises bombardment by atoms, the particles that make up atoms, or any combination thereof. In some embodiments, the particles that make up an atom comprise composite particles or elementary particles. In some embodiments, composite particles comprise neutrons, protons, or mesons. In some embodiments, an elementary particle comprises electrons, photons, or muons. In some embodiments, the atomic bombardment is neutron bombardment. In some embodiments, the neutron bombardment is a byproduct of a thermonuclear fusion reaction. In some embodiments, the thermonuclear fusion reaction is a plasma fusion reaction. In some embodiments, the thermonuclear fusion reaction occurs within a fusion reactor with magnetic confinement. In some embodiments, the fusion reactor is a toroidal reactor such as a Z-pinch reactor, stellarator reactor, tokamak reactor, or compacted toroid reactor. In some embodiments, the fusion reactor is tokamak reactor. In some embodiments, the neutron bombardment is a byproduct of nuclear fission or nuclear fusion. In some embodiments, the neutron bombardment is a byproduct of radioactive decay.

In some embodiments, the radiation is a byproduct of a fusion reaction produced by thermonuclear fusion. In some embodiments, the thermonuclear fusion is inertial confinement fusion, inertial electrostatic confinement, beam-beam/beam-target fusion, muon-catalyzed fusion, antimatter initialized fusion, pyroelectric fusion, or hybrid nuclear fusion-fission. In some embodiments, the fusion reaction is a thermonuclear fusion reaction. In some embodiments, the radiation is atomic bombardment, nuclear radiation, electromagnetic radiation, or any combination thereof, wherein the radiation is a byproduct of a fusion reaction produced by thermonuclear fusion. In some embodiments, the fusion reaction is a beam-beam/beam-target fusion reaction. In some embodiments, the thermonuclear fusion reaction occurs within a fusion reactor with magnetic confinement such as a Z-pinch reactor, stellarator reactor, tokamak reactor, or compacted toroid reactor. In some embodiments, the fusion reaction occurs within a fusion reactor such as a field-reverse configuration (FRC) reactor.

In some embodiments, the composite matrix comprises a composite matrix of Formula I or Formula II.

In some embodiments, the boron content is isotopically enriched with boron-10 (¹⁰B). In some embodiments, the boron-10 content is at least 20%, at least 25%, at least 50%, at least 75%, at least 90%, at least 95%, or at least 99%.

In some embodiments, the composite matrix of Formula II. In some embodiments, the one or more ceramics comprises at least B or C. In some embodiments, Q is one or more ceramics selected from TiB₂, TaB₂, FeB₄, RuB₂, Ru₂B₃, ReB₂, B₄C, B₄Si, cubic-BN, BCN, BC₂N, B₂O₃, and B₆O. In some embodiments, Q is one or more ceramics selected from B₄C, BCN, BC₂N, TiC, ZrC, VC, NbC, NbC₂, TaC, MoC, MoC₂, and SiC. In some embodiments, Q is one or more ceramics selected from TiB₂, SiC, or B₄C.

In some embodiments, the radiation shield the reduces the exposure of the protected target to the radiation by at least 90%, at least 95%, or at least 99%. In some embodiments, the radiation shield is resistant to physical impingement. In some embodiments, the radiation shield is wear resistant to mechanical and thermal cycling. In some embodiments, the radiation shield is configured to have a geometric shape. In some embodiments, the radiation shield is shaped as a plate, a cylinder, or a tile. In some embodiments, the radiation shield comprises one or more additional layers of a radiation shielding material. In some embodiments, the radiation shield comprises a structural component having a surface upon which the composite matrix is disposed. In some embodiments, the structural component is an enclosure or wall surrounding at least a portion of a nuclear reactor. In some embodiments, the structural component forms at least a portion of an aircraft hull, optionally wherein the structural component comprises aluminum, carbon fiber, ceramic, or any combination thereof.

In another aspect, disclosed herein is a radiation shield configured to shield from radiation, the shield comprising:
a composite matrix of Formula I, Formula II, Formula III, or Formula IV, wherein the radiation comprises atomic bombardment, nuclear radiation, or electromagnetic radiation, and optionally physical impingement; and wherein a composite matrix of Formula I, Formula II, Formula III, or Formula IV comprises:

W₁₋ₓMoₓB₄ (Formula I);

(W₁₋ₓMoₓB₄)_{z}(Q)ₙ (Formula II);

(W₁₋ₓMoₓB₄)_{z}(T)_{q} (Formula III); or

(W₁₋ₓMoₓB₄)_{z}(T)_{q}(Q)ₙ (Formula IV),

wherein,
M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al);
Q is one or more ceramics, wherein each of the one or more ceramics comprises at least two elements, and at least one of the two elements is B (boron), C (carbon), Si (silicon), N (nitrogen), or O (oxygen);
T is (i) at least one element that comprises a group 4, 5, 6, 7, 8, 9, 10, 11, 12, 13, or 14 transition metal element in the Periodic Table of Elements or (ii) an alloy which is a combination of two or more group 4, 5, 6, 7, 8, 9, 10, 11, 12, 13, or 14 transition metal elements in the Periodic Table of Elements;
x is a molar ratio from 0 to 0.999;
z is a volume percent from 0.001 to 0.999 (0.1% to 99.9%);
n is a volume percent from 0.001 to 0.999 (0.1% to 99.9%);
q is a volume percent from 0.001 to 0.999 (0.1% to 99.9%);
the sum of n and z is 1 (100%) in Formula II;
the sum of z and q is 1 (100%) in Formula III;
the sum of z, q, and n is 1 (100%) in Formula IV;
wherein the composite matrix has a porosity of at least 10%;
and optionally, the boron content of a composite matrix of Formula I, Formula II, Formula III, or Formula IV is isotopically enriched with boron-10 (¹⁰B), and
wherein x is from 0.001 to 0.999 for a composite matrix of Formula I.

In another aspect, disclosed herein is a liquid composition configured to form a radiation shield, the shield comprising:
a composite matrix of Formula I, Formula II, Formula III, or Formula IV, wherein the radiation comprises atomic bombardment, nuclear radiation, or electromagnetic radiation, and optionally physical impingement; and wherein a composite matrix of Formula I, Formula II, Formula III, or Formula IV comprises:

W₁₋ₓMoₓB₄ (Formula I);

(W₁₋ₓMoₓB₄)_{z}(Q)ₙ (Formula II);

(W₁₋ₓMoₓB₄)_{z}(T)_{q} (Formula III); or

(W₁₋ₓMoₓB₄)_{z}(T)_{q}(Q)ₙ (Formula IV),
wherein,
M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al);
Q is one or more ceramics, wherein each of the one or more ceramics comprises at least two elements, and at least one of the two elements is B (boron), C (carbon), Si (silicon), N (nitrogen), or O (oxygen);
T is (i) at least one element that comprises a group 4, 5, 6, 7, 8, 9, 10, 11, 12, 13, or 14 transition metal element in the Periodic Table of Elements or (ii) an alloy which is a combination of two or more group 4, 5, 6, 7, 8, 9, 10, 11, 12, 13, or 14 transition metal elements in the Periodic Table of Elements;
x is a molar ratio from 0 to 0.999;
z is a volume percent from 0.001 to 0.999 (0.1% to 99.9%);
n is a volume percent from 0.001 to 0.999 (0.1% to 99.9%);
q is a volume percent from 0.001 to 0.999 (0.1% to 99.9%);
the sum of n and z is 1 (100%) in Formula II;
the sum of z and q is 1 (100%) in Formula III;
the sum of z, q, and n is 1 (100%) in Formula IV;
and optionally, the boron content of a composite matrix of Formula I, Formula II, Formula III, or Formula IV is isotopically enriched with boron-10 (¹⁰B); and
one or more binders configured to allow curing of the liquid composition to form a solid radiation shield. In some embodiments, x is from 0.001 to 0.999 for a composite matrix of Formula I.

In another aspect, disclosed herein is a method of forming a solid radiation shield, comprising spraying or applying a liquid composition comprising a composite matrix of Formula I, II, III, or IV onto a surface of a structural component, and curing the liquid composition.

In another aspect, disclosed herein is a liquid composition configured to form a radiation shield, the shield comprising:
a composite matrix of Formula I, Formula II, Formula III, or Formula IV, wherein the radiation comprises atomic bombardment, nuclear radiation, or electromagnetic radiation, and optionally physical impingement; and wherein a composite matrix of Formula I, Formula II, Formula III, or Formula IV comprises:

W₁₋ₓMoₓB₄ (Formula I);

(W₁₋ₓMoₓB₄)_{z}(Q)ₙ (Formula II);

(W₁₋ₓMoₓB₄)_{z}(T)_{q} (Formula III); or

(W₁₋ₓMoₓB₄)_{z}(T)_{q}(Q)ₙ (Formula IV),
wherein,
M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al);
Q is one or more ceramics, wherein each of the one or more ceramics comprises at least two elements, and at least one of the two elements is B (boron), C (carbon), Si (silicon), N (nitrogen), or O (oxygen);
T is (i) at least one element that comprises a group 4, 5, 6, 7, 8, 9, 10, 11, 12, 13, or 14 transition metal element in the Periodic Table of Elements or (ii) an alloy which is a combination of two or more group 4, 5, 6, 7, 8, 9, 10, 11, 12, 13, or 14 transition metal elements in the Periodic Table of Elements;
x is a molar ratio from 0 to 0.999;
z is a volume percent from 0.001 to 0.999 (0.1% to 99.9%);
n is a volume percent from 0.001 to 0.999 (0.1% to 99.9%);
q is a volume percent from 0.001 to 0.999 (0.1% to 99.9%);
the sum of n and z is 1 (100%) in Formula II;
the sum of z and q is 1 (100%) in Formula III;
the sum of z, q, and n is 1 (100%) in Formula IV;
and optionally, the boron content of a composite matrix of Formula I, Formula II, Formula III, or Formula IV is isotopically enriched with boron-10 (¹⁰B); and
one or more binders to allow the liquid composition to form a thermoset plastic radiation shield. In some embodiments, wherein x is from 0.001 to 0.999 for a composite matrix of Formula I.

In some embodiments, disclosed herein is a method of regenerating the radiation shields described herein comprising: a) exposing the radiation shield to water for a period of time sufficient to form at least B₂O₃ and metal oxides, and b) removing the B₂O₃ and metal oxides to yield a surface of the composite matrix with an increase in boron-10 relative to the formation and removal of the B₂O₃ and metal oxides.

In another aspect, disclosed herein is a method of forming a solid radiation shield, comprising preparing a liquid composition comprising a composite matrix of Formula I, II, III, or IV, and melting, pressing, or injection molding the liquid composition into the thermoset plastic radiation shield.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various aspects of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows X-ray powder diffractograms of a composite of W_{0.95}Cr_{0.05}B₄ and B₄C, wherein the B₄C is 10% by volume.

FIG. 2 shows X-ray powder diffractograms of a composite of W_{0.95}Cr_{0.05}B₄ and TiB₂, wherein the TiB₂ is 10% by volume.

### DETAILED DESCRIPTION OF THE INVENTION

Disclosed herein are radiation shielding compositions, devices, and methods for providing radiation shielding that utilizing compositions comprising tungsten tetraboride (WB₄) or tungsten alloy tetraborides (W₁₋ₓMoₓB₄). There are two general categories of radiation shielding: heavy, dense metals, and low-Z (low atomic number such as carbon and boron). In the case of a heavy metal such as tungsten, the use of such a material for radiation shielding can be difficult due to it being expensive to source, difficult to work (manipulate such as shaping, forming, machining), or heavy, and in some instances toxic. Compositions of boron and carbon are therefore desirable due to their low cost, and abundance. Materials comprising a tungsten tetraboride (WB₄) or tungsten alloy tetraborides (W₁₋ₓMoₓB₄) contain both heavy metals and the low Z element boron. Both elements are particularly useful in the field of radiation shielding. Due in part to a high natural abundance of the isotope boron-10, boron is resistant to neutron bombardment. The high density of tungsten also provides an excellent barrier to most components of radiation. The advantages of tungsten tetraboride (WB₄) or tungsten alloy tetraborides (W₁₋ₓMoₓB₄) can be paired with additional metals and ceramics to amplify the radiation shielding properties of the composite.

In some embodiments, the composite matrix material used for radiation shielding comprises a tungsten tetraboride composition (WB₄) or tungsten alloy tetraborides (W₁.ₓMoₓB₄). In some embodiments, the composite matrix further comprises boron carbide (e.g., B₄C and/orB₁₂C₃).

In some embodiments, the boron carbide comprises boron-10 which has a particularly large neutron cross-section, almost as much as that of tungsten, and has a natural abundance of ˜20^{%} (19.9(7)%). In some embodiments, the composite matrix comprises boron carbide having a boron-10 content that is greater than about 20%, for example, at least 25%, at least 30^{%}, at least 35%, at least 40%, at least 45%, at least 50%, at least 55%, at least 60%, at least 65%, at least 70%, at least 75%, at least 80%, at least 85%, at least 90%, or at least 95% or higher as a percentage of total boron content. For example, the composite matrix may contain boron carbide enriched for boron-10. The significance of combining tungsten tertaborides (WB₄ or W₁₋ₓMoₓB₄) with a binder such as tetride (WB₄ or W₁₋ₓMoₓB₄)+B₄C having a significant amount of boron-10 is that the combination of the tungsten neutron cross section and the boron-10's neutron cross section give rise to effective radiation shielding while maintaining a significantly lower density than that of tungsten carbide or pure tungsten metal. This results in a material having high radiation shielding (e.g., neutron shielding) while reducing the weight and cost of manufacture. The tetrides (WB₄ or W₁₋ₓMoₓB₄) and composite matrices disclosed herein also provide for greater ease of manufacturing because pure W is difficult to shape, form, and handle in part because of its density. In addition, in cases with WC—Co systems, having a transition metal such as Co can have deleterious effects on the system. Therefore, composite matrices that utilize non-transition metal binders such as ceramics can provide superior shielding compared to metal binders that can absorb and absorb neutrons, thereby irradiating neighboring atoms. Furthermore, the degree of neutron absorption can be modulated by changing the ratio of tetride (WB₄ or W₁₋ₓMoₓB₄)) to binder and/or by changing the ratio of boron-10 to boron-11. Accordingly, in some cases, the methods of manufacture disclosed within can include a step for increasing shielding effectiveness by preparing a composite matrix material having tetride (WB₄ or W₁₋ₓMoₓB₄) and boron carbide with an increased ratio of boron-10 to boron-11 than would naturally occur (e.g., boron carbide enriched for boron-10).

In some embodiments, the composite matrix has a standard structure of the tungsten tetraboride hard material mixed with binder that has been sintered. Alternatively or in combination, the composite matrix can be configured with structure comprising a degree of porosity. In some embodiments, the composite matrix has a porosity of at least about 10%, about 20%, about 30%, about 40%, about 50%, about 60%, about 70%, or at least about 80% or more. A composite matrix having a porous structure can be used in breeder reactors, for example, which utilize lithium salts and neutrons from a reactors source to produce deuterium and tritium (which are necessary nuclear fuels). The porous structure allows the composite matrix to act like a “metallic sponge” that would allow a liquid solution to pass through.

In other embodiments, the composite matrix (e.g., W₁₋ₓMoₓB₄ or WB₄ with or without binder) is blended or mixed into a thermoform or thermoset plastic and extruded or cast or injection molded into a shape. This would allow for a uniform distribution of the W₁₋ₓMoₓB₄ or WB₄ (with or without binder) into plastic to produce plates, cylinders, or tiles, or any other suitable shape. Accordingly, the radiation shielding material can be shaped or configured into a particular shape suitable for specific radiation shielding applications. As an illustrative example, flat radiation absorbing tiles may be attached or adhered on an interior or exterior surface of spacecraft to protect sensitive electronics and/or living organisms from solar radiation.

In yet other embodiments, the composite matrix (e.g., W₁₋ₓMoₓB₄ or WB₄ with or without binder) is dispersed in a curable epoxy or resinous liquid and sprayed or applied to a surface and allowed to cure. This approach yields a convenient coating that can provide radiation shielding without requiring prefabrication of the matrix material into a particular shape. For example, a substrate material having the desired shape for a radiation shielding tile can simply be sprayed or given a coating of the composite matrix onto its surface to add or improve upon its shielding properties. As an illustrative example, the radiation shielding material may be used to retrofit existing spacecraft (e.g., older spacecraft lacking radiation shielding capabilities) with increased radiation shielding by applying the material onto a suitable surface or substrate (e.g., as a curable resin).

Tungsten tetraboride (WB₄) is a crystalline composite matrix that is useful as a superhard coating for tools used to cut or abrade. However, the instant application recognizes the potential usefulness of such materials for radiation shielding purposes. The hardness of WB₄ is due in part to the arrangement of the tungsten and boron atoms in the WB₄ crystalline lattice. Substituting transition metal elements for tungsten can increase the hardness of the tungsten alloy tetraboride composition (W₁₋ₓMoₓB₄— Formula I). For example, Vickers hardness measurements have been observed at 0.49 N as high as 53.0, 55.8 and 57.3 GPa for W_{0.90}Cr_{0.10}B₄, W_{0.94}Ta_{0.02}Mn_{0.04}B₄ and W_{0.93}Ta_{0.02}Cr_{0.05}B₄ respectively.

In some embodiments, tungsten alloy tetraborides (W₁₋ₓMoₓB₄) or tungsten tetraboride (WB₄) is combined with a ceramic materials. These composite matrices can provide effective radiation shielding in combination with desirable hardness and/or toughness as well as being easier and cheaper to manufacture compared to alternative shielding materials. Ceramics often react with W₁₋ₓMoₓB₄ or WB₄ to form lower borides, e.g. WB, and WB₂, effectively destroying the beneficial properties of both components. Applicants have found that specialized conditions are needed to access the composites described herein. For example, when elemental carbon or silicon is heated with WB₄, the tetraboride degrades to mixtures of tungsten monoboride, tungsten diboride, and tungsten carbide or silicon carbide respectively. Similarly, when composite matrices of W_{0.95}Cr_{0.05}B₄ and TiB₂ (described in Example 2) were underheated during synthesis, the composite matrix was not effectively formed. Overheating resulted in an inferior material due to significant reaction between the components.

Factors such as heating time, ramp rate, pressure, the metal (M) used in W₁₋ₓMoₓB₄, the molar ratio of M, and the volume ratio of W₁₋ₓMoₓB₄ to ceramic were each important factors to consider when synthesizing the composite matrices described herein. Due to the myriad of synthetic difficulties involved, an inventive step was required to access the composite matrices described herein. As no synthetic route was previously available, the composite matrices would not have been obvious to one skilled in the art.

In some embodiments, the composites disclosed herein are heterogenous in nature, with crystalline tetride (e.g., W₁₋ₓMoₓB₄ or WB₄) being combined with one or more ceramics (binder) to form the composite (W₁₋ₓMoₓB₄)_{z}(Q)ₙ or (WB₄)_{z}(Q)ₙ. During the formation of the composite, grain boundaries form between the crystalline W₁₋ₓMoₓB₄ or WB₄ and the one or more ceramics. The grain boundaries are typically a mixture of W₁₋ₓMoₓB₄ or WB₄, ceramic, and the by-products of any reaction between the tetraborides and the ceramic. The grain boundary aids in the formation of the composite by forming a layer between the ceramic and W₁₋ₓMoₓB₄ or WB₄ that slows the rate of reaction between the two components. The grain boundaries also aid in binding the components into a single composite. The ratio of tetride (WB₄ or W₁₋ₓMoₓB₄) to the binder can be adjusted to optimize hardness, toughness, and radiation shielding effectiveness. In some embodiments, the ratio of tetride to binder is at least 10%, 20%, 30%, 40%, 50%, 60%, or 70% by volume. In some embodiments, the ratio of tetride to binder is no more than 10%, 20%, 30%, 40%, 50%, 60%, or 70% by volume. In some embodiments, the ratio of tetride to binder is no more than 70% (e.g., 70% tetride and 30% ceramic/metal binder).

Reaction conditions such as temperature, pressure, ramp rate and heating technique can be important variables to consider. If the reaction vessel is heated for too long or too high, the grain boundaries may become permeable and fail to effectively insulate the components. In such cases, a large fraction of both the W₁₋ₓMoₓB₄ or WB₄ and the ceramic is destroyed. On the other hand, if the temperature is deficient, the grain boundaries may not sufficiently form to produce the composite. The development of the novel and inventive synthetic techniques described herein were required to access the composite matrices of (W₁₋ₓMoₓB₄)_{z}(Q)ₙ and (WB₄)_{z}(Q)ₙ.

### Radiation Shielding or Attenuation

The compositions, devices, and methods disclosed herein provide for shielding or attenuation of various forms of radiation, in particular, ionizing radiation. The radiation can include electromagnetic radiation (e.g., gamma rays, X-rays, etc.), alpha particles, beta particles, and neutron radiation. The source of radiation can include a cosmic source such as a star or man-made sources such as nuclear reactors and X-ray machines. The degree of radiation shielding or attenuation can be expressed as a linear attenuation coefficient (p). The intensity of the beam at distance x (cm) within a material is calculated using the following equation 2: Iₓ=I₀e^{-μx}, in which Iₓ is the intensity at depth of x cm, I₀ is the original intensity, and μ is the linear attenuation coefficient. The formula can be rearranged and the log taken for both sides to provide the equation for μ:μ=ln(I₀/Iₓ)/x″

The degree of effective shielding provided is expressed as Sieverts/time (e.g., milliSieverts/day). Sieverts are the SI unit, while rem (Rontgen equivalent man) may be used as an alternative. When the composite shield is placed in the path of the radiation, the degree of shielding or attenuation can be expressed as a reduction in the “dosage” of the radiation over time, for example, reducing the mSv/day “flux”. Over time, this radiation shielding results in an overall reduction in the effective dosage that penetrates or passes through the shielding, which can be expressed in Gray (Gy) or rad units.

In some embodiments, the radiation shield provides a radiation or radiation attenuation of at least 80%, at least 85%, at least 90%, at least 95%, at least 96%, at least 97%, at least 98%, at least 99% of the radiation reaching the protected target from the radiation source. For example, an exterior of a nuclear reactor that is at least partially enclosed by the radiation shield can have a reduction in neutron radiation of at least 99% when passing through the radiation shield.

In some embodiments, the radiation shield provides a radiation or radiation attenuation of about 1% to about 99%. In some embodiments, the radiation shield provides a radiation or radiation attenuation of about 1% to about 5%, about 1% to about 10%, about 1% to about 20%, about 1% to about 30%, about 1% to about 40%, about 1% to about 50%, about 1% to about 60%, about 1% to about 70%, about 1% to about 80%, about 1% to about 90%, about 1% to about 99%, about 5% to about 10%, about 5% to about 20%, about 5% to about 30%, about 5% to about 40%, about 5% to about 50%, about 5% to about 60%, about 5% to about 70%, about 5% to about 80%, about 5% to about 90%, about 5% to about 99%, about 10% to about 20%, about 10% to about 30%, about 10% to about 40%, about 10% to about 50%, about 10% to about 60%, about 10% to about 70%, about 10% to about 80%, about 10% to about 90%, about 10% to about 99%, about 20% to about 30%, about 20% to about 40%, about 20% to about 50%, about 20% to about 60%, about 20% to about 70%, about 20% to about 80%, about 20% to about 90%, about 20% to about 99%, about 30% to about 40%, about 30% to about 50%, about 30% to about 60%, about 30% to about 70%, about 30% to about 80%, about 30% to about 900%, about 30% to about 99%, about 40% to about 50%, about 40% to about 60%, ab out 40% to about 70%, about 40% to about 80%, about 40% to about 90%, about 40% to about 99%, about 50% to about 60%, about 50% to about 70%, about 50% to about 80%, about 50% to about 90%, about 50% to about 99%, about 60% to about 70%, about 60% to about 80%, about 60% to about 90%, about 60% to about 99%, about 70% to about 80%, about 70% to about 90%, about 70% to about 99%, about 80% to about 90%, about 80% to about 99%, or about 90% to about 99%. In some embodiments, the radiation shield provides a radiation or radiation attenuation of about 1%, about 5%, about 10%, about 20%, about 30%, about 40%, about 50%, about 60%, about 70%, about 80%, about 90%, or about 99%. In some embodiments, the radiation shield provides a radiation or radiation attenuation of at least about 1%, about 5%, about 10%, about 20%, about 30%, about 40%, about 50%, about 60%, about 70%, about 80%, or about 90%. In some embodiments, the radiation shield provides a radiation or radiation attenuation of at most about 5%, about 10%, about 20%, about 30%, about 40%, about 50%, about 60%, about 70%, about 80%, about 90%, or about 99%. In some embodiments, the radiation shield provides a radiation or radiation attenuation of about 70% to about 99%. In some embodiments, the radiation shield provides a radiation or radiation attenuation of about 70% to about 75%, about 70% to about 77%, about 70% to about 80%, about 70% to about 83%, about 70% to about 85%, about 70% to about 87%, about 70% to about 90%, about 70% to about 93%, about 70% to about 95%, about 70% to about 97%, about 70% to about 99%, about 75% to about 77%, about 75% to about 80%, about 75% to about 83%, about 75% to about 85%, about 75% to about 87%, about 75% to about 90%, about 75% to about 93%, about 75% to about 95%, about 75% to about 97%, about 75% to about 99%, about 77% to about 80%, about 77% to about 83%, about 77% to about 85%, about 77% to about 870%, about 77% to about 90%, about 77% to about 93%, about 77% to about 95%, about 77% to about 97%, about 77% to about 99%, about 80% to about 83%, about 80% to about 85%, about 80% to about 87%, about 80% to about 90%, about 80% to about 93%, about 80% to about 95%, about 80% to about 97%, about 80% to about 99%, about 83% to about 85%, about 83% to about 87%, about 83% to about 90%, about 83% to about 93%, about 83% to about 95%, about 83% to about 97%, about 83% to about 99%, about 85% to about 87%, about 85% to about 90%, about 85% to about 93%, about 85% to about 95, about 85% to about 97%, about 85% to about 99%, about 87% to about 90%, about 87% to about 93%, about 87% to about 95%, about 87% to about 97%, about 87% to about 99%, about 90% to about 93%, about 90% to about 95%, about 90% to about 97%, about 90% to about 99%, about 93% to about 95%, about 93% to about 97%, about 93% to about 99%, about 95% to about 97%, about 95% to about 99%, or about 97% to about 99%. In some embodiments, the radiation shield provides a radiation or radiation attenuation of about 70%, about 75%, about 77%, about 80%, about 83%, about 85%, about 87%, about 90%, about 93%, about 95%, about 97%, or about 99%. In some embodiments, the radiation shield provides a radiation or radiation attenuation of at least about 70%, about 75%, about 77%, about 80%, about 83%, about 85%, about 87%, about 90%, about 93%, about 95%, or about 97%. In some embodiments, the radiation shield provides a radiation or radiation attenuation of at most about 75%, about 77%, about 80%, about 83%, about 85%, about 87%, about 90%, about 93%, about 95%, about 97%, or about 99%.

In some embodiments, the radiation shield placed in the path of a potential radiation source provides sufficient radiation shielding or attenuation that limits the amount of radiation passing through to no more than 0.1 mSv/day per m², 0.2 mSv/day per m², 0.3 mSv/day per m², 0.4 mSv/day per m², 0.5 mSv/day per m², 0.6 mSv/day per m², 0.7 mSv/day per m², 0.8 mSv/day per m², 0.9 mSv/day per m², or no more than 1 mSv/day per m².

In some embodiments, the radiation shield provides a radiation attenuation of about 0.001 mSv/day per m² to about 10 mSv/day per m². In some embodiments, the radiation shield provides a radiation attenuation of about 0.001 mSv/day per m² to about 0.01 mSv/day per m², about 0.001 mSv/day per m² to about 0.1 mSv/day per m², about 0.001 mSv/day per m² to about 0.25 mSv/day per m², about 0.001 mSv/day per m² to about 0.5 mSv/day per m², about 0.001 mSv/day per m² to about 0.75 mSv/day per m², about 0.001 mSv/day per m² to about 1 mSv/day per m², about 0.001 mSv/day per m² to about 1.5 mSv/day per m², about 0.001 mSv/day per m² to about 2 mSv/day per m², about 0.001 mSv/day per m² to about 5 mSv/day per m², about 0.001 mSv/day per m² to about 10 mSv/day per m², about 0.01 mSv/day per m² to about 0.1 mSv/day per m², about 0.01 mSv/day per m² to about 0.25 mSv/day per m², about 0.01 mSv/day per m² to about 0.5 mSv/day per m², about 0.01 mSv/day per m² to about 0.75 mSv/day per m², about 0.01 mSv/day per m² to about 1 mSv/day per m², about 0.01 mSv/day per m² to about 1.5 mSv/day per m², about 0.01 mSv/day per m² to about 2 mSv/day per m², about 0.01 mSv/day per m² to about 5 mSv/day per m², about 0.01 mSv/day per m² to about 10 mSv/day per m², about 0.1 mSv/day per m² to about 0.25 mSv/day per m², about 0.1 mSv/day per m² to about 0.5 mSv/day per m², about 0.1 mSv/day per m² to about 0.75 mSv/day per m², about 0.1 mSv/day per m² to about 1 mSv/day per m², about 0.1 mSv/day per m² to about 1.5 mSv/day per m², about 0.1 mSv/day per m² to about 2 mSv/day per m², about 0.1 mSv/day per m² to about 5 mSv/day per m², about 0.1 mSv/day per m² to about 10 mSv/day per m², about 0.25 mSv/day per m² to about 0.5 mSv/day per m², about 0.25 mSv/day per m² to about 0.75 mSv/day per m², about 0.25 mSv/day per m² to about 1 mSv/day per m², about 0.25 mSv/day per m² to about 1.5 mSv/day per m², about 0.25 mSv/day per m² to about 2 mSv/day per m², about 0.25 mSv/day per m² to about 5 mSv/day per m², about 0.25 mSv/day per m² to about 10 mSv/day per m², about 0.5 mSv/day per m² to about 0.75 mSv/day per m², about 0.5 mSv/day per m² to about 1 mSv/day per m², about 0.5 mSv/day per m² to about 1.5 mSv/day per m², about 0.5 mSv/day per m² to about 2 mSv/day per m², about 0.5 mSv/day per m² to about 5 mSv/day per m², about 0.5 mSv/day per m² to about 10 mSv/day per m², about 0.75 mSv/day per m² to about 1 mSv/day per m², about 0.75 mSv/day per m² to about 1.5 mSv/day per m², about 0.75 mSv/day per m² to about 2 mSv/day per m², about 0.75 mSv/day per m² to about 5 mSv/day per m², about 0.75 mSv/day per m² to about 10 mSv/day per m², about 1 mSv/day per m² to about 1.5 mSv/day per m², about 1 mSv/day per m²to about 2 mSv/day per m², about 1 mSv/day per m² to about 5 mSv/day per m², about 1 mSv/day per m² to about 10 mSv/day per m², about 1.5 mSv/day per m² to about 2 mSv/day per m², about 1.5 mSv/day per m² to about 5 mSv/day per m², about 1.5 mSv/day per m² to about 10 mSv/day per m², about 2 mSv/day per m² to about 5 mSv/day per m², about 2 mSv/day per m² to about 10 mSv/day per m², or about 5 mSv/day per m² to about 10 mSv/day per m². In some embodiments, the radiation shield provides a radiation attenuation of about 0.001 mSv/day per m², about 0.01 mSv/day per m², about 0.1 mSv/day per m², about 0.25 mSv/day per m², about 0.5 mSv/day per m², about 0.75 mSv/day per m², about 1 mSv/day per m², about 1.5 mSv/day per m², about 2 mSv/day per m², about 5 mSv/day per m², or about 10 mSv/day per m². In some embodiments, the radiation shield provides a radiation attenuation of at least about 0.001 mSv/day per m², about 0.01 mSv/day per m², about 0.1 mSv/day per m², about 0.25 mSv/day per m², about 0.5 mSv/day per m², about 0.75 mSv/day per m², about 1 mSv/day per m², about 1.5 mSv/day per m², about 2 mSv/day per m², or about 5 mSv/day per m². In some embodiments, the radiation shield provides a radiation attenuation of at most about 0.01 mSv/day per m², about 0.1 mSv/day per m², about 0.25 mSv/day per m², about 0.5 mSv/day per m², about 0.75 mSv/day per m², about 1 mSv/day per m², about 1.5 mSv/day per m², about 2 mSv/day per m², about 5 mSv/day per m², or about 10 mSv/day per m².

### Compositions of Matter

Described herein are compositions and composite matrices useful for providing radiation shielding. Such compositions include those having the structure of Formula I, Formula II, Formula III, or Formula IV. These compositions utilize tungsten boride materials such as, for example, tungsten tetraboride (WB₄), tungsten alloy tetraboride (W₁₋ₓMₓB₄), and composite matrices thereof. The instant application recognizes the utility of these compositions for providing radiation shielding with improved ease of manufacture, physical manipulation, and overall shielding effectiveness. For example, naturally occurring tungsten isotopes have favorable neutron cross-sections for absorbing neutron energy. Tungsten also has a high atomic number that provides high gamma shielding. In addition, boron has two stable isotopes, boron-10 and boron-11. Boron-10 accounts for about 20% of the natural abundance or the atom. Therefore naturally occurring boron has a high neutron absorption coefficient, and the product of the neutron absorption of boron-10 is the stable boron 11 isotope. Boron sources enriched with boron-10 of up to 99+% are commercially available, allowing for a material with an even higher neutron absorption capabilities.

### Shield Parameters

The compositions disclosed herein can be fashioned into radiation shields of a suitable shape and thickness to provide the requisite degree of radiation shielding and/or attenuation. In some embodiments, the radiation shield is configured to have a thickness of at least 50 mm, at least 75 mm, at least 100 mm, at least 200 mm, at least 300 mm, at least 400 mm, at least 500 mm, at least 600 mm, at least 700 mm, at least 800 mm, at least 900 mm, at least 1000 mm, at least 1100 mm, at least 1200 mm, at least 1300 mm, at least 1400 mm, at least 1500 mm, at least 1600 mm, at least 1700 mm, at least 1800 mm, at least 1900 mm, at least 2000 mm, at least 2100 mm, at least 2200 mm, at least 2300 mm, at least 2400 mm, at least 2500 mm, at least 2600 mm, at least 2700 mm, at least 2800 mm, at least 2900 mm, at least 3000 mm, at least 3500 mm, at least 4000 mm, at least 4500 mm, at least 5000 mm, at least 6000 mm, at least 7000 mm, at least 8000 mm, at least 9000 mm, or at least 10000 mm. In some embodiments, the radiation shield is configured to have a thickness of no more than 50 mm, no more than 75 mm, no more than 100 mm, no more than 200 mm, no more than 300 mm, no more than 400 mm, no more than 500 mm, no more than 600 mm, no more than 700 mm, no more than 800 mm, no more than 900 mm, no more than 1000 mm, no more than 1100 mm, no more than 1200 mm, no more than 1300 mm, no more than 1400 mm, no more than 1500 mm, no more than 1600 mm, no more than 1700 mm, no more than 1800 mm, no more than 1900 mm, no more than 2000 mm, no more than 2100 mm, no more than 2200 mm, no more than 2300 mm, no more than 2400 mm, no more than 2500 mm, no more than 2600 mm, no more than 2700 mm, no more than 2800 mm, no more than 2900 mm, no more than 3000 mm, no more than 3500 mm, no more than 4000 mm, no more than 4500 mm, no more than 5000 mm, no more than 6000 mm, no more than 7000 mm, no more than 8000 mm, no more than 9000 mm, or no more than 10000 mm.

In some embodiments, the radiation shield has a thickness of at least about 100 mm to about 5,000 mm. In some embodiments, the radiation shield has a thickness of at least about 100 mm to about 250 mm, about 100 mm to about 500 mm, about 100 mm to about 750 mm, about 100 mm to about 1,000 mm, about 100 mm to about 1,500 mm, about 100 mm to about 200 mm, about 100 mm to about 2,500 mm, about 100 mm to about 3,000 mm, about 100 mm to about 4,000 mm, about 100 mm to about 5,000 mm, about 250 mm to about 500 mm, about 250 mm to about 750 mm, about 250 mm to about 1,000 mm, about 250 mm to about 1,500 mm, about 250 mm to about 200 mm, about 250 mm to about 2,500 mm, about 250 mm to about 3,000 mm, about 250 mm to about 4,000 mm, about 250 mm to about 5,000 mm, about 500 mm to about 750 mm, about 500 mm to about 1,000 mm, about 500 mm to about 1,500 mm, about 500 mm to about 200 mm, about 500 mm to about 2,500 mm, about 500 mm to about 3,000 mm, about 500 mm to about 4,000 mm, about 500 mm to about 5,000 mm, about 750 mm to about 1,000 mm, about 750 mm to about 1,500 mm, about 750 mm to about 200 mm, about 750 mm to about 2,500 mm, about 750 mm to about 3,000 mm, about 750 mm to about 4,000 mm, about 750 mm to about 5,000 mm, about 1,000 mm to about 1,500 mm, about 1,000 mm to about 200 mm, about 1,000 mm to about 2,500 mm, about 1,000 mm to about 3,000 mm, about 1,000 mm to about 4,000 mm, about 1,000 mm to about 5,000 mm, about 1,500 mm to about 200 mm, about 1,500 mm to about 2,500 mm, about 1,500 mm to about 3,000 mm, about 1,500 mm to about 4,000 mm, about 1,500 mm to about 5,000 mm, about 200 mm to about 2,500 mm, about 200 mm to about 3,000 mm, about 200 mm to about 4,000 mm, about 200 mm to about 5,000 mm, about 2,500 mm to about 3,000 mm, about 2,500 mm to about 4,000 mm, about 2,500 mm to about 5,000 mm, about 3,000 mm to about 4,000 mm, about 3,000 mm to about 5,000 mm, or about 4,000 mm to about 5,000 mm. In some embodiments, the radiation shield has a thickness of at least about 100 mm, about 250 mm, about 500 mm, about 750 mm, about 1,000 mm, about 1,500 mm, about 200 mm, about 2,500 mm, about 3,000 mm, about 4,000 mm, or about 5,000 mm. In some embodiments, the radiation shield has a thickness of at least at least about 100 mm, about 250 mm, about 500 mm, about 750 mm, about 1,000 mm, about 1,500 mm, about 200 mm, about 2,500 mm, about 3,000 mm, or about 4,000 mm. In some embodiments, the radiation shield has a thickness of at least at most about 250 mm, about 500 mm, about 750 mm, about 1,000 mm, about 1,500 mm, about 200 mm, about 2,500 mm, about 3,000 mm, about 4,000 mm, or about 5,000 mm.

The compositions disclosed herein can be configured with any suitable shape for use in radiation shielding. For example, the radiation shield can include one or more tiles that can be installed on an enclosure of a nuclear reactor. The tiles can be flat or curved depending on the reactor design. The applications of such radiation shielding can extend beyond nuclear reactors such as, for example, shielded containers and vials for transporting or storing radioactive materials or for customized shielding purposes. As an illustrative example, the WB₄ crystalline structures and composites thereof may be configured to a customized shape. In some cases, such materials are configured to be flexible, for example, shaped as blankets that can be wrapped around a target to be shielded from radiation. For example, a flexible blanket having sufficient thickness to provide effective radiation shielding (e.g., at least 90%, 95%, or 99% reduction in radiation dosage) may be useful in an emergency radiation exposure situation in space (e.g., during a solar storm) or to simply provide enhanced protection from a low but constant stream of cosmic rays (e.g., used while astronauts are resting to reduce overall exposure over time). Other suitable forms can be used such as a wearable radiation shield or garment. In some embodiments, the radiation shield consists of a single radiation shielding or attenuating layer. In some embodiments, the radiation shield comprises a plurality of layers for shielding or attenuating radiation. For example, neutron radiation striking a first layer may give rise to secondary radiation that must also be blocked by a second or additional layers.

### Composite Matrices of Formula I, Formula II, Formula III, and Formula IV

In one aspect, disclosed herein is a method of shielding a protected target, the method comprising:
a) positioning a radiation shield comprising a composite matrix of Formula I, Formula II, Formula III, or Formula IV in the path of a potential source of radiation travelling to a protected target, wherein the radiation comprises atomic bombardment, nuclear radiation, or electromagnetic radiation, and optionally physical impingement; and
b) reducing the exposure of the protected target to the radiation, wherein a composite matrix of Formula I, Formula II, Formula III, or Formula IV comprises:

W₁₋ₓMoₓB₄ (Formula I);

(W₁₋ₓMoₓB₄)_{z}(Q)ₙ (Formula II);

(W₁₋ₓMoₓB₄)_{z}(T)_{q} (Formula III); or

(W₁₋ₓMoₓB₄)_{z}(T)_{q}(Q)ₙ (Formula IV),
wherein,
   M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al);
   Q is one or more ceramics, wherein each of the one or more ceramics comprises at least two elements, and at least one of the two elements is B (boron), C (carbon), Si (silicon), N (nitrogen), or O (oxygen);
   T is (i) at least one element that comprises a group 4, 5, 6, 7, 8, 9, 10, 11, 12, 13, or 14 transition metal element in the Periodic Table of Elements or (ii) an alloy which is a combination of two or more group 4, 5, 6, 7, 8, 9, 10, 11, 12, 13, or 14 transition metal elements in the Periodic Table of Elements;
   x is a molar ratio from 0 to 0.999;
   z is a volume percent from 0.001 to 0.999 (0.1% to 99.9%);
   n is a volume percent from 0.001 to 0.999 (0.1% to 99.9%);
   q is a volume percent from 0.001 to 0.999 (0.1% to 99.9%);
   the sum of n and z is 1 (100%) in Formula II;
   the sum of z and q is 1 (100%) in Formula III;
   the sum of z, q, and n is 1 (100%) in Formula IV;
   and optionally, the boron content of a composite matrix of Formula I, Formula II, Formula III, or Formula IV is isotopically enriched with boron-10 (¹⁰B).
      In some embodiments, x is from 0.001 to 0.999 for a composite matrix of Formula I.

Described herein are composite matrices including W₁₋ₓMoₓB₄. Metal substitutions into the WB₄ crystal lattice enhances the beneficial properties (e.g. hardness) of WB₄. In the W₁₋ₓMoₓB₄ component, M is substituted into the crystalline lattice of WB₄ to form W₁₋ₓMoₓB₄. As the concentration of M increases, the WB₄ crystalline lattice is increasingly disrupted, and the beneficial properties may be lost. Therefore, the crystalline lattice of W₁₋ₓMoₓB₄ shares many crystalline features of the WB₄ lattice, but is not necessarily identical to WB₄. X-ray diffraction can be used to identify W₁₋ₓMoₓB₄ in the composite. In some embodiments, W₁₋ₓMoₓB₄ is a crystalline solid characterized by at least one X-ray diffraction pattern reflection at a 2 theta of about 24.2±0.3. In some embodiments, the crystalline solid is further characterized by at least one X-ray diffraction pattern reflection at a 2 theta of about 34.5 or about 34.5±0.3 or 45.1±0.3. In some embodiments, the crystalline solid is further characterized by at least one X-ray diffraction pattern reflection at a 2 theta of about 47.5 0.3, 61.8±0.3, 69.2±0.3, 69.4±0.3, 79.7±0.3, 89.9±0.3, or 110.2±0.3. In some embodiments, the crystalline solid is characterized by at least two X-ray diffraction pattern reflections at 2 theta=24.2±0.3, 28.1±0.3, 34.5±0.3, 42.5±0.3, 45.1±0.3, 47.5±0.3, 55.9±0.3, 61.8±0.3, 69.2±0.3, 69.4±0.3, 79.7±0.3, 89.9±0.3, or 110.2±0.3. In some embodiments, the crystalline solid is characterized by at least three X-ray diffraction pattern reflections at 2 theta=24.2±0.3, 28.1±0.3, 34.5±0.3, 42.5±0.3, 45.1±0.3, 47.5±0.3, 55.9±0.3, 61.8±0.3, 69.2±0.3, 69.4±0.3, 79.7±0.3, 89.9±0.3, or 110.2±0.3. In some embodiments, the crystalline solid is characterized by at least four X-ray diffraction pattern reflections at 2 theta=24.2±0.3, 28.1±0.3, 34.5±0.3, 42.5±0.3, 45.1±0.3, 47.5±0.3, 55.9±0.3, 61.8±0.3, 69.2±0.3, 69.4±0.3, 79.7±0.3, 89.9±0.3, or 110.2±0.3. In some embodiments, the crystalline solid is characterized by at least five X-ray diffraction pattern reflections at 2 theta=24.2±0.3, 28.1±0.3, 34.5±0.3, 42.5±0.3, 45.1±0.3, 47.5±0.3, 55.9±0.3, 61.8±0.3, 69.2±0.3, 69.4±0.3, 79.7±0.3, 89.9±0.3, or 110.2±0.3. In some embodiments, the crystalline solid is characterized by at least six X-ray diffraction pattern reflections at 2 theta=24.2±0.3, 28.1±0.3, 34.5±0.3, 42.5±0.3, 45.1±0.3, 47.5±0.3, 55.9±0.3, 61.8±0.3, 69.2±0.3, 69.4±0.3, 79.7±0.3, 89.9±0.3, or 110.2±0.3. In some embodiments, the crystalline solid is characterized by at least seven X-ray diffraction pattern reflections at 2 theta=24.2±0.3, 28.1±0.3, 34.5±0.3, 42.5±0.3, 45.1±0.3, 47.5±0.3, 55.9±0.3, 61.8±0.3, 69.2±0.3, 69.4±0.3, 79.7±±0.3, 89.9±0.3, or 110.2±0.3.

In some embodiments, the radiation shielding comprises a composite matrix of W₁₋ₓMoₓB₄ in Formula I, Formula II, Formula III, or Formula IV. In some embodiments, the hardness of W₁₋ₓMoₓB₄ is measured by a Vickers hardness test measured under a load of 0.49 Newton (N). In some embodiments, the hardness of W₁₋ₓMoₓB₄ is about 10 to about 70 GPa. In some embodiments, the hardness of W₁₋ₓMoₓB₄ is In some embodiments, W₁₋ₓMoₓB₄ has a hardness of at least about 10 GPa, about 15 GPa, about 20 GPa, about 25 GPa, about 30 GPa, about 31 GPa, about 32 GPa, about 33 GPa, about 34 GPa, about 35 GPa, about 36 GPa, about 37 GPa, about 38 GPa, about 39 GPa, about 40 GPa, about 41 GPa, about 42 GPa, about 43 GPa, about 44 GPa, about 45 GPa, about 46 GPa, about 47 GPa, about 48 GPa, about 49 GPa, about 50 GPa, about 51 GPa, about 52 GPa, about 53 GPa, about 54 GPa, about 55 GPa, about 56 GPa, about 57 GPa, about 58 GPa, about 59 GPa, about 60 GPa. In some embodiments, W₁₋ₓMoₓB₄ has a hardness of no greater than about 10 GPa, about 15 GPa, about 20 GPa, about 25 GPa, about 30 GPa, about 31 GPa, about 32 GPa, about 33 GPa, about 34 GPa, about 35 GPa, about 36 GPa, about 37 GPa, about 38 GPa, about 39 GPa, about 40 GPa, about 41 GPa, about 42 GPa, about 43 GPa, about 44 GPa, about 45 GPa, about 46 GPa, about 47 GPa, about 48 GPa, about 49 GPa, about 50 GPa, about 51 GPa, about 52 GPa, about 53 GPa, about 54 GPa, about 55 GPa, about 56 GPa, about 57 GPa, about 58 GPa, about 59 GPa, about 60 GPa.

In some embodiments, the radiation shielding comprises a composite matrix of W₁₋ₓMoₓB₄ in Formula I, Formula II, Formula III, or Formula IV. In some embodiments, the hardness of W₁₋ₓMoₓB₄ is measured by a Vickers hardness test measured under a load of 0.49 Newton (N). In some embodiments, the hardness of W₁₋ₓMoₓB₄ is about 44 to about 57 GPa. In some embodiments, the hardness is about 50 to about 57 GPa. In some embodiments, the hardness is about 50 to about 60 GPa. In some embodiments, the hardness is about 50 to about 65 GPa. In some embodiments, the hardness is about 45 to about 65 GPa. In some embodiments, the hardness is about 50 GPa to about 60 GPa. In some embodiments, the hardness is about 50 GPa, about 51 GPa, about 52 GPa, about 53 GPa, about 54 GPa, about 55 GPa, about 56 GPa, about 57 GPa, about 58 GPa, about 59 GPa, or about 60 GPa. In some embodiments, the hardness is at least about 50 GPa, about 51 GPa, about 52 GPa, about 53 GPa, about 54 GPa, about 55 GPa, about 56 GPa, about 57 GPa, about 58 GPa, or about 59 GPa. In some embodiments, the hardness is at most about 51 GPa, about 52 GPa, about 53 GPa, about 54 GPa, about 55 GPa, about 56 GPa, about 57 GPa, about 58 GPa, about 59 GPa, or about 60 GPa.

In some embodiments, the radiation shielding comprises a composite matrix of W₁₋ₓMoₓB₄ in Formula I, Formula II, Formula III, or Formula IV. In some embodiments, x has a value within the range 0.001 to 0.999, inclusively. In some embodiments, x has a value within the range of about 0.001 to about 0.055. In some embodiments, x has a value within the range of about 0.001 to about 0.005, about 0.001 to about 0.01, about 0.001 to about 0.015, about 0.001 to about 0.02, about 0.001 to about 0.025, about 0.001 to about 0.03, about 0.001 to about 0.035, about 0.001 to about 0.04, about 0.001 to about 0.045, about 0.001 to about 0.05, about 0.001 to about 0.055, about 0.005 to about 0.01, about 0.005 to about 0.015, about 0.005 to about 0.02, about 0.005 to about 0.025, about 0.005 to about 0.03, about 0.005 to about 0.035, about 0.005 to about 0.04, about 0.005 to about 0.045, about 0.005 to about 0.05, about 0.005 to about 0.055, about 0.01 to about 0.015, about 0.01 to about 0.02, about 0.01 to about 0.025, about 0.01 to about 0.03, about 0.01 to about 0.035, about 0.01 to about 0.04, about 0.01 to about 0.045, about 0.01 to about 0.05, about 0.01 to about 0.055, about 0.015 to about 0.02, about 0.015 to about 0.025, about 0.015 to about 0.03, about 0.015 to about 0.035, about 0.015 to about 0.04, about 0.015 to about 0.045, about 0.015 to about 0.05, about 0.015 to about 0.055, about 0.02 to about 0.025, about 0.02 to about 0.03, about 0.02 to about 0.035, about 0.02 to about 0.04, about 0.02 to about 0.045, about 0.02 to about 0.05, about 0.02 to about 0.055, about 0.025 to about 0.03, about 0.025 to about 0.035, about 0.025 to about 0.04, about 0.025 to about 0.045, about 0.025 to about 0.05, about 0.025 to about 0.055, about 0.03 to about 0.035, about 0.03 to about 0.04, about 0.03 to about 0.045, about 0.03 to about 0.05, about 0.03 to about 0.055, about 0.035 to about 0.04, about 0.035 to about 0.045, about 0.035 to about 0.05, about 0.035 to about 0.055, about 0.04 to about 0.045, about 0.04to about 0.05, about 0.04to about 0.055, about 0.045 to about 0.05, about 0.045 to about 0.055, about 0.05 to about 0.055, about 0.01 to about 0.06, about 0.01 to about 0.065, about 0.01 to about 0.07, about 0.01 to about 0.075, about 0.01 to about 0.08, about 0.01 to about 0.085, about 0.01 to about 0.09, about 0.02to about 0.03, about 0.02 to about 0.04, about 0.02 to about 0.05, about 0.02 to about 0.06, about 0.02 to about 0.065, about 0.02 to about 0.07, about 0.02 to about 0.075, about 0.02 to about 0.08, about 0.02 to about 0.085, about 0.02 to about 0.09, about 0.03 to about 0.04, about 0.03 to about 0.05, about 0.03 to about 0.06, about 0.03 to about 0.065, about 0.03 to about 0.07, about 0.03 to about 0.075, about 0.03 to about 0.08, about 0.03 to about 0.085, about 0.03 to about 0.09, about 0.04 to about 0.05, about 0.04 to about 0.06, about 0.04 to about 0.065, about 0.04 to about 0.07, about 0.04 to about 0.075, about 0.04 to about 0.08, about 0.04 to about 0.085, about 0.04 to about 0.09, about 0.05 to about 0.06, about 0.05 to about 0.065, about 0.05 to about 0.07, about 0.05 to about 0.075, about 0.05 to about 0.08, about 0.05 to about 0.085, about 0.05 to about 0.09, about 0.06 to about 0.065, about 0.06 to about 0.07, about 0.06 to about 0.075, about 0.06to about 0.08, about 0.06to about 0.085, about 0.06to about 0.09, about 0.065 to about 0.07, about 0.065 to about 0.075, about 0.065 to about 0.08, about 0.065 to about 0.085, about 0.065 to about 0.09, about 0.07 to about 0.075, about 0.07 to about 0.08, about 0.07 to about 0.085, about 0.07 to about 0.09, about 0.075 to about 0.08, about 0.075 to about 0.085, about 0.075 to about 0.09, about 0.08 to about 0.085, about 0.08 to about 0.09, about 0.085 to about 0.09, about 0.01 to about 0.1, about 0.01 to about 0.13, about 0.01 to about 0.15, about 0.01 to about 0.17, about 0.01 to about 0.2, about 0.01 to about 0.23, about 0.01 to about 0.25, about 0.01 to about 0.27, about 0.01 to about 0.3, about 0.01 to about 0.35, about 0.01 to about 0.4, about 0.1 to about 0.13, about 0.1 to about 0.15, about 0.1 to about 0.17, about 0.1 to about 0.2, about 0.1 to about 0.23, about 0.1 to about 0.25, about 0.1 to about 0.27, about 0.1 to about 0.3, about 0.1 to about 0.35, about 0.1 to about 0.4, about 0.13 to about 0.15, about 0.13 to about 0.17, about 0.13 to about 0.2, about 0.13 to about 0.23, about 0.13 to about 0.25, about 0.13 to about 0.27, about 0.13 to about 0.3, about 0.13 to about 0.35, about 0.13 to about 0.4, about 0.15 to about 0.17, about 0.15 to about 0.2, about 0.15 to about 0.23, about 0.15 to about 0.25, about 0.15 to about 0.27, about 0.15 to about 0.3, about 0.15 to about 0.35, about 0.15 to about 0.4, about 0.17 to about 0.2, about 0.17 to about 0.23, about 0.17 to about 0.25, about 0.17 to about 0.27, about 0.17 to about 0.3, about 0.17 to about 0.35, about 0.17 to about 0.4, about 0.2 to about 0.23, about 0.2 to about 0.25, about 0.2 to about 0.27, about 0.2 to about 0.3, about 0.2 to about 0.35, about 0.2 to about 0.4, about 0.23 to about 0.25, about 0.23 to about 0.27, about 0.23 to about 0.3, about 0.23 to about 0.35, about 0.23 to about 0.4, about 0.25 to about 0.27, about 0.25 to about 0.3, about 0.25 to about 0.35, about 0.25 to about 0.4, about 0.27 to about 0.3, about 0.27 to about 0.35, about 0.27 to about 0.4, about 0.3 to about 0.35, about 0.3 to about 0.4, or about 0.35 to about 0.4. In some embodiments of a composite matrix described herein, or prepared by the methods herein, x has a value of about 0.001, 0.005, 0.01, 0.05, 0.02, 0.015, 0.025, 0.03, 0.035, 0.04, 0.045, 0.05, 0.055, 0.06, 0.065, 0.070, 0.075, 0.080, 0.085, 0.090, 0.095, 0.1, 0.15, 0.2, 0.25, 0.3, ±0.35, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.65, 0.7, 0.8, 0.9, 0.95, 0.99, or about 0.999. In some embodiments of a composite matrix described herein, or prepared by the methods herein, x has a value of at least about 0.001, 0.005, 0.01, 0.05, 0.02, 0.015, 0.025, 0.03, 0.035, 0.04, 0.045, 0.05, 0.055, 0.06, 0.065, 0.070, 0.075, 0.080, 0.085, 0.090, 0.095, 0.1, 0.15, 0.2, 0.25, 0.3, ±0.35, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.65, 0.7, 0.8, 0.9, 0.95, 0.99, or about 0.999. In some embodiments of a composite matrix described herein, or prepared by the methods herein, x has a value of no greater than about 0.001, 0.005, 0.01, 0.05, 0.02, 0.015, 0.025, 0.03, 0.035, 0.04, 0.045, 0.05, 0.055, 0.06, 0.065, 0.070, 0.075, 0.080, 0.085, 0.090, 0.095, 0.1, 0.15, 0.2, 0.25, 0.3, ±0.35, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.65, 0.7, 0.8, 0.9, 0.95, 0.99, or about 0.999.

In some embodiments, the radiation shielding comprises a composite matrix of W₁₋ₓMoₓB₄ in Formula I, Formula II, Formula III, or Formula IV. In some embodiments, the composite matrix includes a metal side product that is less than 20%, 15%, 12%, 10%, 9%, 8%, 7%, 6%, 5%, 4%, 3%, 2%, 1%, 0.5%, 0.1%, 0.05%, or 0.01% relative to the percentage of the composite matrix. In some embodiments, the metal side product is tungsten diboride (WB₂) or tungsten monoboride (WB). In some embodiments wherein x is not 0, the metal side product is a non-tungsten metal boride. In some embodiments, the non-tungsten metal boride is TiB₂, ZrB₂, HfB₂, VB, VB₂, NbB₂, NbB₂, CrB, CrB₂, Cr₂B, Cr₃B₄, Cr₄B, Cr₅B₃, MoB, MoB₂, Mo_{0.2}B₄, Mo_{0.2}B₅, MnB, MnB₂, MNB₄, Mn₂B, Mn₄B, Mn₃B₄, ReB₂, Re₃B, Re₇B₂, FeB, Fe₂B, RuB₂, Ru₂B₃, OsB, Os₂B₃, OsB₂, CoB, CO₂B, IrB, Ir₂B, NiB, Ni₂B, Ni₃B, CuB, or ZnB.

In some embodiments, at least one allotrope of elemental boron is present in the composite matrix. Allotropes of boron include the following states of boron: alpha rhombohedral, alpha tetragonal, beta rhombohedral, beta tetragonal, orthorhombic (gamma), borophen, borospherene and amorphous boron.

In some embodiments, the radiation shielding comprises a composite matrix of W₁₋ₓMoₓB₄ in Formula I, Formula II, Formula III, or Formula IV. In some embodiments, in a composite matrix described herein, or prepared by the methods herein, the percentage weight of W₁₋ₓMoₓB₄ to excess boron leftover from the synthesis of W₁₋ₓMoₓB₄ is at least 80%, 85%, 88%, 90%, 91%, 92%, 93%, 94%, 95%, 96%, 97%, 98%, 99%, 99.5%, 99.9%, 99.95%, or 99.99%.

In some embodiments, the radiation shielding comprises a composite matrix of W₁₋ₓMoₓB₄ in Formula I, Formula II, Formula III, or Formula IV. In some embodiments, is M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al). In some embodiments, M is one or more of Ti, V, Cr, Mn, Fe, Co, Ni, Cu, Zn, Zr, Nb, Mo, Ru, Hf, Ta, Re, Os, Ir, and Y. In some embodiments, M is one or more of Ti, V, Cr, Mn, Fe, Co, Ni, Cu, Zn, Zr, Nb, Mo, Ru, Hf, Ta, and Re. In some embodiments, M is one or more of Ti, V, Cr, Mn, Fe, Co, Zr, Nb, Mo, Ru, Hf, Ta, and Re. In some embodiments, M is one or more of Ti, V, Cr, Mn, Zr, Nb, Mo, Hf, Ta, and Re. In some embodiments, M is one or more of Ti, V, Zr, Nb, Hf, and Ta. In some embodiments, M is one or more of Cr, Mn, Mo, and Re. In some embodiments, M is one or more of Cr, Ta, Mo, or Mn. In some embodiments, M is one or more of Cr, Ta, Mo, or Mn. In some embodiments, M is Cr; Mn; Mo; Ta and Cr; or Ta and Mo. In some embodiments, M comprises at least one of Re, Ta, Mn, Cr, Hf, Ta, Zr and Y. In some embodiments, M comprises at least one of Re, Ta, Mn and Cr. Sometimes, M comprises at least one of Ta, Mn and Cr. Other times, M comprises at least one of Hf, Zr, and Y. In some instances, M comprises at least Re. In some instances, M comprises at least Ta. In some instances, M comprises at least Mn. In some instances, M comprises at least Cr. In some cases, M comprises at least Hf. In some cases, M comprises at least Zr. In some cases, M comprises at least Y. In some cases, M comprises at least Ti. In some cases, M comprises at least V. In some cases, M comprises at least Co. In some cases, M comprises at least Ni. In some cases, M comprises at least Cu. In some cases, M comprises at least Zn. In some cases, M comprises at least Nb. In some cases, M comprises at least Mo. In some cases, M comprises at least Ru. In some cases, M comprises at least Os. In some cases, M comprises at least Ir. In some cases, M comprises at least Li. In some instances, M comprises two or more elements selected from titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al). In some cases, M comprises Ta and an element selected from Ti, V, Cr, Mn, Fe, Co, Ni, Cu, Zn, Zr, Nb, Mo, Ru, Hf, Re, Os, Ir, Li, Y and Al. In some cases, M comprises Ta and an element selected from Mn or Cr. In some cases, M comprises Hf and an element selected from Ti, V, Cr, Mn, Fe, Co, Ni, Cu, Zn, Zr, Nb, Mo, Ru, Re, Os, Ir, Li, Ta, Y and Al. In some cases, M comprises Zr and an element selected from Ti, V, Cr, Mn, Fe, Co, Ni, Cu, Zn, Ta, Nb, Mo, Ru, Hf, Re, Os, Ir, Li, Y and Al. In some cases, M comprises Y and an element selected from Ti, V, Cr, Mn, Fe, Co, Ni, Cu, Zn, Ta, Nb, Mo, Ru, Hf, Re, Os, Ir, Li, Zr and Al. In some embodiments, Mis selected from Re, Ta, Mn, Cr, Hf, Ta, Zr, Y, Ta and Mn, or Ta and Cr. In some embodiments, M is selected from Re, Ta, Mn, Cr, Ta and Mn, or Ta and Cr. Sometimes, M is selected from Ta, Mn, Cr, Ta and Mn, or Ta and Cr. M can be Re. Other times, M is selected from Hf, Zr, and Y. M can be Ta. M can be Mn. M can be Cr. M can be Ta and Mn. M can be Ta and Cr. M can be Hf. M can be Zr. M can be Y. M can be Ti. M can be V. M can be Co. M can be Ni. M can be Cu. M can be Zn. M can be Nb. M can be Mo. M can be Ru. M can be Os. M can be Ir. M can be Li.

In some embodiments, the radiation shielding comprises a composite matrix of W₁₋ₓMoₓB₄ in Formula I, Formula II, Formula III, or Formula IV. In some embodiments, M is Re, and x is at least 0.001 and less than 0.6. In some embodiments, M is Re, and x is at least 0.001 and less than 0.5. In some embodiments, M is Re, and x is at least 0.001 and less than 0.4. In some embodiments, M is Re, and x is at least 0.001 and less than 0.3. In some embodiments, M is Re, and x is at least 0.001 and less than 0.2. In some embodiments, M is Re, and x is at least 0.001 and less than 0.1. In some embodiments, M is Ta, and x is at least 0.001 and less than 0.6. In some embodiments, M is Ta, and x is at least 0.001 and less than 0.5. In some embodiments, M is Ta, and x is at least 0.001 and less than 0.4. In some embodiments, M is Ta, and x is at least 0.001 and less than 0.3. In some embodiments, M is Ta, and x is at least 0.001 and less than 0.2. In some embodiments, M is Ta, and x is at least 0.001 and less than 0.1. In some embodiments, M is Ta, and x is at least 0.001 and less than 0.05. In some embodiments, M is Ta, and x is about 0.02. In some embodiments, M is Ta, and x is about 0.04. In some embodiments, M is Mn, and x is at least 0.001 and less than 0.6. In some embodiments, M is Mn, and x is at least 0.001 and less than 0.5. In some embodiments, M is Mn, and x is at least 0.001 and less than 0.4. In some embodiments, M is Mn, and x is at least 0.001 and less than 0.3. In some embodiments, M is Mn, and x is at least 0.001 and less than 0.2. In some embodiments, M is Mn, and x is at least 0.001 and less than 0.1. In some embodiments, M is Mn, and x is at least 0.001 and less than 0.05. In some embodiments, M is Cr, and x is at least 0.001 and less than 0.6. In some embodiments, M is Cr, and x is at least 0.001 and less than 0.5. In some embodiments, M is Cr, and x is at least 0.001 and less than 0.4. In some embodiments, M is Cr, and x is at least 0.001 and less than 0.3. In some embodiments, M is Cr, and x is at least 0.001 and less than 0.2. In some embodiments, M is Cr, and x is at least 0.001 and less than 0.1. In some embodiments, M is Cr, and x is at least 0.001 and less than 0.05. In some embodiments, M is Cr, and x is at least 0.001 and less than 0.4. In some embodiments, M is Mo, and x is at least 0.001 and less than 0.4. In some embodiments, M is Mn, and x is at least 0.001 and less than 0.4. In some embodiments, M is Cr and Ta, and x is at least 0.001 and less than 0.4. In some embodiments, M is Ta and Mo, and x is at least 0.01 and less than 0.4. In some embodiments, M comprises Ta and Mn. In some embodiments, M is Ta and Mn. In some embodiments, M comprises Ta and Mn, and x is at least 0.001 and less than 0.6. In some instances, a composite matrix comprises W_{0.94}Ta_{0.02}Mn_{0.04}By, wherein y is at least 4. In some instances, a composite matrix comprises W_{0.94}Ta_{0.02}Mn_{0.04}B₄. In some instances, M comprises Ta and Cr. In some instances, M is Ta and Cr. In some instances, M comprises Ta and Cr, and x is at least 0.001 and less than 0.6. In some instances, a composite matrix comprises W_{0.93}Ta_{0.02}Cr_{0.05}By, wherein y is at least 4. In some instances, a composite matrix comprises W_{0.93}Ta_{0.02}Cr_{0.05}B₄.

In some embodiments, the radiation shielding comprises a composite matrix of W₁₋ₓMoₓB₄ in Formula I, Formula II, Formula III, or Formula IV. In some embodiments, M is one metal. In some embodiments, M is Cr. In some embodiments, the composite matrix is W_{0.99}Cr_{0.01}B₄, W_{0.98}Cr_{0.02}B₄, W_{0.97}Cr_{0.03}B₄, W_{0.96}Cro O₄B₄, W_{0.95}Cr_{0.05}B₄, W_{0.94}Cr_{0.06}B₄, W_{0.93}Cr_{0.07}B₄, W_{0.92}Cr_{0.08}B₄, W_{0.91}Cr_{0.09}B₄, W_{0.90}Cr_{0.10}B₄, W_{0.89}Cr_{0.11}B₄, W_{0.88}Cr_{0.12}B₄, W₀₈₇Cr_{0.13}B₄, W_{0.86}Cr_{0.14}B₄, W_{0.85}Cr_{0.15}B₄, W_{0.84}Cr_{0.16}B₄, W_{0.83}Cr_{0.17}B₄, W_{0.82}Cr_{0.1}sB₄, Wos₈₁Cr_{0.19}B₄, W_{0.80}Cr_{0.2}NB₄, W₀₇₅Cr_{0.25}B₄, W₀.oCr_{0.30}B₄, W_{0.65}Cr_{0.35}B₄, W₀.oCr_{0.40}B₄, W_{0.55}Cr_{0.45}B₄, or W_{0.50}Cr_{0.50}B₄.In some embodiments, M is Mo₀. In some embodiments, the composite matrix is W_{0.99}Mo_{0.0.1}B₄, W_{0.98}Mo_{0.0.02}B₄, W_{0.97}Mo_{0.0.03}B₄, W_{0.96}Mo_{0.0.04}B₄, W_{0.95}Mo_{0.0.05}B₄, W_{0.94}Mo_{0.0.06}B₄, W_{0.93}Mo_{0.0.07}B₄, W_{0.92}Mo_{0.05}O₈B₄, W_{0.91}Mo_{0.0.09}B₄, W_{0.90}Mo_{0.0.10}B₄, W_{0.89}Mo_{0.11}B₄, WossMo_{0.0.12}B₄, Wos₈₇Mo_{0.13}B₄, W_{0.86}Mo_{0.14}B₄, W_{0.85}Mo_{0.15}B₄, W₀₈₄Mo_{0.0.16}B₄, W_{0.83}Mo_{0.0.17}B₄, W_{0.82}Mo_{0.1}B₄, W₀₅₈₁Mo_{0.0.19}B₄, W_{0.80}Mo_{0.0.2}B₄, W_{0.75}Mo_{0.0.25}B₄, W_{0.70}Mo_{0.0}±_{0.30}B₄, W_{0.65}Mo_{0.0}±_{0.35}B₄, W_{0.60}Mo_{0.0.40}B₄, W_{0.55}Mo_{0.0.45}B₄, or W_{0.50}Mo_{0.0.50}B₄. In some embodiments, M is Mn. In some embodiments, the composite matrix is W_{0.99}Mn_{0.01}B₄, W_{0.98}Mn_{0.02}B₄, W_{0.97}Mn_{0.03}B₄, W_{0.96}Mnn₀₀₄B₄, W_{0.95}Mn_{0.05}B₄, W_{0.94}Mn_{0.06}B₄, W_{0.93}Mn_{0.07}B₄, W_{0.92}Mn₀₅O₈B₄, W_{0.91}Mn_{0.09}B₄, W_{0.90}Mn_{0.10}B₄, W_{0.89}Mn_{0.11}B₄, W_{0.88}Mn_{0.12}B₄, W₀₈₇Mn_{0.13}B₄, W_{0.86}Mn_{0.14}B₄, W_{0.85}Mn_{0.15}B₄, W_{0.84}Mn_{0.16}B₄, W_{0.83}Mn_{0.17}B₄, W_{0.82}Mn_{0.18}B₄, W₀.sMn_{0.19}B₄, W_{0.80}Mn_{0.2}NB₄, W₀₇₅Mn_{0.25}B₄, W_{0.0}Mn_{0.30}B₄, W_{0.65}Mn_{0.35}B₄, W_{0.60}Mn_{0.40}B₄, W_{0.55}Mn_{0.45}B₄, or W_{0.50}Mn_{0.50}B₄. In some embodiments, M is Ta. In some embodiments, the composite matrix is W_{0.99}Ta_{0.1}B₄, W_{0.98}Ta_{0.02}B₄, W_{0.97}Ta_{0.03}B₄, W_{0.96}Ta_{0.04}B₄, W_{0.95}Ta_{0.05}B₄, W_{0.94}Ta_{0.06}B₄, W_{0.93}Ta_{0.07}B₄, W_{0.92}Ta_{0.08}B₄, W_{0.91}Ta_{0.09}B₄, W_{0.90}Ta_{0.10}B₄, W_{0.89}Ta_{0.11}B₄, W₀₅₈₈Ta_{0.12}B₄, Wos₈₇Ta_{0.13}B₄, W_{0.86}Ta_{0.14}B₄, W_{0.85}Ta_{0.15}B₄, W_{0.84}Ta_{0.16}B₄, W_{0 83}Ta_{0.17}B₄, W_{0.82}Ta₀₁₈B₄, W₀₅₈₁Ta_{0.19}B₄, Wos₈₀Ta_{0.21}B₄, W_{0.75}Ta_{0.25}B₄, W_{0.70}Ta₀±_{0.30}B₄, W_{0 0.65}Ta_{0.35}B₄, W_{0.60}Ta_{0.40}B₄, W_{0.55}Ta_{0.45}B₄, or W_{0.0}.oTa_{0.0}.oB₄. In some embodiments, M is Re. In some embodiments, the composite matrix is W_{0.99}Re_{0.1}B₄, W_{0.98}Re_{0.02}B₄, W_{0.97}Re_{0.3}B₄, W_{0.96}Re_{0.04}B₄, W₀₉₅Re_{0.05}B₄, W_{0.94}Re_{0.06}B₄, W_{0.93}Re_{0.07}B₄, W_{0.92}Re₀₅O₈B₄, W_{0.91}Re_{0.09}B₄, W_{0.90}Re_{0.10}B₄, W_{0.89}Re_{0.11}B₄, W₀₅₈₈Re_{0.12}B₄, W_{0.87}Re_{0.13}B₄, W_{0.86}Re_{0.14}B₄, W_{0.85}Re_{0.15}B₄, W_{0.84}Re_{0.16}B₄, W_{0.83}Re_{0.17}B₄, W_{0.82}Re_{0.1}B₄, Wos₈₁Re_{0.19}B₄, Wos₈₀Re₀.N₂B₄, W_{0.075}Re_{0.25}B₄, W_{0.70}Re_{0.30}B₄, W₀₆₅Re₀±_{0.35}B₄, W_{0.60}Re_{0.40}B₄, W_{0.55}Re_{0.45}B₄, or W_{0.50}Re_{0.50}B₄. In some embodiments, M is V. In some embodiments, the composite matrix is W_{0.99}V_{0.01}B₄, W_{0.9}sV_{0.02}B₄, W_{0.97}V_{0.3}B₄, W_{0.96}V_{0.04}B₄, W_{0.95}V_{0.05}B₄, W_{0.94}Vo_{0.6}B₄, W_{0.93}V_{0.07}B₄, W_{0.92}Vo osB₄, W_{0.91}V_{0.10}O₉B₄, W_{0.90}V_{0.10}B₄, W_{0.89}V_{0.11}B₄, W_{0.8}sV_{0.12}B₄, W_{0.87}V_{0.13}B₄, W_{0.86}V_{0.14}B₄, W_{0.85}V_{0.15}B₄, W_{0.84}V_{0.16}B₄, W_{0.83}V_{0.17}B₄, W_{0.82}V_{0.18}B₄, W_{0.81}V_{0.19}B₄, W_{0.65}V_{0.2}B₄, W_{0.75}V_{0.25}B₄, W_{0.70}V_{0.30}B₄, W_{0.65}V_{0.35}B₄, W_{0.60}V_{0.40}B₄, W_{0.55}V_{0.45}B₄, or W_{0.50}V_{0.50}B₄. In some embodiments, M is Nb. In some embodiments, the composite matrix is W_{0.99}Nb_{0.01}B₄, W_{0.98}Nb_{0.02}B₄, W_{0.97}Nb_{0.03}B₄, W_{0.96}Nb_{0.04}B₄, W_{0.95}Nb_{0.05}B₄, W_{0.94}Nb_{0.06}B₄, W_{0.93}Nb_{0.07}B₄, W_{0.92}Nb₀₅O₈B₄, W_{0.91}Nb_{0.09}B₄, W_{0.090}Nb_{0.10}B₄, W_{0.89}Nb_{0 11}B₄, W_{0.88}Nb_{0.12}B₄, W_{0.87}Nb_{0.13}B₄, W_{0.86}Nb_{0.14}B₄, W_{0.85}Nb_{0.15}B₄, W_{0.84}NbN_{0.16}B₄, W_{0.83}Nb_{0.17}B₄, W_{0.82}Nb_{0.18}B₄, W_{0.81}Nb_{0.19}B₄, W_{0.80}Nb₀₂₀B₄, W_{0.75}Nb_{0.25}B₄, W_{0.70}Nb₀±_{0.30}B₄, W_{0.65}Nb_{0.35}B₄, W_{0.60}Nb₀₄₀B₄, W_{0.55}Nb_{0.45}B₄, or W_{0.50}Nb_{0.50}B₄.

In some embodiments, the radiation shielding comprises a composite matrix of W₁₋ₓMoₓB₄ in Formula I, Formula II, Formula III, or Formula IV. In some embodiments, M is two or more metals. In such embodiments, the sum of the molar ratios of the two or more metals equal x. In some embodiments, at least one metal is Cr, Ta, Mo, or Mn. In some embodiments, M is Ta and Cr, and the sum of the molar ratios of Ta and Cr equal x. In some embodiments, the composite matrix is W_{0.98}Ta_{0.01}Cr_{0.01}B₄, W_{0.97}Ta_{0.01}Cr_{0.02}B₄, W_{0.96}Ta_{0.03}Cr_{0.01}B₄, W_{0.95}Ta_{0.01}Cr_{0.04}B₄, W_{0.94}Ta_{0.01}Cr_{0.05}B₄, W_{0.93}Ta_{0.01}Cr_{0.06}B₄, W_{0.92}Ta_{0.01}Cr_{0.07}B₄, W_{0.91}Ta_{0.01}Cr_{0.08}B₄, W_{0.9}Ta_{0.01}Cr_{0.09}B₄, W_{0.89}Ta_{0.01}Cr_{0.1}B₄, W_{0.88}Ta_{0.01}Cr_{0.11}B₄, W_{0.87}Ta_{0.01}Cr_{0.12}B₄, W_{0.86}Ta_{0.01}Cr_{0.13}B₄, W_{0.85}Ta_{0.01}Cr_{0.14}B₄, W_{0.98}Ta_{0.02}Cr_{0.01}B₄, W_{0.96}Ta_{0.02}Cr_{0.02}B₄, W_{0.95}Ta_{0.02}Cr_{0.03}B₄, W_{0.94}Ta_{0.02}Cr_{0.04}B₄, W_{0.93}Ta_{0.02}Cr_{0.05}B₄, W_{0.92}Ta_{0.02}Cr_{0.06}B₄, W_{0.91}Ta_{0.02}Cr_{0.07}B₄, W_{0.90}Ta_{0.02}Cr_{0.08}B₄, W_{0.89}Ta_{0.02}Cr_{0.09}B₄, W_{0.88}Ta_{0.02}Cr_{0.1}B₄, W_{0.87}Ta_{0.2}Cr_{0.11}B₄, W₀₈₆Ta_{0.02}Cr_{0.12}B₄, W_{0.85}Ta_{0.02}Cr_{0.13}B₄, W_{0.84}Ta_{0.02}Cr_{0.14}B₄, W_{0.96}Ta_{0.03}Cr_{0.01}B₄, W_{0.95}Ta_{0.03}Cr_{0.02}B₄, W_{0.94}Ta_{0.03}Cr_{0.03}B₄, W_{0.93}Ta_{0.03}Cr_{0.04}B₄, W_{0.92}Ta_{0.03}Cr_{0.05}B₄, W_{0.91}Ta_{0.03}Cr_{0.06}B₄, W_{0.90}Ta_{0.03}Cr_{0.07}B₄, W_{0.89}Ta_{0.03}Cr₀₅O₈B₄, W_{0.88}Ta_{0.03}Cr_{0.09}B₄, W_{0.87}Ta_{0.03}Cr_{0.1}B₄, W_{0.86}Ta_{0.03}Cr_{0.11}B₄, W_{0.85}Ta_{0.03}Cr_{0.12}B₄, W_{0.84}Ta_{0.03}Cr_{0.13}B₄, W_{0.83}Ta_{0.03}Cr_{0.14}B₄, W_{0.95}Ta_{0.0.4}Cr_{0.10}O₁B₄, W_{0.94}Ta_{0.04}Cr_{0.02}B₄, W_{0.93}Ta_{0.04}Cr_{0.03}B₄, W_{0.92}Ta_{0.0.4}Cr_{0.10}O₄B₄, W_{0.91}Ta_{0.04}Cr_{0.05}B₄, W_{0.90}Ta_{0.04}Cr_{0.06}B₄, W_{0.89}Ta_{0.04}Cr_{0.07}B₄, W₀₈₈Ta_{0.04}Cr₀₅O₈B₄, W_{0.87}Ta_{0.0.4}Cr_{0.10}O₉B₄, W_{0 86}Ta_{0.0.4}Cr_{0.1}B₄, W_{0 85}Ta_{0.0.4}Cr_{0.11}B₄, W_{0.84}Ta_{0.04}Cr_{0.12}B₄, W_{0.83}Ta_{0.0.4}Cr_{0.13}B₄, W_{0 82}Ta_{0.0.4}Cr_{0.14}B₄, W_{0.94}Ta_{0.05}Cr_{0.1}B₄, W_{0.93}Ta_{0.0.5}Cr_{0.10}O₂B₄, W₀₉₂Ta_{0.05}Cr_{0.03}B₄, W_{0.91}Ta_{0.05}Cr_{0.04}B₄, W_{0.90}Ta_{0.05}Cr_{0.05}B₄, W_{0.89}Ta_{0.05}Cr_{0.06}B₄, W₀₈₈Ta_{0.05}Cr_{0.07}B₄, W₀ s₈₇Ta_{0.05}Cr₀₅O₈B₄, W_{0.86}Ta_{0.05}Cr_{0.09}B₄, W_{0.85}Ta_{0.05}Cr_{0.1}B₄, W_{0.84}Ta_{0.0.5}Cr_{0.11}B₄, W_{O 83}Ta_{0.0.5}Cr_{0.12}B₄, W_{0.82}Ta_{0.05}Cr_{0.13}B₄, or W_{0.81}Ta_{0.0.5}Cr_{0.14}B₄. In some embodiments, M is Ta and Mo, and the sum of the molar ratios of Ta and Mo equal x. In some embodiments, the composite matrix is W_{0.98}Ta_{0.01}Mo_{0.0.01}B₄, W_{0.97}Ta_{0.01}Mo_{0.0.02}B₄, W_{0.96}Ta_{0.03}Mo_{0.0}O₁B₄, W_{0.95}Ta_{0.01}Mo_{0.04}B₄, W_{0.94}Ta_{0.1}Mo_{0.05}B₄, W_{0.93}Ta_{0.1}Mo_{0.06}B₄, W_{0.92}Ta_{0.01}Mo_{0.07}B₄, W_{0.91}Ta₀.oMo_{0.0.08}B₄, W_{0.90}Ta_{0.01}Mo_{0.0.09}B₄, W_{0.89}Ta_{0.01}Mo_{0.1}B₄, W₀₈₈Ta_{0.1}Mo_{0.0 11}B₄, Wo s₈₇Ta_{0.1}Mo_{0.0.12}B₄, W₀₅₈₆Ta_{0.1}Mo_{0.0.13}B₄, W_{0.85}Ta_{0.1}Mo_{0.0 14}B₄, W_{0.98}Ta_{0.02}Mo_{0.10}O₁B₄, W_{0.96}Ta_{0.02}Mo_{0.02}B₄, W_{0.95}Ta_{0.02}Mo_{0.03}B₄, W_{0.94}Ta_{0.10}O₂Mo_{0.10}O₄B₄, W_{0.93}Ta_{0.02}Mo_{0.0.05}B₄, W_{0.92}Ta_{0.02}Mo_{0.06}B₄, W_{0.91}Ta_{0.02}Mo_{0.07}B₄, W_{0.90}Ta_{0.02}Mo_{0.0.08}B₄, W_{0.89}Ta_{0.02}Mo_{0.09}B₄, W_{0.88}Ta_{0.02}Mo_{0.1}B₄, W_{0.87}Ta_{0.02}Mo_{0.11}B₄, W_{0.86}Ta_{0.02}Mo_{0.0.12}B₄, W_{0.85}Ta_{0.02}Mo_{0.13}B₄, W_{0.84}Ta_{0.02}Mo_{0.14}B₄, W_{0.96}Ta_{0.03}Mo_{0.0.1}B₄, W_{0.95}Ta_{0.03}Mo_{0.02}B₄, W_{0.94}Ta_{0.0.3}Mo_{0.10}O_{0.3}B₄, W_{0.93}Ta_{0.03}Mo_{0.04}B₄, W_{0.92}Ta_{0.03}Mo_{0.05}B₄, W_{0.91}Ta_{0.0.3}Mo_{0.0.6}B₄, W_{0.90}Ta_{0.0.3}Mo_{0.10}O₇B₄, W_{0.89}Ta_{0.03}Mo_{0.05}O₈B₄, W_{0.88}Ta_{0.03}Mo_{0.009}B₄, W_{0.87}Ta_{0.0.3}Mo_{0.1}B₄, W₀₈₆Ta_{0.03}Mo_{0.11}B₄, W_{0.85}Ta_{0.03}Mo_{0.12}B₄, W_{0.84}Ta_{0.03}Mo_{0.0 13}B₄, W_{0.83}Ta_{0.03}Mo_{0.14}B₄, W_{0.95}Ta_{0.0.4}Mo_{0.10}O₁B₄, W_{0.94}Ta_{0.04}Mo_{0.02}B₄, W_{0.93}Ta_{0.04}Mo_{0.03}B₄, W_{0.92}Ta_{0.0.4}Mo_{0.10}O₄B₄, W_{0.91}Ta_{0.04}Mo_{0.05}B₄, W_{0.0.90}Ta_{0.04}Mo_{0.06}B₄, W_{0.89}Ta_{0.04}Mo_{0.07}B₄, W₀₈₈Ta_{0.04}Mo_{0.05}O₈B₄, WOy₈₇Ta_{0.04}Mo_{0.00}O₉B₄, W₀ s₈₆Ta_{0.04}Mo_{0.0.1}B₄, W_{0.85}Ta_{0.04}Mo_{0.11}B₄, W_{0.84}Ta_{0.04}Mo_{0.0.12}B₄, W_{0.83}Ta_{0.04}Mo_{0.13}B₄, W_{0.82}Ta_{0.04}Mo_{0.14}B₄, W_{0.94}Ta_{0.05}Mo_{0.0.1}B₄, W_{0.93}Ta_{0.05}Mo_{0.02}B₄, W_{0.92}Ta_{0.0.5}Mo_{0.3}B₄, W_{0.91}Ta_{0.05}Mo_{0.04}B₄, W_{0.90}Ta_{0.05}Mo_{0.05}B₄, W_{0.89}Ta_{0.0.5}Mo_{0.0.6}B₄, W₀₈₈Ta_{0.05}Mo_{0.07}B₄, W₀ s₈₇Ta_{0.05}Mo_{0.008}B₄, W_{0.86}Ta_{0.05}Mo_{0.00}O₉B₄, W_{0.85}Ta_{0.05}Mo_{0.1}B₄, W_{0.84}Ta_{0.05}Mo_{0.11}B₄, W_{0.83}Ta_{0.05}Mo_{0.12}B₄, W_{0.82}Ta_{0.05}Mo_{0.0.13}B₄, or W_{0.81}Ta_{0.05}Mo_{0.14}B₄.

### Ceramics

Described herein are composite matrices of (W₁₋ₓMoₓB₄)_{z}(Q)ₙ (Formula II) or (W₁.ₓMoₓB₄)_{z}(T)_{q}(Q)ₙ (Formula IV). In some embodiments, Q is one or more ceramics. The chemical properties of the ceramic affects the reactivity of the ceramic with W₁₋ₓMoₓB₄ or WB₄ under the synthetic conditions described herein. For example, ceramics with lower melting points may have higher mobility under the required synthetic conditions and react with a higher proportion of the W₁₋ₓMoₓB₄ or WB₄. In another example, denser ceramics may have a lower reactivity and mobility at the elevated temperatures required to form the composite matrices. Melting points and densities of some of the ceramics in the disclosure are listed below in Table 1.

TABLE 1

| Ceramic | Melting point (° C.) | Density (g/cm³) |
|---|---|---|
| TiB₂ | 3,230 | 4.52 |
| HfB₂ | 3,250 | 10.5 |
| ReB₂ | 2,400 | 12.7 |
| B₄C | 2,763 | 2.52 |
| cubic-BN | 2,973 | 3.45 |
| B₆O | 2,000 | 2.56 |
| TiC | 3,160 | 4.93 |
| ZrC | 3,532-3,540 | 6.73 |
| VC | 2,810 | 5.77 |
| NbC | 3,608 | 7.820 |
| TaC | 4,780-5,470 | 14.3-14.65 |
| Cr₃C₂ | 1,895 | 6.68 |
| MoC | 2,687 | 8.90 |
| SiC | 2,830 | 3.16 |
| TiN | 2,947 | 5.21 |
| ZrN | 2,952 | 7.09 |
| TiSi2 | 1,470 | 4.02 |
| Si₃N₄ | 1,900 | 3.17 |
| TiO₂ | 1,843 | 4.23 (rutile), |
| | | 3.78 (anatase) |
| ZrO₂ | 2,715 | 5.68 |
| Al₂O₃ | 2,072 | 3.987 |
| SiO₂ | 1,713 | 2.648 (α-quartz), |
| | | 2.196 (amorphous) |
| WB₄ | 2,000 | 9.6-10.1 |

In some embodiments, Q is one or more ceramics with a melting point above 1500° C., 1600° C., 1700° C., 1800° C., 1900° C., 2000° C., 2100° C., 2200° C., 2300° C., 2400° C., 2500° C., 2600° C., 2700° C., 2800° C., 2900° C., 3000° C., 3100° C., 3200° C., 3300° C., 3400° C., 3500° C., 3600° C., 3700° C., 3800° C., 3900° C., 4000° C., or 4500° C. In some embodiments, Q is one or more ceramics with a melting point below 1500° C., 1600° C., 1700° C., 1800° C., 1900° C., 2000° C., 2100° C., 2200° C., 2300° C., 2400° C., 2500° C., 2600° C., 2700° C., 2800° C., 2900° C., 3000° C., 3100° C., 3200° C., 3300° C., 3400° C., 3500° C., 3600° C., 3700° C., 3800° C., 3900° C., 4000° C., or 4500° C. In some embodiments, Q is one or more ceramics with a melting point of about 1,500° C. to about 5,500° C. In some embodiments, Q is one or more ceramics with a melting point of about 1,500° C., about 2,000° C., about 2,300° C., about 2,500° C., about 2,700° C., about 3,000° C., about 3,200° C., about 3,400° C., about 3,700° C., about 4,000° C., about 4,500° C., or about 5,500° C. In some embodiments, Q is one or more ceramics with a melting point of at least about 1,500° C., about 2,000° C., about 2,300° C., about 2,500° C., about 2,700° C., about 3,000° C., about 3,200° C., about 3,400° C., about 3,700° C., about 4,000° C., or about 4,500° C. In some embodiments, Q is one or more ceramics with a melting point of at most about 2,000° C., about 2,300° C., about 2,500° C., about 2,700° C., about 3,000° C., about 3,200° C., about 3,400° C., about 3,700° C., about 4,000° C., about 4,500° C., or about 5,500° C. In some embodiments, Q is one or more ceramics with a melting point of about 1,400° C. to about 5,500° C. In some embodiments, Q is one or more ceramics with a melting point of about 1,400° C. to about 1,700° C., about 1,400° C. to about 2,000° C., about 1,400° C. to about 2,250° C., about 1,400° C. to about 2,500° C., about 1,400° C. to about 2,750° C., about 1,400° C. to about 3,000° C., about 1,400° C. to about 3,500° C., about 1,400° C. to about 4,000° C., about 1,400° C. to about 4,500° C., about 1,400° C. to about 5,000° C., about 1,400° C. to about 5,500° C., about 1,700° C. to about 2,000° C., about 1,700° C. to about 2,250° C., about 1,700° C. to about 2,500° C., about 1,700° C. to about 2,750° C., about 1,700° C. to about 3,000° C., about 1,700° C. to about 3,500° C., about 1,700° C. to about 4,000° C., about 1,700° C. to about 4,500° C., about 1,700° C. to about 5,000° C., about 1,700° C. to about 5,500° C., about 2,000° C. to about 2,250° C., about 2,000° C. to about 2,500° C., about 2,000° C. to about 2,750° C., about 2,000° C. to about 3,000° C., about 2,000° C. to about 3,500° C., about 2,000° C. to about 4,000° C., about 2,000° C. to about 4,500° C., about 2,000° C. to about 5,000° C., about 2,000° C. to about 5,500° C., about 2,250° C. to about 2,500° C., about 2,250° C. to about 2,750° C., about 2,250° C. to about 3,000° C., about 2,250° C. to about 3,500° C., about 2,250° C. to about 4,000° C., about 2,250° C. to about 4,500° C., about 2,250° C. to about 5,000° C., about 2,250° C. to about 5,500° C., about 2,500° C. to about 2,750° C., about 2,500° C. to about 3,000° C., about 2,500° C. to about 3,500° C., about 2,500° C. to about 4,000° C., about 2,500° C. to about 4,500° C., about 2,500° C. to about 5,000° C., about 2,500° C. to about 5,500° C., about 2,750° C. to about 3,000° C., about 2,750° C. to about 3,500° C., about 2,750° C. to about 4,000° C., about 2,750° C. to about 4,500° C., about 2,750° C. to about 5,000° C., about 2,750° C. to about 5,500° C., about 3,000° C. to about 3,500° C., about 3,000° C. to about 4,000° C., about 3,000° C. to about 4,500° C., about 3,000° C. to about 5,000° C., about 3,000° C. to about 5,500° C., about 3,500° C. to about 4,000° C., about 3,500° C. to about 4,500° C., about 3,500° C. to about 5,000° C., about 3,500° C. to about 5,500° C., about 4,000° C. to about 4,500° C., about 4,000° C. to about 5,000° C., about 4,000° C. to about 5,500° C., about 4,500° C. to about 5,000° C., about 4,500° C. to about 5,500° C., or about 5,000° C. to about 5,500° C. In some embodiments, Q is one or more ceramics with a melting point of about 1,400° C., about 1,700° C., about 2,000° C., about 2,250° C., about 2,500° C., about 2,750° C., about 3,000° C., about 3,500° C., about 4,000° C., about 4,500° C., about 5,000° C., or about 5,500° C. In some embodiments, Q is one or more ceramics with a melting point of at least about 1,400° C., about 1,700° C., about 2,000° C., about 2,250° C., about 2,500° C., about 2,750° C., about 3,000° C., about 3,500° C., about 4,000° C., about 4,500° C., or about 5,000° C. In some embodiments, Q is one or more ceramics with a melting point of atmost about 1,700° C., about 2,000° C., about 2,250° C., about 2,500° C., about 2,750° C., about 3,000° C., about 3,500° C., about 4,000° C., about 4,500° C., about 5,000° C., or about 5,500° C.

In some embodiments, Q is one or more ceramics with a density of about 2 g/cm³ to about 15 g/cm³. In some embodiments, Q is one or more ceramics with a density of about 2 g/cm³, about 3 g/cm³, about 4 g/cm³, about 5 g/cm³, about 6 g/cm³, about 7 g/cm³, about 8 g/cm³, about 9 g/cm³, about 10 g/cm³, about 12 g/cm³, or about 15 g/cm³. In some embodiments, Q is one or more ceramics with a density of at least about 2 g/cm³, about 3 g/cm³, about 4 g/cm³, about 5 g/cm³, about 6 g/cm³, about 7 g/cm³, about 8 g/cm³, about 9 g/cm³, about 10 g/cm³, or about 12 g/cm³. In some embodiments, Q is one or more ceramics with a density of at most about 3 g/cm³, about 4 g/cm³, about 5 g/cm³, about 6 g/cm³, about 7 g/cm³, about 8 g/cm³, about 9 g/cm³, about 10 g/cm³, about 12 g/cm³, or about 15 g/cm³. In some embodiments, Q is one or more ceramics with a density of at most about 2 g/cm³, about 3 g/cm³, about 4 g/cm³, about 5 g/cm³, about 6 g/cm³, about 7 g/cm³, about 8 g/cm³, about 9 g/cm³, about 10 g/cm³, or about 12 g/cm³. In some embodiments, Q is one or more ceramics with a density of at most about 3 g/cm³, about 4 g/cm³, about 5 g/cm³, about 6 g/cm³, about 7 g/cm³, about 8 g/cm³, about 9 g/cm³, about 10 g/cm³, about 12 g/cm³, or about 15 g/cm³. In some embodiments, Q is one or more ceramics with a density of about 2 g/cm³ to about 15 g/cm³. In some embodiments, Q is one or more ceramics with a density of about 2 g/cm³ to about 3 g/cm³, about 2 g/cm³ to about 4 g/cm³, about 2 g/cm³ to about 5 g/cm³, about 2 g/cm³ to about 6 g/cm³, about 2 g/cm³ to about 7 g/cm³, about 2 g/cm³ to about 8 g/cm³, about 2 g/cm³ to about 9 g/cm³, about 2 g/cm³ to about 10 g/cm³, about 2 g/cm³ to about 11 g/cm³, about 2 g/cm³ to about 12 g/cm³, about 2 g/cm³ to about 15 g/cm³, about 3 g/cm³ to about 4 g/cm³, about 3 g/cm³ to about 5 g/cm³, about 3 g/cm³ to about 6 g/cm³, about 3 g/cm³ to about 7 g/cm³, about 3 g/cm³ to about 8 g/cm³, about 3 g/cm³ to about 9 g/cm³, about 3 g/cm³ to about 10 g/cm³, about 3 g/cm³ to about 11 g/cm³, about 3 g/cm³ to about 12 g/cm³, about 3 g/cm³ to about 15 g/cm³, about 4 g/cm³ to about 5 g/cm³, about 4 g/cm³ to about 6 g/cm³, about 4 g/cm³ to about 7 g/cm³, about 4 g/cm³ to about 8 g/cm³, about 4 g/cm³ to about 9 g/cm³, about 4 g/cm³ to about 10 g/cm³, about 4 g/cm³ to about 11 g/cm³, about 4 g/cm³ to about 12 g/cm³, about 4 g/cm³ to about 15 g/cm³, about 5 g/cm³ to about 6 g/cm³, about 5 g/cm³ to about 7 g/cm³, about 5 g/cm³ to about 8 g/cm³, about 5 g/cm³ to about 9 g/cm³, about 5 g/cm³ to about 10 g/cm³, about 5 g/cm³ to about 11 g/cm³, about 5 g/cm³ to about 12 g/cm³, about 5 g/cm³ to about 15 g/cm³, about 6 g/cm³ to about 7 g/cm³, about 6 g/cm³ to about 8 g/cm³, about 6 g/cm³ to about 9 g/cm³, about 6 g/cm³ to about 10 g/cm³, about 6 g/cm³ to about 11 g/cm³, about 6 g/cm³ to about 12 g/cm³, about 6 g/cm³ to about 15 g/cm³, about 7 g/cm³ to about 8 g/cm³, about 7 g/cm³ to about 9 g/cm³, about 7 g/cm³ to about 10 g/cm³, about 7 g/cm³ to about 11 g/cm³, about 7 g/cm³ to about 12 g/cm³, about 7 g/cm³ to about 15 g/cm³, about 8 g/cm³ to about 9 g/cm³, about 8 g/cm³ to about 10 g/cm³, about 8 g/cm³ to about 11 g/cm³, about 8 g/cm³ to about 12 g/cm³, about 8 g/cm³ to about 15 g/cm³, about 9 g/cm³ to about 10 g/cm³, about 9 g/cm³ to about 11 g/cm³, about 9 g/cm³ to about 12 g/cm³, about 9 g/cm³ to about 15 g/cm³, about 10 g/cm³ to about 11 g/cm³, about 10 g/cm³ to about 12 g/cm³, about 10 g/cm³ to about 15 g/cm³, about 11 g/cm³ to about 12 g/cm³, about 11 g/cm³ to about 15 g/cm³, or about 12 g/cm³ to about 15 g/cm³. In some embodiments, Q is one or more ceramics with a density of about 2 g/cm³, about 3 g/cm³, about 4 g/cm³, about 5 g/cm³, about 6 g/cm³, about 7 g/cm³, about 8 g/cm³, about 9 g/cm³, about 10 g/cm³, about 11 g/cm³, about 12 g/cm³, or about 15 g/cm³. In some embodiments, Q is one or more ceramics with a density of at least about 2 g/cm³, about 3 g/cm³, about 4 g/cm³, about 5 g/cm³, about 6 g/cm³, about 7 g/cm³, about 8 g/cm³, about 9 g/cm³, about 10 g/cm³, about 11 g/cm³, or about 12 g/cm³. In some embodiments, Q is one or more ceramics with a density of at most about 3 g/cm³, about 4 g/cm³, about 5 g/cm³, about 6 g/cm³, about 7 g/cm³, about 8 g/cm³, about 9 g/cm³, about 10 g/cm³, about 11 g/cm³, about 12 g/cm³, or about 15 g/cm³.

In some instances, n is about 0.001, 0.005, 0.01, 0.05, 0.1, 0.15, 0.2, 0.25, 0.3, ±0.35, 0.4, 0.45 or 0.5. In some cases, n is about 0.001. In some instances, n is at least about 0.001, 0.005, 0.01, 0.05, 0.1, 0.15, 0.2, 0.25, 0.3, ±0.35, 0.4, 0.45 or 0.5. In some instances, n is no more than about 0.001, 0.005, 0.01, 0.05, 0.1, 0.15, 0.2, 0.25, 0.3, ±0.35, 0.4, 0.45 or 0.5. In some cases, n is about 0.001. In some cases, n is about 0.001. In some cases, n is about 0.005. In some cases, n is about 0.01. In some cases, n is about 0.05. In some cases, n is about 0.1. In some cases, n is about 0.15. In some cases, n is about 0.2. In some cases, n is about 0.25. In some cases, n is about 0.3. In some cases, n is about 0.35. In some cases, n is about 0.4. In some cases, n is about 0.45. In some cases, n is about 0.5. In some embodiments, n is about 0.001 to about 0.999. In some embodiments, n is about 0.001 to about 0.1, about 0.001 to about 0.2, about 0.001 to about 0.4, about 0.001 to about 0.6, about 0.001 to about 0.65, about 0.001 to about 0.7, about 0.001 to about 0.75, about 0.001 to about 0.8, about 0.001 to about 0.85, about 0.001 to about 0.9, about 0.001 to about 0.999, about 0.1 to about 0.2, about 0.1 to about 0.4, about 0.1 to about 0.6, about 0.1 to about 0.65, about 0.1 to about 0.7, about 0.1 to about 0.75, about 0.1 to about 0.8, about 0.1 to about 0.85, about 0.1 to about 0.9, about 0.1 to about 0.999, about 0.2 to about 0.4, about 0.2 to about 0.6, about 0.2 to about 0.65, about 0.2 to about 0.7, about 0.2 to about 0.75, about 0.2 to about 0.8, about 0.2 to about 0.85, about 0.2 to about 0.9, about 0.2 to about 0.999, about 0.4 to about 0.6, about 0.4 to about 0.65, about 0.4 to about 0.7, about 0.4 to about 0.75, about 0.4 to about 0.8, about 0.4 to about 0.85, about 0.4 to about 0.9, about 0.4 to about 0.999, about 0.6 to about 0.65, about 0.6 to about 0.7, about 0.6 to about 0.75, about 0.6 to about 0.8, about 0.6 to about 0.85, about 0.6 to about 0.9, about 0.6 to about 0.999, about 0.65 to about 0.7, about 0.65 to about 0.75, about 0.65 to about 0.8, about 0.65 to about 0.85, about 0.65 to about 0.9, about 0.65 to about 0.999, about 0.7 to about 0.75, about 0.7 to about 0.8, about 0.7 to about 0.85, about 0.7 to about 0.9, about 0.7 to about 0.999, about 0.75 to about 0.8, about 0.75 to about 0.85, about 0.75 to about 0.9, about 0.75 to about 0.999, about 0.8 to about 0.85, about 0.8 to about 0.9, about 0.8 to about 0.999, about 0.85 to about 0.9, about 0.85 to about 0.999, or about 0.9 to about 0.999. In some embodiments, n is about 0.001, about 0.1, about 0.2, about 0.4, about 0.6, about 0.65, about 0.7, about 0.75, about 0.8, about 0.85, about 0.9, or about 0.999. In some embodiments, n is at least about 0.001, about 0.1, about 0.2, about 0.4, about 0.6, about 0.65, about 0.7, about 0.75, about 0.8, about 0.85, or about 0.9. In some embodiments, n is at most about 0.1, about 0.2, about 0.4, about 0.6, about 0.65, about 0.7, about 0.75, about 0.8, about 0.85, about 0.9, or about 0.999.

Described herein are composite matrices of (W₁₋ₓMoₓB₄)_{z}(Q)ₙ (Formula II) or (W₁₋ₓMoₓB₄)_{z}(T)_{q}(Q)ₙ (Formula IV). In some embodiments, Q is one or more ceramics, wherein each of the one or more ceramics comprises at least two elements, and at least one of the two elements is B (boron), C (carbon), Si (silicon), N (nitrogen), or O (oxygen). In some embodiments, the one or more ceramics comprises at least B, C, Si, or N. In some embodiments, the one or more ceramics comprises at least B, C, or Si. In some embodiments, the one or more ceramics comprises at least O. In some embodiments, the one or more ceramics comprises at least B. In some embodiments, the one or more ceramics comprises at least C. In some embodiments, the one or more ceramics comprises at least N. In some embodiments, the one or more ceramics comprises at least Si. In some embodiments, the one or more ceramics comprises one or more metal selected from Ti, Zr, Hf, V, Nb, Ta, Cr, Mo, W, Mn, Re, Fe, and Ru. In some embodiments, the one or more ceramics comprises one or more metal selected from Ti, V, Nb, Ta, Cr, Mo, W, Mn, Re, Fe, and Ru. In some embodiments, the one or more ceramics comprises one or more metal selected from Cr, Mo, W, Mn, Re, Fe, and Ru. In some embodiments, the one or more ceramics comprises one or more metal selected from Ti, Zr, Hf, V, Nb, and Ta. In some embodiments, the one or more ceramics does not comprise a ceramic containing Hf, Zr, or Y.

In some embodiments, Q is one or more ceramics selected from TiB₂, HfB₂, TaB₂, FeB₄, RuB₂, Ru₂B₃, ReB₂, B₄C, B₄Si, cubic-BN, BCN, BC₂N, B₂O₃, B₆O, TiC, ZrC, VC, NbC, NbC₂, TaC, Cr₃C₂, MoC, MoC₂, SiC, TiN, ZrN, TiSi, TiSi₂, Ti₅Si₃, SiAlON, Si₃N₄, TiO₂, ZrO₂, Al₂O₃, and SiO₂. In some embodiments, Q is one or more ceramics selected from TiB₂, TaB₂, FeB₄, RuB₂, Ru₂B₃, ReB₂, B₄C, B₄Si, cubic-BN, BCN, BC₂N, B₂O₃, B₆O, TiC, ZrC, VC, NbC, NbC₂, TaC, Cr₃C₂, MoC, MoC₂, SiC, TiN, ZrN, TiSi, TiSi₂, Ti₅Si₃, SiAlON, Si₃N₄, TiO₂, ZrO₂, Al₂O₃, and SiO₂. In some embodiments, Q is one or more ceramics selected from TiB₂, HfB₂, TaB₂, FeB₄, RuB₂, Ru₂B₃, ReB₂, B₄C, B₄Si, cubic-BN, BCN, BC₂N, B₂O₃, and B₆O. In some embodiments, Q is one or more ceramics selected from TiB₂, TaB₂, FeB₄, RuB₂, Ru₂B₃, ReB₂, B₄C, B₄Si, cubic-BN, BCN, BC₂N, B₂O₃, and B₆O. In some embodiments, Q is one or more ceramics selected from B₄C, BCN, BC₂N, TiC, ZrC, VC, NbC, NbC₂, TaC, MoC, MoC₂, and SiC. In some embodiments, Q is one or more ceramics selected from cubic-BN, BCN, BC₂N, TiN, ZrN, SiAlON, and Si₃N₄. In some embodiments, Q is one or more ceramics selected from B₂O₃, B₆O, TiO₂, ZrO₂, Al₂O₃, and SiO₂. In some embodiments, Q is one or more ceramics selected from SiC, TiSi, TiSi₂, Ti₅Si₃, SiAlON, Si₃N₄, and SiO₂. In some embodiments, Q is one or more ceramics selected from TiB₂, SiC, or B₄C. In some embodiments, Q is not tungsten carbide.

In some embodiments, W₁₋ₓMoₓB₄ or WB₄ and Q react to form the grain boundaries described herein. In some embodiments, reaction product is a metal boride. In some embodiments, the metal boride is WB, WB₂, TiB₂, ZrB₂, HfB₂, VB, VB₂, NbB₂, NbB₂, CrB, CrB₂, Cr₂B, Cr₃B₄, Cr₄B, Cr₅B₃, MoB, MoB₂, Mo_{0.2}B₄, Mo_{0.2}B₅, MnB, MnB₂, MNB₄, Mn₂B, Mn₄B, Mn₃B₄, ReB₂, Re₃B, Re₇B₂, FeB, Fe₂B, RuB₂, Ru₂B₃, OsB, Os₂B₃, OsB₂, CoB, CO₂B, IrB, Ir₂B, NiB, Ni₂B, Ni₃B, CuB, or ZnB. In some embodiments, morethan 50%, 60%, 70%, 80%, 85%, 90%, 95%, 96%, 97%, 98%, or 99% of the W₁₋ₓMB₄ or WB₄ in the composite matrix is unreacted. In some embodiments, more than 30%, 40%, 50%, 60%, 70%, 80%, 85%, 90%, 95%, 96%, 97%, 98%, or 99% of Q in the composite matrix is unreacted.

In some embodiments, the components of the composite matrices described herein are evenly mixed during synthesis. In some embodiments, Q is not a coating on W₁₋ₓMoₓB₄ or WB₄. In some embodiments, component Q adheres particles of crystalline W₁₋ₓMoₓB₄ or WB₄ together. In some embodiments, component Q adheres particles of crystalline W₁₋ₓMoₓB₄ or WB₄ together and increases the Palmquist toughness of the overall composite matrix.

In some embodiments, Q is not tungsten carbide.

In some embodiments, disclosed herein are composite matrices comprising tungsten tetraboride, tungsten carbide, and T_{q}. For example, the (Q)ₙ of the composite matrices of (W₁₋ₓMoₓB₄)_{z}(T)_{q}(Q)ₙ (Formula IV) can be tungsten carbide as in (W₁₋ₓMoₓB₄)ₙ(T)_{q}(WC_{0.99-1.0.5})ₚ.

In some embodiments, a composite matrix described herein comprising:
a) a first formula (W₁₋ₓMoₓB₄)ₙ
   wherein:
      M is at least one of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al);
      x is from 0.001 to 0.999; and
      n is from 0.01 to 0.99;
b) a tungsten carbide of formula (WC_{0.99-1.05})ₚ, wherein p is from 0.01 to 0.99; and
c) a second formula T_{q};
   wherein:
      T is an alloy comprising at least one Group 4, 5, 6, 7, 8, 9, 10, 11, 12, 13, or 14 element in a Periodic Table of Elements; and
      q is from 0.01 to 0.99; and
   wherein the sum of p, q, and n is 1.

In some embodiments, the tungsten carbide of formula (WC_{0.99-1.05}), comprises WC_{0.99}, WC₁, WC_{1.01}, WC_{1.02}, WC_{1.03}, WC_{1.04} or WC_{1.05}. In some embodiments, a tungsten carbide described herein comprises a tungsten carbide of formula (WC_{0.99})ₚ, wherein p is from 0.01 to 0.99. In some embodiments, a tungsten carbide described herein comprises a tungsten carbide of formula (WC₁)ₚ, wherein p is from 0.01 to 0.99. In some embodiments, a tungsten carbide described herein comprises a tungsten carbide of formula (WC_{1.01})ₚ, wherein p is from 0.01 to 0.99. In some embodiments, a tungsten carbide described herein comprises a tungsten carbide of formula (WC_{1.02})ₚ, wherein p is from 0.01 to 0.99. In some embodiments, a tungsten carbide described herein comprises a tungsten carbide of formula (WC_{1.03})ₚ, wherein p is from 0.01 to 0.99. In some embodiments, a tungsten carbide described herein comprises a tungsten carbide of formula (WC_{1.04})ₚ, wherein p is from 0.01 to 0.99. In some embodiments, a tungsten carbide described herein comprises a tungsten carbide of formula (WC_{1.05})ₚ, wherein p is from 0.01 to 0.99.

In some embodiments, p is from 0.01 to 0.99. In some embodiments, p is from 0.05 to 0.99, 0.1 to 0.99, 0.15 to 0.99, 0.2 to 0.99, 0.25 to 0.99, 0.35 to 0.99, 0.4 to 0.99, 0.5 to 0.99, 0.6 to 0.99, 0.7 to 0.99, 0.8 to 0.99, 0.01 to 0.9, 0.05 to 0.9, 0.1 to 0.9, 0.15 to 0.9, 0.2 to 0.9, 0.25 to 0.9, 0.3 to 0.9, 0.35 to 0.9, 0.4 to 0.9, 0.5 to 0.9, 0.6 to 0.9, 0.7 to 0.9, 0.8 to 0.9, 0.01 to 0.8, 0.05 to 0.8, 0.1 to 0.8, 0.15 to 0.8, 0.2 to 0.8, 0.25 to 0.8, 0.3 to 0.8, 0.4 to 0.8, 0.5 to 0.8, 0.6 to 0.8, 0.7 to 0.8, 0.01 to 0.7, 0.05 to 0.7, 0.1 to 0.7, 0.2 to 0.7, 0.3 to 0.7, 0.4 to 0.7, 0.5 to 0.7, 0.01 to 0.6, 0.05 to 0.6, 0.1 to 0.6, 0.2 to 0.6, 0.3 to 0.6, 0.01 to 0.5, 0.05 to 0.5, 0.1 to 0.5, 0.2 to 0.5, 0.01 to 0.4, 0.05 to 0.4, 0.1 to 0.4, 0.2 to 0.4, 0.01 to 0.3, 0.05 to 0.3, 0.1 to 0.3, 0.2 to 0.3, 0.75 to 0.99, 0.75-0.9, 0.75 to 0.8, 0.8 to 0.99, or 0.8-0.9.

In some cases, p is about 0.01, 0.05, 0.1, 0.15, 0.2, 0.25, 0.3, ±0.35, 0.4, 0.45, 0.5, 0.55, 0.6, 0.65, 0.7, 0.75, 0.8, 0.85, 0.9, 0.95, or 0.99. In some cases, p is about 0.01. In some cases, p is about 0.05. In some cases, p is about 0.1. In some cases, p is about 0.15. In some cases, p is about 0.2. In some cases, p is about 0.25. In some cases, p is about 0.3. In some cases, p is about 0.35. In some cases, p is about 0.4. In some cases, p is about 0.5. In some cases, p is about 0.6. In some cases, p is about 0.7. In some cases, p is about 0.75. In some cases, p is about 0.8. In some cases, p is about 0.85. In some cases, p is about 0.9. In some cases, p is about 0.95. In some cases, p is about 0.99. In some cases, p is at least about 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, or 0.99; alternatively or in combination, p is no more than about 0.01, 0.05, 0.1, 0.15, 0.2, 0.25, 0.3, ±0.35, 0.4, 0.45, 0.5, 0.55, 0.6, 0.65, 0.7, 0.75, 0.8, 0.85, 0.9, 0.95, or 0.99.

### Metal Binders

Described herein are composite matrices of (W₁₋ₓMoₓB₄)_{z}(T)_{q} (Formula III) or (W₁₋ₓMoₓB₄)_{z}(T)_{q}(Q)ₙ (Formula IV). In some cases, T is an alloy comprising at least one Group 4, 5, 6, 7, 8, 9, 10, 11, 12, 13, or 14 element in the Periodic Table of Elements. Sometimes, T can be an alloy comprising at least one Group 8, 9, 10, 11, 12, 13 or 14 element in the Periodic Table of Elements. In some instances, T is an alloy comprising at least one Group 4 element in the Periodic Table of Elements. In some instances, T is an alloy comprising at least one Group 5 element in the Periodic Table of Elements. In some instances, T is an alloy comprising at least one Group 6 element in the Periodic Table of Elements. In some instances, T is an alloy comprising at least one Group 7 element in the Periodic Table of Elements. In some instances, T is an alloy comprising at least one Group 8 element in the Periodic Table of Elements. In some instances, T is an alloy comprising at least one Group 9 element in the Periodic Table of Elements. In some instances, T is an alloy comprising at least one Group 10 element in the Periodic Table of Elements. In some instances, T is an alloy comprising at least one Group 11 element in the Periodic Table of Elements. In some instances, T is an alloy comprising at least one Group 12 element in the Periodic Table of Elements. In some instances, T is an alloy comprising at least one Group 13 element in the Periodic Table of Elements. In some instances, T is an alloy comprising at least one Group 14 element in the Periodic Table of Elements.

In some instances, T is an alloy comprising at least one element selected from Cu, Ni, Co, Fe, Si, Al and Ti. In some cases, T is an alloy comprising at least one element selected from Cu, Co, Fe, Ni, Ti and Si. In some cases, T is an alloy comprising at least one element selected from Cu, Co, Fe and Ni. In some cases, T is an alloy comprising at least one element selected from Co, Fe and Ni. In some cases, T is an alloy comprising at least one element selected from Al, Ti and Si. In some cases, T is an alloy comprising at least one element selected from Ti and Si. In some embodiments, T is an alloy comprising Cu. In some embodiments, T is an alloy comprising Ni. In some embodiments, T is an alloy comprising Co. In some embodiments, T is an alloy comprising Fe. In some embodiments, T is an alloy comprising Si. In some embodiments, T is an alloy comprising Al. In some embodiments, T is an alloy comprising Ti.

In some instances, T is an alloy comprising two or more, three or more, four or more, five or more, or six or more Group 4, 5, 6, 7, 8, 9, 10, 11, 12, 13, or 14 elements in the Periodic Table of Elements. In some cases, T is an alloy comprising two or more, three or more, four or more, five or more, or six or more Group 8, 9, 10, 11, 12, 13, or 14 elements in the Periodic Table of Elements. Sometimes, the alloy T may comprise Cu, and optionally in combination with one or more of Co, Ni, Fe, Si, Ti, W, Sn, or Ta. In some cases, the alloy T comprises Co, Ni, Fe, Si, Ti, W, Sn, Ta, or any combinations thereof. In such alloy, the weight percentage of Cu may be about 40 wt. % to about 60 wt. %, or may be about 50 wt. %. The weight percentage of Co may be about 10 wt. % to about 20 wt. %, or may be about 20 wt. %. The weight percentage of Sn may be less than 7 wt. %, may be up to 7 wt. %, or may be about 5 wt. %. The weight percentage of Ni may be about 5 wt. % to about 15 wt. %, or may be about 10 wt. %. The weight percentage of W may be about 15 wt. %.

In some embodiments, q is from 0.001 to 0.999. In some cases, q is at least about 0.001, 0.005, 0.01, 0.05, 0.1, 0.15, 0.2, 0.25, 0.3, ±0.35, 0.4, 0.45, 0.5, 0.55, 0.6, 0.65, 0.7, 0.75, 0.8, 0.85, 0.9, 0.95, 0.99, or about 0.999. In some cases, q is no more than about 0.001, 0.005, 0.01, 0.05, 0.1, 0.15, 0.2, 0.25, 0.3, ±0.35, 0.4, 0.45, 0.5, 0.55, 0.6, 0.65, 0.7, 0.75, 0.8, 0.85, 0.9, 0.95, 0.99, or about 0.999. In some cases, q is about 0.001. In some cases, q is about 0.005. In some cases, q is about 0.01. In some cases, q is about 0.05. In some cases, q is about 0.1. In some cases, q is about 0.15. In some cases, q is about 0.2. In some cases, q is about 0.25. In some cases, q is about 0.3. In some cases, q is about 0.35. In some cases, q is about 0.4. In some cases, q is about 0.5. In some cases, q is about 0.6. In some cases, q is about 0.7. In some cases, q is about 0.75. In some cases, q is about 0.8. In some cases, q is about 0.85. In some cases, q is about 0.9. In some cases, q is about 0.95. In some cases, q is about 0.99. In some cases, q is about 0.999.

Described herein are composite matrices of (W₁₋ₓMoₓB₄)_{z}(Q)ₙ (Formula II), (W₁₋ₓMoₓB₄)_{z}(T)_{q} (Formula III), or (W₁₋ₓMoₓB₄)_{z}(T)_{q}(Q)ₙ (Formula IV). In some embodiments, z is about 0.001 to about 0.4. In some embodiments, z is about 0.001 to about 0.01, about 0.001 to about 0.05, about 0.001 to about 0.07, about 0.001 to about 0.1, about 0.001 to about 0.13, about 0.001 to about 0.15, about 0.001 to about 0.2, about 0.001 to about 0.25, about 0.001 to about 0.3, about 0.001 to about 0.35, about 0.001 to about 0.4, about 0.01 to about 0.05, about 0.01 to about 0.07, about 0.01 to about 0.1, about 0.01 to about 0.13, about 0.01 to about 0.15, about 0.01 to about 0.2, about 0.01 to about 0.25, about 0.01 to about 0.3, about 0.01 to about 0.35, about 0.01 to about 0.4, about 0.05 to about 0.07, about 0.05 to about 0.1, about 0.05 to about 0.13, about 0.05 to about 0.15, about 0.05 to about 0.2, about 0.05 to about 0.25, about 0.05 to about 0.3, about 0.05 to about 0.35, about 0.05 to about 0.4, about 0.07 to about 0.1, about 0.07 to about 0.13, about 0.07 to about 0.15, about 0.07 to about 0.2, about 0.07 to about 0.25, about 0.07 to about 0.3, about 0.07 to about 0.35, about 0.07 to about 0.4, about 0.1 to about 0.13, about 0.1 to about 0.15, about 0.1 to about 0.2, about 0.1 to about 0.25, about 0.1 to about 0.3, about 0.1 to about 0.35, about 0.1 to about 0.4, about 0.13 to about 0.15, about 0.13 to about 0.2, about 0.13 to about 0.25, about 0.13 to about 0.3, about 0.13 to about 0.35, about 0.13 to about 0.4, about 0.15 to about 0.2, about 0.15 to about 0.25, about 0.15 to about 0.3, about 0.15 to about 0.35, about 0.15 to about 0.4, about 0.2 to about 0.25, about 0.2 to about 0.3, about 0.2 to about 0.35, about 0.2 to about 0.4, about 0.25 to about 0.3, about 0.25 to about 0.35, about 0.25 to about 0.4, about 0.3 to about 0.35, about 0.3 to about 0.4, or about 0.35 to about 0.4. In some embodiments, z is about 0.001, about 0.01, about 0.05, about 0.07, about 0.1, about 0.13, about 0.15, about 0.2, about 0.25, about 0.3, about 0.35, or about 0.4. In some embodiments, z is at least about 0.001, about 0.01, about 0.05, about 0.07, about 0.1, about 0.13, about 0.15, about 0.2, about 0.25, about 0.3, or about 0.35. In some embodiments, z is at most about 0.01, about 0.05, about 0.07, about 0.1, about 0.13, about 0.15, about 0.2, about 0.25, about 0.3, about 0.35, or about 0.4. In some embodiments, z is about 0.6 to about 0.95. In some embodiments, z is about 0.6 to about 0.65, about 0.6 to about 0.7, about 0.6 to about 0.75, about 0.6 to about 0.77, about 0.6 to about 0.8, about 0.6 to about 0.82, about 0.6 to about 0.85, about 0.6 to about 0.88, about 0.6 to about 0.9, about 0.6 to about 0.92, about 0.6 to about 0.95, about 0.65 to about 0.7, about 0.65 to about 0.75, about 0.65 to about 0.77, about 0.65 to about 0.8, about 0.65 to about 0.82, about 0.65 to about 0.85, about 0.65 to about 0.88, about 0.65 to about 0.9, about 0.65 to about 0.92, about 0.65 to about 0.95, about 0.7 to about 0.75, about 0.7 to about 0.77, about 0.7 to about 0.8, about 0.7 to about 0.82, about 0.7 to about 0.85, about 0.7 to about 0.88, about 0.7 to about 0.9, about 0.7 to about 0.92, about 0.7 to about 0.95, about 0.75 to about 0.77, about 0.75 to about 0.8, about 0.75 to about 0.82, about 0.75 to about 0.85, about 0.75 to about 0.88, about 0.75 to about 0.9, about 0.75 to about 0.92, about 0.75 to about 0.95, about 0.77to about 0.8, about 0.77 to about 0.82, about 0.77to about 0.85, about 0.77 to about 0.88, about 0.77 to about 0.9, about 0.77 to about 0.92, about 0.77 to about 0.95, about 0.8 to about 0.82, about 0.8 to about 0.85, about 0.8 to about 0.88, about 0.8 to about 0.9, about 0.8 to about 0.92, about 0.8 to about 0.95, about 0.82 to about 0.85, about 0.82 to about 0.88, about 0.82to about 0.9, about 0.82 to about 0.92, about 0.82 to about 0.95, about 0.85 to about 0.88, about 0.85 to about 0.9, about 0.85 to about 0.92, about 0.85 to about 0.95, about 0.88to about 0.9, about 0.88 to about 0.92, about 0.88to about 0.95, about 0.9 to about 0.92, about 0.9 to about 0.95, or about 0.92 to about 0.95. In some embodiments, z is about 0.6, about 0.65, about 0.7, about 0.75, about 0.77, about 0.8, about 0.82, about 0.85, about 0.88, about 0.9, about 0.92, or about 0.95. In some embodiments, z is at least about 0.6, about 0.65, about 0.7, about 0.75, about 0.77, about 0.8, about 0.82, about 0.85, about 0.88, about 0.9, or about 0.92. In some embodiments, z is at most about 0.65, about 0.7, about 0.75, about 0.77, about 0.8, about 0.82, about 0.85, about 0.88, about 0.9, about 0.92, or about 0.95. In some embodiments, z is about 0.001 to about 0.999. In some embodiments, z is about 0.001 to about 0.1, about 0.001 to about 0.2, about 0.001 to about 0.3, about 0.001 to about 0.4, about 0.001 to about 0.5, about 0.001 to about 0.6, about 0.001 to about 0.7, about 0.001 to about 0.8, about 0.001 to about 0.9, about 0.001 to about 0.95, about 0.001 to about 0.999, about 0.1 to about 0.2, about 0.1 to about 0.3, about 0.1 to about 0.4, about 0.1 to about 0.5, about 0.1 to about 0.6, about 0.1 to about 0.7, about 0.1 to about 0.8, about 0.1 to about 0.9, about 0.1 to about 0.95, about 0.1 to about 0.999, about 0.2 to about 0.3, about 0.2 to about 0.4, about 0.2 to about 0.5, about 0.2 to about 0.6, about 0.2 to about 0.7, about 0.2 to about 0.8, about 0.2 to about 0.9, about 0.2 to about 0.95, about 0.2 to about 0.999, about 0.3 to about 0.4, about 0.3 to about 0.5, about 0.3 to about 0.6, about 0.3 to about 0.7, about 0.3 to about 0.8, about 0.3 to about 0.9, about 0.3 to about 0.95, about 0.3 to about 0.999, about 0.4 to about 0.5, about 0.4 to about 0.6, about 0.4 to about 0.7, about 0.4 to about 0.8, about 0.4 to about 0.9, about 0.4 to about 0.95, about 0.4 to about 0.999, about 0.5 to about 0.6, about 0.5 to about 0.7, about 0.5 to about 0.8, about 0.5 to about 0.9, about 0.5 to about 0.95, about 0.5 to about 0.999, about 0.6 to about 0.7, about 0.6 to about 0.8, about 0.6 to about 0.9, about 0.6 to about 0.95, about 0.6 to about 0.999, about 0.7 to about 0.8, about 0.7 to about 0.9, about 0.7 to about 0.95, about 0.7 to about 0.999, about 0.8 to about 0.9, about 0.8 to about 0.95, about 0.8 to about 0.999, about 0.9 to about 0.95, about 0.9 to about 0.999, or about 0.95 to about 0.999. In some embodiments, z is about 0.001, about 0.1, about 0.2, about 0.3, about 0.4, about 0.5, about 0.6, about 0.7, about 0.8, about 0.9, about 0.95, or about 0.999. In some embodiments, z is at least about 0.001, about 0.1, about 0.2, about 0.3, about 0.4, about 0.5, about 0.6, about 0.7, about 0.8, about 0.9, or about 0.95. In some embodiments, z is at most about 0.1, about 0.2, about 0.3, about 0.4, about 0.5, about 0.6, about 0.7, about 0.8, about 0.9, about 0.95, or about 0.999. In some embodiments, a composite material described herein comprising: (a) a tungsten tetraboride of formula (WB₄)_{z}, wherein z is from 0.001 to 0.999; and (b) a second formula Cu_{q}; wherein q is from 0.001 to 0.999; and wherein the sum of q and n is 1. In some embodiments, a composite material described herein comprising: (a) a tungsten tetraboride of formula (WB₄)_{z}, wherein z is from 0.001 to 0.099; and (b) a second formula Ni_{q}; wherein q is from 0.001 to 0.999; and wherein the sum of q and n is 1. In some embodiments, a composite material described herein comprising: (a) a tungsten tetraboride of formula (WB₄)ₙ, wherein n is from 0.001 to 0.999; and (b) a second formula Co_{q}; wherein q is from 0.001 to 0.999; and wherein the sum of q and n is 1. In some embodiments, a composite material described herein comprising: (a) a tungsten tetraboride of formula (WB₄)_{z}, wherein z is from 0.001 to 0.999; and (b) a second formula Fe_{q}; wherein q is from 0.001 to 0.999; and wherein the sum of q and n is 1. In some embodiments, a composite material described herein comprising: (a) a tungsten tetraboride of formula (WB₄)_{z}, wherein z is from 0.001 to 0.999; and (b) a second formula Si_{q}; wherein q is from 0.001 to 0.999; and wherein the sum of q and n is 1. In some embodiments, a composite material described herein comprising: (a) a tungsten tetraboride of formula (WB₄)_{z}, wherein z is from 0.001 to 0.999; and (b) a second formula Al_{q}; wherein q is from 0.001 to 0.999; and wherein the sum of q and n is 1. In some embodiments, a composite material described herein comprising: (a) a tungsten tetraboride of formula (WB₄)_{z}, wherein z is from 0.001 to 0.999; and (b) a second formula Ti_{q}; wherein q is from 0.001 to 0.999; and wherein the sum of q and n is 1. In some embodiments, z has a value within the range of 0.001 to 0.999 (0.1% to 99.9% by volume), n has a value within the range of about 0.001 to 0.999*0.1% to 99.9% by volume), and the sum of z and n are 1 (100% by volume).

### Properties of Composite Matrices of Formula II, Formula III, and Formula IV

In some embodiments, composite matrices of Formula II, III, or IV described herein have a Vickers hardness (measured at 1 kg or 9.8 N) of about 15 GPa to about 35 GPa. In some embodiments, a composite matrix described herein has a Vickers hardness of about 15 GPa, about 19 GPa, about 20 GPa, about 21 GPa, about 22 GPa, about 23 GPa, about 25 GPa, about 27 GPa, about 29 GPa, about 31 GPa, about 33 GPa, or about 35 GPa. In some embodiments, a composite matrix described herein has a Vickers hardness of at least about 15 GPa, about 19 GPa, about 20 GPa, about 21 GPa, about 22 GPa, about 23 GPa, about 25 GPa, about 27 GPa, about 29 GPa, about 31 GPa, or about 33 GPa. In some embodiments, a composite matrix described herein has a Vickers hardness of at most about 19 GPa, about 20 GPa, about 21 GPa, about 22 GPa, about 23 GPa, about 25 GPa, about 27 GPa, about 29 GPa, about 31 GPa, about 33 GPa, or about 35 GPa.

In some embodiments, a composite matrix of Formula II, III, or IV described herein has a Palmquist toughness of about 1 MPa m^{1/2} to about 12 MPa m^{1/2}. In some embodiments, a composite matrix described herein has a Palmquist toughness of about 1 MPa m^{1/2}, about 2 MPa m^{1/2}, about 3 MPa m^{1/2}, about 4 MPa m^{1/2}, about 5 MPa m^{1/2}, about 6 MPa m^{1/2}, about 7 MPa m^{1/2}, about 8 MPa m^{1/2}, about 9 MPa m^{1/2}, about 10 MPa m^{1/2}, about 11 MPa m^{1/2}, or about 12 MPa m^{1/2}. In some embodiments, a composite matrix described herein has a Palmquist toughness of at least about 1 MPa m^{1/2}, about 2 MPa m^{1/2}, about 3 MPa m^{1/2}, about 4 MPa m^{1/2}, about 5 MPa m^{1/2}, about 6 MPa m^{1/2}, about 7 MPa m^{1/2}, about 8 MPa m^{1/2}, about 9 MPa m^{1/2}, about 10 MPa m^{1/2}, or about 11 MPa m^{1/2}. In some embodiments, a composite matrix described herein has a Palmquist toughness of at most about 2 MPa m^{1/2}, about 3 MPa m^{1/2}, about 4 MPa m^{1/2}, about 5 MPa m^{1/2}, about 6 MPa m^{1/2}, about 7 MPa m^{1/2}, about 8 MPa m^{1/2}, about 9 MPa m¹¹², about 10 MPa m^{1/2}, about 11 MPa m^{1/2}, or about 12 MPa m^{1/2}.

In some embodiments, a composite matrix of Formula II, III, or IV described herein has a density of about 1 g/cm³ to about 10 g/cm³. In some embodiments, a composite matrix described herein has a density of about 1 g/cm³ to about 3 g/cm³, about 1 g/cm³ to about 5 g/cm³, about 1 g/cm³ to about 5.5 g/cm³, about 1 g/cm³ to about 6 g/cm³, about 1 g/cm³ to about 6.5 g/cm³, about 1 g/cm³ to about 7 g/cm³, about 1 g/cm³ to about 7.5 g/cm³, about 1 g/cm³ to about 8 g/cm³, about 1 g/cm³ to about 8.5 g/cm³, about 1 g/cm³ to about 9 g/cm³, about 1 g/cm³ to about 10 g/cm³, about 3 g/cm³ to about 5 g/cm³, about 3 g/cm³ to about 5.5 g/cm³, about 3 g/cm³ to about 6 g/cm³, about 3 g/cm³ to about 6.5 g/cm³, about 3 g/cm³ to about 7 g/cm³, about 3 g/cm³ to about 7.5 g/cm³, about 3 g/cm³ to about 8 g/cm³, about 3 g/cm³ to about 8.5 g/cm³, about 3 g/cm³ to about 9 g/cm³, about 3 g/cm³ to about 10 g/cm³, about 5 g/cm³ to about 5.5 g/cm³, about 5 g/cm³ to about 6 g/cm³, about 5 g/cm³ to about 6.5 g/cm³, about 5 g/cm³ to about 7 g/cm³, about 5 g/cm³ to about 7.5 g/cm³, about 5 g/cm³ to about 8 g/cm³, about 5 g/cm³ to about 8.5 g/cm³, about 5 g/cm³ to about 9 g/cm³, about 5 g/cm³ to about 10 g/cm³, about 5.5 g/cm³ to about 6 g/cm³, about 5.5 g/cm³ to about 6.5 g/cm³, about 5.5 g/cm³ to about 7 g/cm³, about 5.5 g/cm³ to about 7.5 g/cm³, about 5.5 g/cm³ to about 8 g/cm³, about 5.5 g/cm³ to about 8.5 g/cm³, about 5.5 g/cm³ to about 9 g/cm³, about 5.5 g/cm³ to about 10 g/cm³, about 6 g/cm³ to about 6.5 g/cm³, about 6 g/cm³ to about 7 g/cm³, about 6 g/cm³ to about 7.5 g/cm³, about 6 g/cm³ to about 8 g/cm³, about 6 g/cm³ to about 8.5 g/cm³, about 6 g/cm³ to about 9 g/cm³, about 6 g/cm³ to about 10 g/cm³, about 6.5 g/cm³ to about 7 g/cm³, about 6.5 g/cm³ to about 7.5 g/cm³, about 6.5 g/cm³ to about 8 g/cm³, about 6.5 g/cm³ to about 8.5 g/cm³, about 6.5 g/cm³ to about 9 g/cm³, about 6.5 g/cm³ to about 10 g/cm³, about 7 g/cm³ to about 7.5 g/cm³, about 7 g/cm³ to about 8 g/cm³, about 7 g/cm³ to about 8.5 g/cm³, about 7 g/cm³ to about 9 g/cm³, about 7 g/cm³ to about 10 g/cm³, about 7.5 g/cm³ to about 8 g/cm³, about 7.5 g/cm³ to about 8.5 g/cm³, about 7.5 g/cm³ to about 9 g/cm³, about 7.5 g/cm³ to about 10 g/cm³, about 8 g/cm³ to about 8.5 g/cm³, about 8 g/cm³ to about 9 g/cm³, about 8 g/cm³ to about 10 g/cm³, about 8.5 g/cm³ to about 9 g/cm³, about 8.5 g/cm³ to about 10 g/cm³, or about 9 g/cm³ to about 10 g/cm³. In some embodiments, a composite matrix described herein has a density of about 1 g/cm³, about 3 g/cm³, about 5 g/cm³, about 5.5 g/cm³, about 6 g/cm³, about 6.5 g/cm³, about 7 g/cm³, about 7.5 g/cm³, about 8 g/cm³, about 8.5 g/cm³, about 9 g/cm³, or about 10 g/cm³. In some embodiments, a composite matrix described herein has a density of at least about 1 g/cm³, about 3 g/cm³, about 5 g/cm³, about 5.5 g/cm³, about 6 g/cm³, about 6.5 g/cm³, about 7 g/cm³, about 7.5 g/cm³, about 8 g/cm³, about 8.5 g/cm³, or about 9 g/cm³. In some embodiments, a composite matrix described herein has a density of at most about 3 g/cm³, about 5 g/cm³, about 5.5 g/cm³, about 6 g/cm³, about 6.5 g/cm³, about 7 g/cm³, about 7.5 g/cm³, about 8 g/cm³, about 8.5 g/cm³, about 9 g/cm³, or about 10 g/cm³.

In some embodiments, the composite matrix of Formula II, III, or IV described herein, or prepared by the methods herein, is resistant to oxidation. In some embodiments, the composite matrix is resistant to oxidation below 400° C. In some embodiments, the composite matrix is resistant to oxidation below 410° C. In some embodiments, the composite matrix is resistant to oxidation below 420° C. In some embodiments, the composite matrix is resistant to oxidation below 440° C. In some embodiments, the composite matrix is resistant to oxidation below 450° C. In some embodiments, the composite matrix is resistant to oxidation below 460° C. In some embodiments, the composite matrix is resistant to oxidation below 465° C. In some embodiments, the composite matrix is resistant to oxidation below 475° C. In some embodiments, the composite matrix is resistant to oxidation below 490° C. In some embodiments, the composite matrix is resistant to oxidation below 500° C. In some embodiments, the composite matrix is resistant to oxidation below 550° C. In some embodiments, the composite matrix is resistant to oxidation below 600° C. In some embodiments, the composite matrix is resistant to oxidation below 650° C. In some embodiments, the composite matrix is resistant to oxidation below 700° C. In some embodiments, the composite matrix is resistant to oxidation below 800° C. In some embodiments, the composite matrix is resistant to oxidation below 900° C.

In some embodiments, a composite material of Formula II, III, or IV described herein is resistant to oxidation. In some embodiments, a composite material described herein has anti-oxidation property. For example, when the composite material is coated on the surface of a substrate (e.g., a radiation shielding device such as a metal tile), the composite material reduces the rate of oxidation of the substrate in comparison to a substrate not coated with the composite material. In an alternative example, when the composite material is coated on the surface of a substrate, the composite material prevents oxidation of the substrate in comparison to a substrate not coated with the composite material. In some embodiments, the composite material inhibits the formation of oxidation or reduces the rate of oxidation. In some embodiments, a coating of the composite matrix reduced the rate of oxidation of the substrate as compared to the uncoated substrate. In some embodiments, the composite matrix reduces the rate of oxidation by at least 10%, at least 2%, at least 30%, least 4%, at least 5%, at least 6%, at least 7%, at least 8%, at least 9%, at least 10%, at least 15%, at least 20%, at least 25%, at least 30%, at least 35 at least 40%, at least 45%, at least 50%, at least 55%, at least 60%, at least 65%, at least 70%, at least 75%, at least 80%, or at least 90%.

### Methods of Manufacturing Composite Matrices

Described herein is a method of preparing a composite matrix of the formula (W₁₋ₓMoₓB₄)_{z}(Q)ₙ, the method comprising:
a) blending together crystalline W₁₋ₓMoₓB₄ with solid Q to form a mixture;
   wherein:
M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al);
x is from 0.001 to 0.999;
Q is one or more ceramics, wherein each of the one or more ceramics comprises at least two elements, and at least one of the two elements is B (boron), C (carbon), Si (silicon), N (nitrogen), or O (oxygen);
   z is a volume percent from 0.001 to 0.999 (0.1% to 99.9%);
   n is a volume percent from 0.001 to 0.999 (0.1% to 99.9%); and
   the sum of n and z is 1 (100%);
b) pressing the mixture to generate a pellet; and
c) heating the pellet to produce the composite matrix (W₁₋ₓMoₓB₄)_{z}(Q)ₙ.

Described herein is a method of preparing a composite matrix of the formula (W₁₋ₓMoₓB₄)_{z}(Q)ₙ, the method comprising:
a) blending together crystalline W₁₋ₓMoₓB₄ with solid Q to form a mixture;
   wherein:
M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al);
x is from 0.001 to 0.999;
Q is one or more ceramics, wherein each of the one or more ceramics comprises at least two elements, and at least one of the two elements is B (boron), C (carbon), Si (silicon), N (nitrogen), or O (oxygen);
   z is a volume percent from 0.001 to 0.999 (0.1% to 99.9%);
   n is a volume percent from 0.001 to 0.999 (0.1% to 99.9%); and
   the sum of n and z is 1 (100%);
b) pressing the mixture to between 25 MPa to 200 MPa to generate a pellet; and
c) heating the pellet to produce the composite matrix (W₁₋ₓMoₓB₄)_{z}(Q)ₙ,
   wherein heating the pellet comprises ramping the temperature from about 23° C. to a temperature less than 2000° C. over the course ofless than 30 mins.

Described herein is a method of preparing a composite matrix of the formula (W₁₋ₓMoₓB₄)_{z}(Q)ₙ, the method comprising:
a) blending together crystalline W₁₋ₓMoₓB₄ with solid Q to form a mixture;
   wherein:
M is one or more of titanium (Ti), vanadium (V), chromium (Cr), manganese (Mn), zirconium (Zr), niobium (Nb), molybdenum (Mo), hafnium (Hf), tantalum (Ta), and rhenium (Re);
x is from 0.001 to 0.3;
Q is one or more ceramics, wherein each of the one or more ceramics comprises at least two elements, and at least one of the two elements is B (boron), C (carbon), Si (silicon), N (nitrogen), or O (oxygen);
   z is a volume percent from 70% to 99.9%;
   n is a volume percent from 0.1% to 30%; and
   the sum of n and z is 1 (100%);
b) pressing the mixture to between 25 MPa to 200 MPa to generate a pellet; and
c) heating the pellet to produce the composite matrix (W₁₋ₓMoₓB₄)_{z}(Q)ₙ,
   wherein heating the pellet comprises ramping the temperature from about 23° C. to a temperature less than 2000° C. over the course ofless than 30 mins.

Described herein is a method a composite matrix of the formula (WB₄)_{z}(Q)ₙ, the method comprising:
a) blending together crystalline WB₄ with solid Q to form a mixture;
   wherein:
Q is one or more ceramics, wherein each of the one or more ceramics comprises at least two elements, and at least one of the two elements is B (boron), C (carbon), Si (silicon), N (nitrogen), or O (oxygen);
   z is a volume percent from 0.001 to 0.999 (0.1% to 99.9%);
   n is a volume percent from 0.001 to 0.999 (0.1% to 99.9%); and
   the sum of n and z is 1 (100%);
c) pressing the mixture to generate a pellet; and
c) heating the pellet in a vessel to produce the composite matrix (WB₄)_{z}(Q)ₙ.

Described herein is a method a composite matrix of the formula (WB₄)_{z}(Q)ₙ, the method comprising:
a) blending together crystalline WB₄ with solid Q to form a mixture;
   wherein:
Q is one or more ceramics, wherein each of the one or more ceramics comprises at least two elements, and at least one of the two elements is B (boron), C (carbon), Si (silicon), N (nitrogen), or O (oxygen);
   z is a volume percent from 0.001 to 0.70 (0.1% to 70%);
   n is a volume percent from 0.30 to 0.999 (30% to 99.9%); and
   the sum of n and z is 1 (100%);
b) pressing the mixture to between 25 MPa to 200 MPa to generate a pellet; and
c) heating the pellet to produce the composite matrix (W₁₋ₓMoₓB₄)_{z}(Q)ₙ,
   wherein heating the pellet comprises ramping the temperature from about 23° C. to a temperature less than 2000° C. over the course ofless than 30 mins.

In some embodiments, described herein comprises a method of preparing a densified composite material, which comprises (a) blending together a first composition having a formula (W₁₋ₓMoₓB₄)ₙ and a second composition of formula T_{q} for a time sufficient to produce a powder mixture; wherein: M is at least one of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al); T is an alloy comprising at least one Group 4, 5, 6, 7, 8, 9, 10, 11, 12, 13, or 14 element in the Periodic Table of Elements; x is from 0.001 to 0.999; q and n are each independently from 0.001 to 0.999; and the sum of q and n is 1; (b) pressing the powder mixture under a pressure sufficient to generate a pellet; and (c) sintering the pellet at a temperature sufficient to produce a densified composite material.

In some embodiments, described herein comprises a method of preparing a densified composite material, which comprises (a) blending together a first composition having a formula (WB₄)ₙ and a second composition of formula T_{q} for a time sufficient to produce a powder mixture; wherein: T is an alloy comprising at least one Group 4, 5, 6, 7, 8, 9, 10, 11, 12, 13, or 14 element in the Periodic Table of Elements; q and n are each independently from 0.001 to 0.999; and the sum of q and n is 1; (b) pressing the powder mixture under a pressure sufficient to generate a pellet; and (c) sintering the pellet at a temperature sufficient to produce a densified composite material.

In some embodiments, the mixture is heated, melted or sintered in an electrical arc furnace, an induction furnace, or a hot press optionally equipped with a spark plasma sinter. In some embodiments, the mixture is heated, melted or sintered in an electrical arc furnace, an induction furnace, a hot press, or spark plasma sinter.

In some embodiments, the reaction is a solid state reaction. In some embodiments, the reaction requires the partial melting of at least one component in the mixture. In some embodiments, the reaction requires the complete melting of at least one component in the mixture.

In some embodiments, the methods described herein, e.g., for generating a composite matrix require sintering, heating, or melting a mixture of elements under an inert atmosphere or vacuum. In some embodiments, the inert or vacuum atmosphere is introduced after transferring the mixture into the reaction vessel and prior to any heating. In some embodiments, a vacuum is applied to the reaction vessel. In some embodiments, the vacuum is applied for at least 10 minutes, 20 minutes, 30 minutes, or more. In some embodiments, oxygen is removed from the reaction vessel. In some embodiments, vacuum is applied for a time sufficient to remove at least 99% of oxygen from the reaction vessel.

In some embodiments the inert atmosphere is an inert gas such as helium, argon or dinitrogen. In some embodiments, the reaction vessel is purged with an inert gas to generate the inert atmosphere. In some embodiments, the reaction vessel is subjected to at least one cycle of applying a vacuum and flushing the reaction vessel with an inert gas to remove oxygen from the reaction vessel. In some cases, the reaction vessel is subjected to 2, 3, 4, 5, 6, or more cycles of applying a vacuum and flushing the reaction vessel with an inert gas to remove oxygen from the reaction vessel. In some cases, this process is repeated until desired oxygen levels persist.

In some embodiments, a mixing time is about 5 minutes to about 6 hours. In some embodiments, the mixing time is about 5 minutes, about 10 minutes, about 15 minutes, about 20 minutes, about 30 minutes, about 45 minutes, about 1 hour, about 1.5 hour, about 2 hours, about 3 hours, about 4 hours, about 5 hours, or about 6 hours. In some embodiments, the mixing time is at least 5 minutes or more. In some embodiments, the mixing time is about 10 minutes or more. In some embodiments, the mixing time is about 20 minutes or more. In some embodiments, the mixing time is about 30 minutes or more. In some embodiments, the mixing time is about 45 minutes or more. In some embodiments, the mixing time is about 1 hour or more. In some embodiments, the mixing time is about 2 hours or more. In some embodiments, the mixing time is about 3 hours or more. In some embodiments, the mixing time is about 4 hours or more. In some embodiments, the mixing time is about 5 hours or more. In some embodiments, the mixing time is about 6 hours or more. In some embodiments, the mixing time is about 8 hours or more. In some embodiments, the mixing time is about 10 hours or more. In some embodiments, the mixing time is about 12 hours or more. In some embodiments, a mixing time is about 5 minutes to about 420 minutes. In some embodiments, a mixing time is about 5 minutes to about 10 minutes, about 5 minutes to about 15 minutes, about 5 minutes to about 20 minutes, about 5 minutes to about 30 minutes, about 5 minutes to about 60 minutes, about 5 minutes to about 120 minutes, about 5 minutes to about 180 minutes, about 5 minutes to about 240 minutes, about 5 minutes to about 300 minutes, about 5 minutes to about 360 minutes, about 5 minutes to about 420 minutes, about 10 minutes to about 15 minutes, about 10 minutes to about 20 minutes, about 10 minutes to about 30 minutes, about 10 minutes to about 60 minutes, about 10 minutesto about 120 minutes, about 10 minutes to about 180 minutes, about 10 minutes to about 240 minutes, about 10 minutes to about 300 minutes, about 10 minutes to about 360 minutes, about 10 minutes to about 420 minutes, about 15 minutes to about 20 minutes, about 15 minutes to about 30 minutes, about 15 minutes to about 60 minutes, about 15 minutes to about 120 minutes, about 15 minutes to about 180 minutes, about 15 minutes to about 240 minutes, about 15 minutes to about 300 minutes, about 15 minutes to about 360 minutes, about 15 minutes to about 420 minutes, about 20 minutes to about 30 minutes, about 20 minutes to about 60 minutes, about 20 minutes to about 120 minutes, about 20 minutes to about 180 minutes, about 20 minutes to about 240 minutes, about 20 minutes to about 300 minutes, about 20 minutes to about 360 minutes, about 20 minutes to about 420 minutes, about 30 minutes to about 60 minutes, about 30 minutes to about 120 minutes, about 30 minutes to about 180 minutes, about 30 minutes to about 240 minutes, about 30 minutesto about 300 minutes, about 30 minutes to about 360 minutes, about 30 minutes to about 420 minutes, about 60 minutes to about 120 minutes, about 60 minutes to about 180 minutes, about 60 minutes to about 240 minutes, about 60 minutes to about 300 minutes, about 60 minutes to about 360 minutes, about 60 minutes to about 420 minutes, about 120 minutes to about 180 minutes, about 120 minutes to about 240 minutes, about 120 minutes to about 300 minutes, about 120 minutes to about 360 minutes, about 120 minutes to about 420 minutes, about 180 minutes to about 240 minutes, about 180 minutes to about 300 minutes, about 180 minutes to about 360 minutes, about 180 minutes to about 420 minutes, about 240 minutes to about 300 minutes, about 240 minutes to about 360 minutes, about 240 minutes to about 420 minutes, about 300 minutes to about 360 minutes, about 300 minutes to about 420 minutes, or about 360 minutes to about 420 minutes. In some embodiments, a mixing time is about 5 minutes, about 10 minutes, about 15 minutes, about 20 minutes, about 30 minutes, about 60 minutes, about 120 minutes, about 180 minutes, about 240 minutes, about 300 minutes, about 360 minutes, or about 420 minutes. In some embodiments, a mixing time is at least about 5 minutes, about 10 minutes, about 15 minutes, about 20 minutes, about 30 minutes, about 60 minutes, about 120 minutes, about 180 minutes, about 240 minutes, about 300 minutes, or about 360 minutes. In some embodiments, a mixing time is atmost about 10 minutes, about 15 minutes, about 20 minutes, about 30 minutes, about 60 minutes, about 120 minutes, about 180 minutes, about 240 minutes, about 300 minutes, about 360 minutes, or about 420 minutes.

In some embodiments, the composite matrices described herein are heated to a maximum temperature. In some embodiments, the composite matrices described herein are heated to a maximum temperature and are subjected to a maximum pressure. In some embodiments, the heating is performed at a target ramp rate. In some embodiments, the composite matrices are heated, under pressure, from room temperature to a maximum temperature, and held at the maximum temperature for a period of time.

In some embodiments, the composite matrices are compressed using a maximum pressure of 300 MPa, 275 MPa, 250 MPa, 225 MPa, 200 MPa, 175 MPa, 160 MPa, 150 MPa, 140 MPa, 130 MPa, 120 MPa, 110 MPa, 100 MPa, 90 MPa, 80 MPa, 70 MPa, 60 MPa, 50 MPa, 40 MPa, 30 MPa, or 20 MPa. In some embodiments, the composite matrices are compressed using a maximum pressure of about 25 MPa to about 300 MPa. In some embodiments, the composite matrices are compressed using a maximum pressure of about 25 MPa to about 50 MPa, about 25 MPa to about 75 MPa, about 25 MPa to about 100 MPa, about 25 MPa to about 125 MPa, about 25 MPa to about 150 MPa, about 25 MPa to about 175 MPa, about 25 MPa to about 200 MPa, about 25 MPa to about 225 MPa, about 25 MPa to about 250 MPa, about 25 MPa to about 275 MPa, about 25 MPa to about 300 MPa, about 50 MPa to about 75 MPa, about 50 MPa to about 100 MPa, about 50 MPa to about 125 MPa, about 50 MPa to about 150 MPa, about 50 MPa to about 175 MPa, about 50 MPa to about 200 MPa, about 50 MPa to about 225 MPa, about 50 MPa to about 250 MPa, about 50 MPa to about 275 MPa, about 50 MPa to about 300 MPa, about 75 MPa to about 100 MPa, about 75 MPa to about 125 MPa, about 75 MPa to about 150 MPa, about 75 MPa to about 175 MPa, about 75 MPa to about 200 MPa, about 75 MPa to about 225 MPa, about 75 MPa to about 250 MPa, about 75 MPa to about 275 MPa, about 75 MPa to about 300 MPa, about 100 MPa to about 125 MPa, about 100 MPa to about 150 MPa, about 100 MPa to about 175 MPa, about 100 MPa to about 200 MPa, about 100 MPa to about 225 MPa, about 100 MPa to about 250 MPa, about 100 MPa to about 275 MPa, about 100 MPa to about 300 MPa, about 125 MPa to about 150 MPa, about 125 MPa to about 175 MPa, about 125 MPa to about 200 MPa, about 125 MPa to about 225 MPa, about 125 MPa to about 250 MPa, about 125 MPa to about 275 MPa, about 125 MPa to about 300 MPa, about 150 MPa to about 175 MPa, about 150 MPa to about 200 MPa, about 150 MPa to about 225 MPa, about 150 MPa to about 250 MPa, about 150 MPa to about 275 MPa, about 150 MPa to about 300 MPa, about 175 MPa to about 200 MPa, about 175 MPa to about 225 MPa, about 175 MPa to about 250 MPa, about 175 MPa to about 275 MPa, about 175 MPa to about 300 MPa, about 200 MPa to about 225 MPa, about 200 MPa to about 250 MPa, about 200 MPa to about 275 MPa, about 200 MPa to about 300 MPa, about 225 MPa to about 250 MPa, about 225 MPa to about 275 MPa, about 225 MPa to about 300 MPa, about 250 MPa to about 275 MPa, about 250 MPa to about 300 MPa, or about 275 MPa to about 300 MPa. In some embodiments, the composite matrices are compressed using a maximum pressure of about 25 MPa, about 50 MPa, about 75 MPa, about 100 MPa, about 125 MPa, about 150 MPa, about 175 MPa, about 200 MPa, about 225 MPa, about 250 MPa, about 275 MPa, or about 300 MPa. In some embodiments, the composite matrices are compressed using a maximum pressure of at least about 25 MPa, about 50 MPa, about 75 MPa, about 100 MPa, about 125 MPa, about 150 MPa, about 175 MPa, about 200 MPa, about 225 MPa, about 250 MPa, or about 275 MPa. In some embodiments, the composite matrices are compressed using a maximum pressure of at most about 50 MPa, about 75 MPa, about 100 MPa, about 125 MPa, about 150 MPa, about 175 MPa, about 200 MPa, about 225 MPa, about 250 MPa, about 275 MPa, or about 300 MPa.

In some embodiments, the composite matrices are heated from room temperature (23° C.) to a maximum temperature of about 4000° C., 3950° C., 3900° C., 3850° C., 3800° C., 3750° C., 3700° C., 3650° C., 3600° C., 3550° C., 3500° C., 3450° C., 3400° C., 3350° C., 3300° C., 3250° C., 3200° C., 3150° C., 3100° C., 3050° C., 3000° C., 2950° C., 2900° C., 2850° C., 2800° C., 2750° C., 2700° C., 2650° C., 2600° C., 2550° C., 2500° C., 2450° C., 2400° C., 2350° C., 2300° C., 2250° C., 2200° C., 2150° C., 2100° C., 2050° C., 2000° C., 1950° C., 1900° C., 1850° C., 1800° C., 1750° C., 1700° C., 1650° C., 1600° C., 1550° C., 1500° C., 1450° C., 1400° C., 1350° C., 1300° C., 1250° C., 1200° C., 1150° C., 1100° C., 1050° C., 1000° C. 950° C., 900° C., or 850° C. In some embodiments, the maximum temperature is between about 800° C. to about 2,000° C. In some embodiments, the maximum temperatureis between about 800° C., about 900° C., about 1,000° C., about 1,050° C., about 1,100° C., about 1,150° C., about 1,200° C., about 1,300° C., about 1,400° C., about 1,500° C., about 1,800° C., or about 2,000° C. In some embodiments, the maximum temperature is between at least about 800° C., about 900° C., about 1,000° C., about 1,050° C., about 1,100° C., about 1,150° C., about 1,200° C., about 1,300° C., about 1,400° C., about 1,500° C., or about 1,800° C. In some embodiments, the maximum temperature is between at most about 900° C., about 1,000° C., about 1,050° C., about 1,100° C., about 1,150° C., about 1,200° C., about 1,300° C., about 1,400° C., about 1,500° C., about 1,800° C., or about 2,000° C. In some embodiments, the composite matrices are heated to a maximum temperature of about 800° C. to about 4,000° C. In some embodiments, the composite matrices are heated to a maximum temperature of about 800° C. to about 1,000° C., about 800° C. to about 1,500° C., about 800° C. to about 1,700° C., about 800° C. to about 1,900° C., about 800° C. to about 2,000° C., about 800° C. to about 2,100° C., about 800° C. to about 2,300° C., about 800° C. to about 2,500° C., about 800° C. to about 3,000° C., about 800° C. to about 3,500° C., about 800° C. to about 4,000° C., about 1,000° C. to about 1,500° C., about 1,000° C. to about 1,700° C., about 1,000° C. to about 1,900° C., about 1,000° C. to about 2,000° C., about 1,000° C. to about 2,100° C., about 1,000° C. to about 2,300° C., about 1,000° C. to about 2,500° C., about 1,000° C. to about 3,000° C., about 1,000° C. to about 3,500° C., about 1,000° C. to about 4,000° C., about 1,500° C. to about 1,700° C., about 1,500° C. to about 1,900° C., about 1,500° C. to about 2,000° C., about 1,500° C. to about 2,100° C., about 1,500° C. to about 2,300° C., about 1,500° C. to about 2,500° C., about 1,500° C. to about 3,000° C., about 1,500° C. to about 3,500° C., about 1,500° C. to about 4,000° C., about 1,700° C. to about 1,900° C., about 1,700° C. to about 2,000° C., about 1,700° C. to about 2,100° C., about 1,700° C. to about 2,300° C., about 1,700° C. to about 2,500° C., about 1,700° C. to about 3,000° C., about 1,700° C. to about 3,500° C., about 1,700° C. to about 4,000° C., about 1,900° C. to about 2,000° C., about 1,900° C. to about 2,100° C., about 1,900° C. to about 2,300° C., about 1,900° C. to about 2,500° C., about 1,900° C. to about 3,000° C., about 1,900° C. to about 3,500° C., about 1,900° C. to about 4,000° C., about 2,000° C. to about 2,100° C., about 2,000° C. to about 2,300° C., about 2,000° C. to about 2,500° C., about 2,000° C. to about 3,000° C., about 2,000° C. to about 3,500° C., about 2,000° C. to about 4,000° C., about 2,100° C. to about 2,300° C., about 2,100° C. to about 2,500° C., about 2,100° C. to about 3,000° C., about 2,100° C. to about 3,500° C., about 2,100° C. to about 4,000° C., about 2,300° C. to about 2,500° C., about 2,300° C. to about 3,000° C., about 2,300° C. to about 3,500° C., about 2,300° C. to about 4,000° C., about 2,500° C. to about 3,000° C., about 2,500° C. to about 3,500° C., about 2,500° C. to about 4,000° C., about 3,000° C. to about 3,500° C., about 3,000° C. to about 4,000° C., or about 3,500° C. to about 4,000° C. In some embodiments, the composite matrices are heated to a maximum temperature of about 800° C., about 1,000° C., about 1,500° C., about 1,700° C., about 1,900° C., about 2,000° C., about 2,100° C., about 2,300° C., about 2,500° C., about 3,000° C., about 3,500° C., or about 4,000° C. In some embodiments, the composite matrices are heated to a maximum temperature of at least about 800° C., about 1,000° C., about 1,500° C., about 1,700° C., about 1,900° C., about 2,000° C., about 2,100° C., about 2,300° C., about 2,500° C., about 3,000° C., or about 3,500° C. In some embodiments, the composite matrices are heated to a maximum temperature of at most about 1,000° C., about 1,500° C., about 1,700° C., about 1,900° C., about 2,000° C., about 2,100° C., about 2,300° C., about 2,500° C., about 3,000° C., about 3,500° C., or about 4,000° C.

In some embodiments, the ramp rate is about 10° C./min to about 400° C./min. In some embodiments, the ramp rate is about 10° C./min to about 25° C./min, about 10° C./min to about 50° C./min, about 10° C./min to about 75° C./min, about 10° C./min to about 100° C./min, about 10° C./min to about 125° C./min, about 10° C./min to about 150° C./min, about 10° C./min to about 175° C./min, about 10° C./min to about 200° C./min, about 10° C./min to about 250° C./min, about 10° C./min to about 300° C./min, about 10° C./min to about 400° C./min, about 25° C./min to about 50° C./min, about 25° C./min to about 75° C./min, about 25° C./min to about 100° C./min, about 25° C./min to about 125° C./min, about 25° C./min to about 150° C./min, about 25° C./min to about 175° C./min, about 25° C./min to about 200° C./min, about 25° C./min to about 250° C./min, about 25° C./min to about 300° C./min, about 25° C./min to about 400° C./min, about 50° C./min to about 75° C./min, about 50° C./min to about 100° C./min, about 50° C./min to about 125° C./min, about 50° C./min to about 150° C./min, about 50° C./min to about 175° C./min, about 50° C./min to about 200° C./min, about 50° C./min to about 250° C./min, about 50° C./min to about 300° C./min, about 50° C./min to about 400° C./min, about 75° C./min to about 100° C./min, about 75° C./min to about 125° C./min, about 75° C./min to about 150° C./min, about 75° C./min to about 175° C./min, about 75° C./min to about 200° C./min, about 75° C./min to about 250° C./min, about 75° C./min to about 300° C./min, about 75° C./min to about 400° C./min, about 100° C./min to about 125° C./min, about 100° C./min to about 150° C./min, about 100° C./min to about 175° C./min, about 100° C./min to about 200° C./min, about 100° C./min to about 250° C./min, about 100° C./min to about 300° C./min, about 100° C./min to about 400° C./min, about 125° C./min to about 150° C./min, about 125° C./min to about 175° C./min, about 125° C./min to about 200° C./min, about 125° C./min to about 250° C./min, about 125° C./min to about 300° C./min, about 125° C./min to about 400° C./min, about 150° C./min to about 175° C./min, about 150° C./min to about 200° C./min, about 150° C./min to about 250° C./min, about 150° C./min to about 300° C./min, about 150° C./min to about 400° C./min, about 175° C./min to about 200° C./min, about 175° C./min to about 250° C./min, about 175° C./min to about 300° C./min, about 175° C./min to about 400° C./min, about 200° C./min to about 250° C./min, about 200° C./min to about 300° C./min, about 200° C./min to about 400° C./min, about 250° C./min to about 300° C./min, about 250° C./min to about 400° C./min, or about 300° C./min to about 400° C./min. In some embodiments, the ramp rate is about 10° C./min, about 25° C./min, about 50° C./min, about 75° C./min, about 100° C./min, about 125° C./min, about 150° C./min, about 175° C./min, about 200° C./min, about 250° C./min, about 300° C./min, or about 400° C./min. In some embodiments, the ramp rate is at least about 10° C./min, about 25° C./min, about 50° C./min, about 75° C./min, about 100° C./min, about 125° C./min, about 150° C./min, about 175° C./min, about 200° C./min, about 250° C./min, or about 300° C./min. In some embodiments, the ramp rate is at most about 25° C./min, about 50° C./min, about 75° C./min, about 100° C./min, about 125° C./min, about 150° C./min, about 175° C./min, about 200° C./min, about 250° C./min, about 300° C./min, or about 400° C./min.

In some embodiments, the composite matrix is heated for a total time of about 1 min to about 60 mins. In some embodiments, the composite matrix is heated for a total time of about 1 min, about 3 mins, about 5 mins, about 6 mins, about 7 mins, about 8 mins, about 9 mins, about 10 mins, about 15 mins, about 20 mins, about 30 mins, or about 60 mins. In some embodiments, the composite matrix is heated for a total time of at least about 1 min, about 3 mins, about 5 mins, about 6 mins, about 7 mins, about 8 mins, about 9 mins, about 10 mins, about 15 mins, about 20 mins, or about 30 mins. In some embodiments, the composite matrix is heated for a total time of at most about 3 mins, about 5 mins, about 6 mins, about 7 mins, about 8 mins, about 9 mins, about 10 mins, about 15 mins, about 20 mins, about 30 mins, or about 60 mins. In some embodiments, the composite matrix is heated for a total time of about 1 min to about 120 mins. In some embodiments, the composite matrix is heated for a total time of about 1 min to about 3 mins, about 1 min to about 5 mins, about 1 min to about 10 mins, about 1 min to about 15 mins, about 1 min to about 20 mins, about 1 min to about 30 mins, about 1 min to about 45 mins, about 1 min to about 60 mins, about 1 min to about 75 mins, about 1 min to about 90 mins, about 1 min to about 120 mins, about 3 mins to about 5 mins, about 3 mins to about 10 mins, about 3 mins to about 15 mins, about 3 mins to about 20 mins, about 3 mins to about 30 mins, about 3 mins to about 45 mins, about 3 mins to about 60 mins, about 3 mins to about 75 mins, about 3 mins to about 90 mins, about 3 mins to about 120 mins, about 5 mins to about 10 mins, ab out 5 mins to about 15 mins, about 5 mins to about 20 mins, about 5 mins to about 30 mins, about 5 mins to about 45 mins, about 5 mins to about 60 mins, about 5 mins to about 75 mins, about 5 mins to about 90 mins, about 5 mins to about 120 mins, about 10 mins to about 15 mins, about 10 mins to about 20 mins, about 10 mins to about 30 mins, about 10 mins to about 45 mins, about 10 minsto about 60 mins, about 10 mins to about 75 mins, about 10 mins to about 90 mins, about 10 mins to about 120 mins, about 15 mins to about 20 mins, about 15 mins to about 30 mins, about 15 mins to about 45 mins, about 15 minsto about 60 mins, about 15 minsto about 75 mins, about 15 mins to about 90 mins, about 15 mins to about 120 mins, about 20 mins to about 30 mins, about 20 mins to about 45 mins, about 20 mins to about 60 mins, about 20 mins to about 75 mins, about 20 mins to about 90 mins, about 20 mins to about 120 mins, about 30 minsto about 45 mins, about 30 minsto about 60 mins, about 30 minsto about 75 mins, about 30 mins to about 90 mins, about 30 mins to about 120 mins, about 45 mins to about 60 mins, about 45 mins to about 75 mins, about 45 mins to about 90 mins, about 45 mins to about 120 mins, about 60 mins to about 75 mins, about 60 mins to about 90 mins, about 60 mins to about 120 mins, about 75 mins to about 90 mins, about 75 mins to about 120 mins, or about 90 mins to about 120 mins. In some embodiments, the composite matrix is heated for a total time of about 1 min, about 3 mins, about 5 mins, about 10 mins, about 15 mins, about 20 mins, about 30 mins, about 45 mins, about 60 mins, about 75 mins, about 90 mins, or about 120 mins. In some embodiments, the composite matrix is heated for a total time of at least about 1 min, about 3 mins, about 5 mins, about 10 mins, about 15 mins, about 20 mins, about 30 mins, about 45 mins, about 60 mins, about 75 mins, or about 90 mins. In some embodiments, the composite matrix is heated for a total time of at most about 3 mins, about 5 mins, about 10 mins, about 15 mins, about 20 mins, about 30 mins, about 45 mins, about 60 mins, about 75 mins, about 90 mins, or about 120 mins. In some embodiments, the composite matrix is heated for a total time of about 1 hour to about 48 hours. In some embodiments, the composite matrix is heated for a total time of about 1 hour, about 2 hours, about 3 hours, about 4 hours, about 5 hours, about 6 hours, about 9 hours, about 12 hours, about 18 hours, about 24 hours, or about 48 hours. In some embodiments, the composite matrix is heated for a total time of at least about 1 hour, about 2 hours, about 3 hours, about 4 hours, about 5 hours, about 6 hours, about 9 hours, about 12 hours, about 18 hours, or about 24 hours. In some embodiments, the composite matrix is heated for a total time of at most about 2 hours, about 3 hours, about 4 hours, about 5 hours, about 6 hours, about 9 hours, about 12 hours, about 18 hours, about 24 hours, or about 48 hours. In some embodiments, the composite matrix is heated for a total time of at least about 10 mins, 30 mins, 1 hour, 2 hours, about 3 hours, about 4 hours, about 5 hours, about 6 hours, about 9 hours, about 12 hours, about 18 hours, about 24 hours, or about 48 hours. In some embodiments, the composite matrix is heated for a total time of about 1 hour to ab out 72 hours. In some embodiments, the composite matrix is heated for a total time of about 1 hour to about 2 hours, about 1 hour to about 3 hours, about 1 hour to about 4 hours, about 1 hour to about 5 hours, about 1 hour to about 10 hours, about 1 hour to about 12 hours, about 1 hour to about 18 hours, about 1 hour to about 24 hours, about 1 hour to about 36 hours, about 1 hour to about 48 hours, about 1 hour to about 72 hours, about 2 hours to about 3 hours, about 2 hours to about 4 hours, about 2 hours to about 5 hours, about 2 hours to about 10 hours, about 2 hours to about 12 hours, about 2 hours to about 18 hours, about 2 hours to about 24 hours, about 2 hours to about 36 hours, about 2 hours to about 48 hours, about 2 hours to about 72 hours, about 3 hours to about 4 hours, about 3 hours to about 5 hours, about 3 hours to about 10 hours, about 3 hours to about 12 hours, about 3 hours to about 18 hours, about 3 hours to about 24 hours, about 3 hours to about 36 hours, about 3 hours to about 48 hours, about 3 hours to about 72 hours, about 4 hours to about 5 hours, about 4 hours to about 10 hours, about 4 hours to about 12 hours, about 4 hours to about 18 hours, about 4 hours to about 24 hours, about 4 hours to about 36 hours, about 4 hours to about 48 hours, about 4 hours to about 72 hours, about 5 hours to about 10 hours, about 5 hours to about 12 hours, about 5 hours to about 18 hours, about 5 hours to about 24 hours, about 5 hours to about 36 hours, about 5 hours to about 48 hours, about 5 hours to about 72 hours, about 10 hours to about 12 hours, about 10 hours to about 18 hours, about 10 hours to about 24 hours, about 10 hours to about 36 hours, about 10 hours to about 48 hours, about 10 hours to about 72 hours, about 12 hours to about 18 hours, about 12 hours to about 24 hours, about 12 hours to about 36 hours, about 12 hours to about 48 hours, about 12 hours to about 72 hours, about 18 hours to about 24 hours, about 18 hours to about 36 hours, about 18 hours to about 48 hours, about 18 hours to about 72 hours, about 24 hours to about 36 hours, about 24 hours to about 48 hours, about 24 hours to about 72 hours, about 36 hours to about 48 hours, about 36 hours to about 72 hours, or about 48 hours to about 72 hours. In some embodiments, the composite matrix is heated for a total time of about 1 hour, about 2 hours, about 3 hours, about 4 hours, about 5 hours, about 10 hours, about 12 hours, about 18 hours, about 24 hours, about 36 hours, about 48 hours, or about 72 hours. In some embodiments, the composite matrix is heated for a total time of at least about 1 hour, about 2 hours, about 3 hours, about 4 hours, about 5 hours, about 10 hours, about 12 hours, about 18 hours, about 24 hours, about 36 hours, or about 48 hours. In some embodiments, the composite matrix is heated for a total time of at most about 2 hours, about 3 hours, about 4 hours, about 5 hours, about 10 hours, about 12 hours, about 18 hours, about 24 hours, about 36 hours, about 48 hours, or about 72 hours.

In some embodiments, the composite matrix is held at the maximum temperature for about 1 min to about 60 mins. In some embodiments, the composite matrix is held at the maximum temperature for about 1 min, about 3 mins, about 5 mins, about 6 mins, about 7 mins, about 8 mins, about 9 mins, about 10 mins, about 15 mins, about 20 mins, about 30 mins, or about 60 mins. In some embodiments, the composite matrix is held at the maximum temperature for at least about 1 min, about 3 mins, about 5 mins, about 6 mins, about 7 mins, about 8 mins, about 9 mins, about 10 mins, about 15 mins, about 20 mins, or about 30 mins. In some embodiments, the composite matrix is held at the maximum temperature for at most about 3 mins, about 5 mins, about 6 mins, about 7 mins, about 8 mins, about 9 mins, about 10 mins, about 15 mins, about 20 mins, about 30 mins, or about 60 mins. In some embodiments, the composite matrix is held at the maximum temperature for a total time of about 1 min to about 120 mins. In some embodiments, the composite matrix is held at the maximum temperature for a total time of about 1 min to about 3 mins, about 1 min to about 5 mins, about 1 min to about 10 mins, about 1 min to about 15 mins, about 1 min to about 20 mins, about 1 min to about 30 mins, about 1 min to about 45 mins, about 1 min to about 60 mins, about 1 min to about 75 mins, about 1 min to about 90 mins, about 1 min to about 120 mins, about 3 mins to about 5 mins, about 3 mins to about 10 mins, about 3 mins to about 15 mins, about 3 mins to about 20 mins, about 3 mins to about 30 mins, about 3 mins to about 45 mins, about 3 mins to about 60 mins, about 3 mins to about 75 mins, about 3 mins to about 90 mins, about 3 mins to about 120 mins, about 5 mins to about 10 mins, about 5 mins to about 15 mins, about 5 mins to about 20 mins, about 5 mins to about 30 mins, about 5 mins to about 45 mins, about 5 mins to about 60 mins, about 5 mins to about 75 mins, about 5 mins to about 90 mins, about 5 mins to about 120 mins, about 10 mins to about 15 mins, about 10 mins to about 20 mins, about 10 minsto about 30 mins, about 10 mins to about 45 mins, about 10 mins to about 60 mins, about 10 mins to about 75 mins, about 10 minsto about 90 mins, about 10 mins to about 120 mins, about 15 mins to about 20 mins, about 15 mins to about 30 mins, about 15 mins to about 45 mins, about 15 mins to about 60 mins, about 15 mins to about 75 mins, about 15 minsto about 90 mins, about 15 minsto about 120 mins, about 20 mins to about 30 mins, about 20 mins to about 45 mins, about 20 minsto about 60 mins, about 20 mins to about 75 mins, about 20 mins to about 90 mins, about 20 mins to about 120 mins, about 30 mins to about 45 mins, about 30 mins to about 60 mins, about 30 mins to about 75 mins, about 30 minsto about 90 mins, about 30 minsto about 120 mins, about 45 mins to about 60 mins, about 45 mins to about 75 mins, about 45 minsto about 90 mins, about 45 mins to about 120 mins, about 60 mins to about 75 mins, about 60 mins to about 90 mins, about 60 mins to about 120 mins, about 75 mins to about 90 mins, about 75 mins to about 120 mins, or about 90 mins to about 120 mins. In some embodiments, the composite matrix is held at the maximum temperature for a total time of about 1 min, about 3 mins, about 5 mins, about 10 mins, about 15 mins, about 20 mins, about 30 mins, about 45 mins, about 60 mins, about 75 mins, about 90 mins, or about 120 mins. In some embodiments, the composite matrix is held at the maximum temperature for a total time of at least about 1 min, about 3 mins, about 5 mins, about 10 mins, about 15 mins, about 20 mins, about 30 mins, about 45 mins, about 60 mins, about 75 mins, or about 90 mins. In some embodiments, the composite matrix is heated for a total time of at most about 3 mins, about 5 mins, about 10 mins, about 15 mins, about 20 mins, about 30 mins, about 45 mins, about 60 mins, about 75 mins, about 90 mins, or about 120 mins. In some embodiments, the composite matrix is held at the maximum temperature for about 1 hour to about 48 hours. In some embodiments, the composite matrix is held at the maximum temperature for about 1 hour, about 2 hours, about 3 hours, about 4 hours, about 5 hours, about 6 hours, about 9 hours, about 12 hours, about 18 hours, about 24 hours, or about 48 hours. In some embodiments, the composite matrix is held at the maximum temperature for at least about 1 hour, about 2 hours, about 3 hours, about 4 hours, about 5 hours, about 6 hours, about 9 hours, about 12 hours, about 18 hours, or about 24 hours. In some embodiments, the composite matrix is held at the maximum temperature for at most about 2 hours, about 3 hours, about 4 hours, about 5 hours, about 6 hours, about 9 hours, about 12 hours, about 18 hours, about 24 hours, or about 48 hours. In some embodiments, the composite matrix is held at the maximum temperature for a total time of about 1 hour to about 72 hours. In some embodiments, the composite matrix is held at the maximum temperature for a total time of about 1 hour to about 2 hours, about 1 hour to about 3 hours, about 1 hour to about 4 hours, about 1 hour to about 5 hours, about 1 hour to about 10 hours, about 1 hour to about 12 hours, about 1 hour to about 18 hours, about 1 hour to about 24 hours, about 1 hour to about 36 hours, about 1 hour to about 48 hours, about 1 hour to about 72 hours, about 2 hours to about 3 hours, about 2 hours to about 4 hours, about 2 hours to about 5 hours, about 2 hours to about 10 hours, about 2 hours to about 12 hours, about 2 hours to about 18 hours, about 2 hours to about 24 hours, about 2 hours to about 36 hours, about 2 hours to about 48 hours, about 2 hours to about 72 hours, about 3 hours to about 4 hours, about 3 hours to about 5 hours, about 3 hours to about 10 hours, about 3 hours to about 12 hours, about 3 hours to about 18 hours, about 3 hours to about 24 hours, about 3 hours to about 36 hours, about 3 hours to about 48 hours, about 3 hours to about 72 hours, about 4 hours to about 5 hours, about 4 hours to about 10 hours, ab out 4 hours to about 12 hours, about 4 hours to about 18 hours, about 4 hours to about 24 hours, about 4 hours to about 36 hours, about 4 hours to about 48 hours, about 4 hours to about 72 hours, about 5 hours to about 10 hours, about 5 hours to about 12 hours, about 5 hours to about 18 hours, about 5 hours to about 24 hours, about 5 hours to about 36 hours, about 5 hours to about 48 hours, about 5 hours to about 72 hours, about 10 hours to about 12 hours, about 10 hours to about 18 hours, about 10 hours to about 24 hours, about 10 hours to about 36 hours, about 10 hours to about 48 hours, about 10 hours to about 72 hours, about 12 hours to about 18 hours, about 12 hours to about 24 hours, about 12 hours to about 36 hours, about 12 hours to about 48 hours, about 12 hours to about 72 hours, about 18 hours to about 24 hours, about 18 hours to about 36 hours, about 18 hours to about 48 hours, about 18 hours to about 72 hours, about 24 hours to about 36 hours, about 24 hours to about 48 hours, about 24 hours to about 72 hours, about 36 hours to about 48 hours, about 36 hours to about 72 hours, or about 48 hours to about 72 hours. In some embodiments, the composite matrix is heated for a total time of about 1 hour, about 2 hours, about 3 hours, about 4 hours, about 5 hours, about 10 hours, about 12 hours, about 18 hours, about 24 hours, about 36 hours, about 48 hours, or about 72 hours. In some embodiments, the composite matrix is held at the maximum temperature for a total time of at least about 1 hour, about 2 hours, about 3 hours, about 4 hours, about 5 hours, about 10 hours, about 12 hours, about 18 hours, about 24 hours, about 36 hours, or about 48 hours. In some embodiments, the composite matrix is held at the maximum temperature for a total time of at most about 2 hours, about 3 hours, about 4 hours, about 5 hours, about 10 hours, about 12 hours, about 18 hours, about 24 hours, about 36 hours, about 48 hours, or about 72 hours.

In some embodiments, sintering, heating, or melting is carried out using an electrical current. In some embodiments, heating is carried out by plasma spark sintering. The electrical current (I) used differs substantially depending on the scale of the synthesis. For example, in the lab scale samples described herein, heating is carried out with a electrical current of about 50 to 100 Amps. In some embodiments, heating is carried out with a current (I) of 50 Amps (A) or more. In some embodiments, heating is carried out with a I of 60 A or more. In some embodiments, heating is carried out with a I of 65 A or more. In some embodiments, heating is carried out with a I of 70 A or more. In some embodiments, heating is carried out with a I of 75 A or more. In some embodiments, heating is carried out with a I of 80 A or more. In some embodiments, heating is carried out with a I of 90 A or more. In some embodiments, heating is carried out with a I of 100 A or more. Synthesis on large industrial scales will require greatly increased current. In some embodiments, heating can be carried out with an electrical current of 10,000 to 50,000 Amps. In some embodiments, heating is carried out with a current of about 10,000 Amps, about 15,000 Amps, about 20,000 Amps, about 25,000 Amps, about 30,000 Amps, about 35,000 Amps, about 40,000 Amps, about 45,000 Amps, or about 50,000 Amps. In some embodiments, heating is carried out with a current of at least about 10,000 Amps, about 15,000 Amps, about 20,000 Amps, about 25,000 Amps, about 30,000 Amps, about 35,000 Amps, about 40,000 Amps, or about 45,000 Amps. In some embodiments, heating is carried out with a current of at most about 15,000 Amps, about 20,000 Amps, about 25,000 Amps, about 30,000 Amps, about 35,000 Amps, about 40,000 Amps, about 45,000 Amps, or about 50,000 Amps. In some embodiments, heating is carried out with a current (I) of 5,000 Amps (A) or more. In some embodiments, heating is carried out with a current (I) of 10,000 Amps (A) or more. In some embodiments, heating is carried out with a current (I) of 20,000 Amps (A) or more. In some embodiments, heating is carried out with a current (I) of 30,000 Amps (A) or more. In some embodiments, heating is carried out with a current (I) of 40,000 Amps (A) or more. In some embodiments, heating is carried out with a current (I) of 50,000 Amps (A) or more. Medium scale, pilot level synthesis may require an electrical current of 100 to 10,000 Amps. In some embodiments, heating is carried out with a current of about 100 Amps to about 10,000 Amps. In some embodiments, heating is carried out with a current of about 100 Amps, about 500 Amps, about 1,000 Amps, about 2,000 Amps, about 3,000 Amps, about 4,000 Amps, about 5,000 Amps, about 6,000 Amps, about 7,000 Amps, about 8,000 Amps, about 9,000 Amps, or about 10,000 Amps. In some embodiments, heating is carried out with a current of at least about 100 Amps, about 500 Amps, about 1,000 Amps, about 2,000 Amps, about 3,000 Amps, about 4,000 Amps, about 5,000 Amps, about 6,000 Amps, about 7,000 Amps, about 8,000 Amps, or about 9,000 Amps. In some embodiments, heating is carried out with a current of at most about 500 Amps, about 1,000 Amps, about 2,000 Amps, about 3,000 Amps, about 4,000 Amps, about 5,000 Amps, about 6,000 Amps, about 7,000 Amps, about 8,000 Amps, about 9,000 Amps, or about 10,000 Amps.

In some embodiments, the method comprises shaping the composite matrix into a radiation shield or a component thereof. In some embodiments, the radiation shield or component thereof comprises flat or curved plating. In some embodiments, the method comprises preparing a liquid composition comprising particles of the composite matrix. In some embodiments, the liquid composition comprises one or more binders, adhesives, and/or additives. In some embodiments, the liquid composition is formulated as a resinousliquid or an epoxy liquid configured to cure or harden into a solid. In some embodiments, the liquid composition is configured to cure or harden after mixing with a curing agent or hardener. In some embodiments, the liquid composition is configured to cure or harden at least partly in response to exposure to radiation (e.g., UV lamp for UV curable resin).

In some aspects, disclosed herein is a method comprising obtaining a liquid composition comprising particles of the composite matrix and spraying the liquid comprising the particles of the composite matrix (e.g., onto a suitable surface or substrate such as a steel sheet) to form a resin or epoxy that hardens to form radiation shielding or a component thereof.

In some aspects, disclosed herein is a method for installing the composite matrix to form a radiation shield or a component there. In some embodiments, the radiation shield or component thereof is installed within a reactor. In some embodiments, the reactor is a nuclear reactor. In some embodiments, the nuclear reactor is a fission reactor or a fusion reactor. In some embodiments, the fusion reactor has a tokamak design. In some embodiments, the fusion reactor has an ITER design. In some embodiments, the method comprises installing one or more sheets or layers of the composite matrix, optionally wherein the composite matrix is disposed on a substrate or surface. In some embodiments, the method comprises combining one or more sheets or layers of the composite matrix with additional shielding material. In some embodiments, the additional shielding material comprises one or more sheets or layers of a metal or a metal-based composite. In some embodiments, the metal comprises lead, cadmium, tin, antimony, tungsten, or bismuth. In some embodiments, the metal-based composite comprises a metal mixed with one or more binders or additives.

In some embodiments, the arc furnace electrode is made of graphite or tungsten metal. In some embodiments, the reaction vessel is water cooled.

In some embodiments, arc melting is performed in an inert gas atmosphere. In some embodiments, arc melting is performed in an argon atmosphere. In some embodiments, arc melting is performed in a helium atmosphere. In some embodiments, arc melting is performed in a dinitrogen atmosphere.

In some embodiments, arc melting is performed for 0.01-10 mins. In some embodiments, arc melting is performed for 0.01-8 mins. In some embodiments, arc melting is performed for 0.01-6 mins. In some embodiments, arc melting is performed for 0.01-5 mins. In some embodiments, arc melting is performed for 0.01-4 mins. In some embodiments, arc melting is performed for 0.5-3 mins. In some embodiments, arc melting is performed for 0.8-2.5 mins. In some embodiments, arc melting is performed for 1-2 mins. In some embodiments, arc melting is performed for about 0.01 mins to about 20 mins. In some embodiments, arc melting is performed for about 0.01 mins to about 0.5 mins, about 0.01 mins to about 1 min, about 0.01 mins to about 2 mins, about 0.01 mins to about 3 mins, about 0.01 minsto about 4 mins, about 0.01 mins to about 5 mins, about 0.01 mins to about 7.5 mins, about 0.01 mins to about 10 mins, about 0.01 mins to about 12.5 mins, about 0.01 mins to about 15 mins, about 0.01 mins to about 20 mins, about 0.5 mins to about 1 min, about 0.5 mins to about 2 mins, about 0.5 mins to about 3 mins, about 0.5 mins to about 4 mins, about 0.5 mins to about 5 mins, about 0.5 mins to about 7.5 mins, about 0.5 mins to about 10 mins, about 0.5 mins to about 12.5 mins, about 0.5 mins to about 15 mins, about 0.5 mins to about 20 mins, about 1 min to about 2 mins, about 1 min to about 3 mins, about 1 min to about 4 mins, about 1 min to about 5 mins, about 1 min to about 7.5 mins, about 1 min to about 10 mins, about 1 min to about 12.5 mins, about 1 min to about 15 mins, about 1 min to about 20 mins, about 2 mins to about 3 mins, about 2 mins to about 4 mins, about 2 mins to about 5 mins, about 2 mins to about 7.5 mins, about 2 mins to about 10 mins, about 2 mins to about 12.5 mins, about 2 mins to about 15 mins, about 2 mins to about 20 mins, about 3 mins to about 4 mins, about 3 mins to about 5 mins, about 3 mins to about 7.5 mins, about 3 mins to about 10 mins, about 3 mins to about 12.5 mins, about 3 mins to about 15 mins, about 3 mins to about 20 mins, about 4 mins to about 5 mins, about 4 mins to about 7.5 mins, about 4 mins to about 10 mins, about 4 mins to about 12.5 mins, about 4 mins to about 15 mins, about 4 mins to about 20 mins, about 5 mins to about 7.5 mins, about 5 mins to about 10 mins, about 5 mins to about 12.5 mins, about 5 mins to about 15 mins, about 5 mins to about 20 mins, about 7.5 mins to about 10 mins, about 7.5 mins to about 12.5 mins, about 7.5 mins to about 15 mins, about 7.5 mins to about 20 mins, about 10 mins to about 12.5 mins, about 10 mins to about 15 mins, about 10 mins to about 20 mins, about 12.5 mins to about 15 mins, about 12.5 mins to about 20 mins, or about 15 mins to about 20 mins. In some embodiments, arc melting is performed for about 0.01 mins, about 0.5 mins, about 1 min, about 2 mins, about 3 mins, about 4 mins, about 5 mins, about 7.5 mins, about 10 mins, about 12.5 mins, about 15 mins, or about 20 mins. In some embodiments, arc melting is performed for at least about 0.01 mins, about 0.5 mins, about 1 min, about 2 mins, about 3 mins, about 4 mins, about 5 mins, about 7.5 mins, about 10 mins, about 12.5 mins, or about 15 mins. In some embodiments, arc melting is performed for at most about 0.5 mins, about 1 min, about 2 mins, about 3 mins, about 4 mins, about 5 mins, about 7.5 mins, about 10 mins, about 12.5 mins, about 15 mins, or about 20 mins.

In some embodiments, sintering is carried out at room temperature. In some cases, sintering is carried out at a temperature range of between about 23° C. and about 27° C. In some cases, sintering is carried out at a temperature of about 24° C., about 25° C., or about 26° C.

In some embodiments, a sintering, heating, or melting described herein involves an elevated temperature and an elevated pressure, e.g., hot pressing. Hot pressing is a process involving a simultaneous application of pressure and high temperature, which can accelerate the rate of densification of a material (e.g., a composite matrix described herein). In some embodiments, a temperature from 1000° C. to 2200° C. and a pressure of up to 36,000 psi are used during hot pressing. In some embodiments, heating is achieved by plasma spark sintering.

In other embodiments, a sintering step described herein involves an elevated pressure and room temperature, e.g., cold pressing. In such embodiments, pressure of up to 36,000 psi is used.

In some embodiment, a sintering, heating, or melting described herein is carried out in a furnace. In some embodiments the furnace is an induction furnace. In some embodiments, the induction furnace is heated by electromagnetic induction. In some embodiments, the electromagnetic radiation used for electromagnetic induction has the frequency and wavelength of radio waves. In some embodiments, the electromagnetic radiation used for electromagnetic induction has the frequency from about 3 Hz to about 300 GHz and a wavelength from 1 mm to 10,000 km. In some embodiments, the frequency is from about 3 Hz to about 30 Hz. In some embodiments, the frequency is from about 30 Hz to about 300 Hz. In some embodiments, the frequency is from about 300 Hz to about 3000 Hz. In some embodiments, the frequency is from about 3 kHz to about 30 kHz. In some embodiments, the frequency is from about 30 kHz to about 300 kHz. In some embodiments, the frequency is from about 300 kHz to about 3000 kHz. In some embodiments, the frequency is from about 3 MHz to about 30 MHz. In some embodiments, the frequency is from about 30 MHz to about 300 MHz. In some embodiments, the frequency is from about 300 MHz to about 3000 MHz. In some embodiments, the frequency is from about 3 GHz to about 30 GHz. In some embodiments, the frequency is from about 30 GHz to about 300 GHz.

In some embodiments, the reaction vessel is lined with carbon graphite which is inductively heated by electromagnetic radiation with a frequency of 10-50 kHz. In some embodiments, the frequency is from about 50 Hz to about 400 kHz. In some embodiments, the frequency is from about 60 Hz to about 400 kHz. In some embodiments, the frequency is from about 100 Hz to about 400 kHz. In some embodiments, the frequency is from about 1 kHz to about 400 kHz. In some embodiments, the frequency is from about 10 kHz to about 300 kHz.

In some embodiments, the frequency is from about 50 kHz to about 200 kHz. In some embodiments, the frequency is from about 100 kHz to about 200 kHz. In some embodiments, the frequency is from about 1 kHz to about 50 kHz. In some embodiments, the frequency is from about 50 kHz to about 100 kHz.

In some embodiments, heating or melting described herein is carried out in a conventional furnace. In some embodiments, a conventional furnace heats the crucible or sample through the use of metal coils or combustion.

In some embodiments, the raw mixtures react with oxygen and carbon upon heating. Heating the mixture by electrical arc furnace, induction furnace, conventional furnace, hot pressing or plasma sintering requires that the majority of the raw mixture not come in contact with oxygen or carbon. In some embodiments, the reaction mixture (compressed or otherwise) is optionally shielded from the reaction chamber by an insulating material. In some embodiments, the reaction mixture is optionally shielded from the reaction chamber by an electrically insulating material. In some embodiments, at most about 95%, 90%, 85%, 80%, 70%, 60%, 50%, 40%, 30%, or less of the surface of the mixture is optionally shielded from the reaction chamber by the electrically insulating material. In some embodiments, the insulating material comprises hexagonal boron nitride (h-BN). In some embodiments, the insulating material does not contain carbon. In some embodiments, the compressed raw mixture is shielded from the arc furnace electrode by the electrically insulating material, optionally comprising hexagonal boron nitride.

In some embodiments, the compressed raw mixture is heated by an electric arc furnace. In some embodiments, the arc furnace electrode comprises graphite or tungsten metal. In some embodiments, the reaction vessel is optionally coated with an electrically insulating material. In some embodiments, at most about 95%, 90%, 85%, 80%, 70%, 60%, 50%, 40%, 30%, or less of the surface of the reaction vessel is optionally coated with the electrically insulating material. In some embodiments, the insulating material comprises hexagonal boron nitride (h-BN). In some embodiments, the insulating material does not contain carbon. In some embodiments, the compressed raw mixture is shielded from the arc furnace electrode by the electrically insulating material, optionally comprising hexagonal boron nitride.

In some embodiments, the composite matrix is composed of grains or crystallites that are less than 1000 micrometer in size. In some embodiments, the composite matrix is composed of grains or crystallites that are less than 100 micrometer in size. In some embodiments, the composite matrix is composed of grains or crystallites that are less than 50 micrometer in size. In some embodiments, the composite matrix is composed of grains or crystallites that are less than 10 micrometer in size. In some embodiments, the composite matrix is composed of grains or crystallites that are less than 1 micrometer in size.

In some embodiments, the compressed raw mixture is heated by an induction furnace. In some embodiments, the induction furnace is heated by electromagnetic induction. In some embodiments, the electromagnetic radiation used for electromagnetic induction has the frequency of radio waves. In some embodiments, the mixture is heated by hot pressing. In some embodiments, the mixture is heated by plasma spark sintering. In some embodiments, the reaction vessel is water cooled. In some embodiments, the reaction vessel is graphite lined. In some embodiments, graphite is heated within the reaction vessel. In some embodiments, the compressed raw mixture is shielded from the graphite lined reaction vessel by an electrically insulating material, optionally comprising hexagonal boron nitride.

In some embodiments, the compressed raw mixture is heated by an electric arc furnace. In some embodiments, the arc furnace electrode is made of graphite or tungsten metal. In some embodiments, the compressed raw mixture is partially shielded from the arc furnace electrode by an electrically insulating material, optionally comprising hexagonal boron nitride.

In some embodiments, the compressed raw mixture is heated by an induction furnace. In some embodiments, the induction furnace is heated by electromagnetic induction. In some embodiments, the electromagnetic radiation used for electromagnetic induction has the frequency of radio waves. In some embodiments, the mixture is heated by hot pressing. In some embodiments, the mixture is heated by plasma spark sintering. In some embodiments, the reaction vessel is water cooled. In some embodiments, the reaction vessel is graphite lined. In some embodiments, the radiofrequency induction is tuned to carbon, and the graphite is heated within the reaction vessel. In some embodiments, the compressed raw mixture is shielded from the graphite lined reaction vessel by an electrically insulating material, optionally comprising hexagonal boron nitride.

In some embodiments, the compressed raw mixture is melted by an electric arc furnace or plasma arc furnace. In some embodiments, the arc furnace electrode is made of graphite or tungsten metal. In some embodiments, in reaction vessel is water cooled. In some embodiments, the cooling rate of the reaction vessel is controlled. In some embodiments, the reaction vessel is allowed to cool to ambient temperature.

In some embodiments, the reaction vessel is purged with an inert gas to generate the inert atmosphere. In some embodiments, the inert gas comprises argon, nitrogen, or helium. In some embodiments, the reaction vessel is subjected to at least one cycle of applying a vacuum and flushing the reaction vessel with an inert gas to remove oxygen from the reaction vessel.

In certain embodiments, described herein are methods of making a composite matrix comprising tungsten tetraboride with a reduced or non-detectable amount of metal side products (orby-products) (e.g., less than 20%, 15%, 10%, 5%, 4%, 3%, 2%, 1%, 0.5% or less of the composite is metal side products).

In some embodiments, the reaction chamber is separated from the reaction mixture by a liner. In some embodiments, the liner is an h-BN liner. In some embodiments, the liner is a metal liner. In some embodiments, the liner is comprised of one or more transition elements. In some embodiments, the metal liner comprises a group 4, group 5, group 6, or group 7 transition metal. In some embodiments, the metal liner comprises one or more of the following elements: Ti, Zr, Hf, V, Nb, Ta, Cr, Mo, W, Mn, Tc, and Re. In some embodiments, the metal liner comprises Nb, Ta, Mo, or W. In some embodiments, the metal liner comprises Nb. In some embodiments, the metal liner comprises Ta. In some embodiments, the metal liner comprises Mo. In some embodiments, the metal liner comprises W.

In some embodiments, the liner has a thickness of about 0.05 mm. In some embodiments, the liner has a thickness of about 0.10 mm. In some embodiments, the liner has a thickness of about 0.15 mm. In some embodiments, the liner has a thickness of about 0.20 mm. In some embodiments, the liner has a thickness of about 0.25 mm. In some embodiments, the liner has a thickness of about 0.30 mm. In some embodiments, the liner has a thickness of about 0.05 mm. In some embodiments, the liner has a thickness of about 0.35 mm. In some embodiments, the liner has a thickness of about 0.40 mm. In some embodiments, the liner has a thickness of about 0.05 mm. In some embodiments, the liner has a thickness of about 0.45 mm. In some embodiments, the liner has a thickness of about 0.50 mm. In some embodiments, the liner has a thickness of about 0.75 mm. In some embodiments, the liner has a thickness of about 1.0 mm. In some embodiments, the liner has a thickness of about 5.0 mm. In some embodiments, the liner has a thickness of about 10.0 mm.

In some embodiments, the liner has a thickness of greater than or about 0.05 mm. In some embodiments, the liner has a thickness of greater than or about 0.10 mm. In some embodiments, the liner has a thickness of greater than or about 0.15 mm. In some embodiments, the liner has a thickness of greater than or about 0.20 mm. In some embodiments, the liner has a thickness of greater than or about 0.25 mm. In some embodiments, the liner has a thickness of greater than or about 0.30 mm. In some embodiments, the liner has a thickness of greater than or about 0.05 mm. In some embodiments, the liner has a thickness of greater than or about 0.35 mm. In some embodiments, the liner has a thickness of greater than or about 0.40 mm. In some embodiments, the liner has a thickness of greater than or about 0.05 mm. In some embodiments, the liner has a thickness of greater than or about 0.45 mm. In some embodiments, the liner has a thickness of greater than or about 0.50 mm. In some embodiments, the liner has a thickness of greater than or about 0.75 mm. In some embodiments, the liner has a thickness of greater than or about 1.0 mm. In some embodiments, the liner has a thickness of greater than or about 5.0 mm. In some embodiments, the liner has a thickness of greater than or about 10.0 mm.

In some embodiments, the liner has a thickness of about 0.01 mm to about 5 mm. In some embodiments, the liner has a thickness of about 0.01 mm to about 0.05 mm, about 0.01 mm to about 0.15 mm, about 0.01 mm to about 0.2 mm, about 0.01 mm to about 0.25 mm, about 0.01 mm to about 0.3 mm, about 0.01 mm to about 0.35 mm, about 0.01 mm to about 0.4 mm, about 0.01 mm to about 0.45 mm, about 0.01 mm to about 0.5 mm, about 0.01 mm to about 1 mm, about 0.01 mm to about 5 mm, about 0.05 mm to about 0.15 mm, about 0.05 mm to about 0.2 mm, about 0.05 mm to about 0.25 mm, about 0.05 mm to about 0.3 mm, about 0.05 mm to about 0.35 mm, about 0.05 mm to about 0.4 mm, about 0.05 mm to about 0.45 mm, about 0.05 mm to about 0.5 mm, about 0.05 mm to about 1 mm, about 0.05 mm to about 5 mm, about 0.15 mm to about 0.2 mm, about 0.15 mm to about 0.25 mm, about 0.15 mm to about 0.3 mm, about 0.15 mm to about 0.35 mm, about 0.15 mm to about 0.4 mm, about 0.15 mm to about 0.45 mm, about 0.15 mm to about 0.5 mm, about 0.15 mm to about 1 mm, about 0.15 mm to about 5 mm, about 0.2 mm to about 0.25 mm, about 0.2 mm to about 0.3 mm, about 0.2 mm to about 0.35 mm, about 0.2 mm to about 0.4 mm, about 0.2 mm to about 0.45 mm, about 0.2 mm to about 0.5 mm, about 0.2 mm to about 1 mm, about 0.2 mm to about 5 mm, about 0.25 mm to about 0.3 mm, about 0.25 mm to about 0.35 mm, about 0.25 mm to about 0.4 mm, about 0.25 mm to about 0.45 mm, about 0.25 mm to about 0.5 mm, about 0.25 mm to about 1 mm, about 0.25 mm to about 5 mm, about 0.3 mm to about 0.35 mm, about 0.3 mm to about 0.4 mm, about 0.3 mm to about 0.45 mm, about 0.3 mm to about 0.5 mm, about 0.3 mm to about 1 mm, about 0.3 mm to about 5 mm, about 0.35 mm to about 0.4 mm, about 0.35 mm to about 0.45 mm, about 0.35 mm to about 0.5 mm, about 0.35 mm to about 1 mm, about 0.35 mm to about 5 mm, about 0.4 mm to about 0.45 mm, about 0.4 mm to about 0.5 mm, about 0.4 mm to about 1 mm, about 0.4 mm to about 5 mm, about 0.45 mm to about 0.5 mm, about 0.45 mm to about 1 mm, about 0.45 mm to about 5 mm, about 0.5 mm to about 1 mm, about 0.5 mm to about 5 mm, or about 1 mm to about 5 mm.

In some embodiments, the neutron shielding devices and compositions comprising a composite matrix utilizing W₁₋ₓMoₓB₄ or WB₄ compositions are regenerable. In some embodiments, an envisioned use for the composite matrices described herein is the absorption of neutrons stemming from a nuclear fusion reactor. In some embodiments, the boron in the composite use is naturally occurring or isotopically enriched for boron-10. However, as the material absorbs neutron radiation, the isotopic enrichment will be depleted as boron 10 converts to boron 11. The depletion will occur more rapidly at the surface of the material. It may therefore by useful to regenerate the surface of the shielding material by removing the depleted surface. Under certain conditions, such as when the composite is exposed to high humidity or direct contact with water over time, B₂O₃ is formed by a reaction with the tungsten tetraboride present in the composite. The B₂O₃ and the byproducts may be removed to form a fresh layer of the composite with boron-10. In some embodiments, described herein is a method of regenerating a radiation shield described herein comprising: a) exposing the radiation shield to water for a period of time sufficient to form at least B₂O₃ and metal oxides, and b) removing the B₂O₃ and metal oxides to yield a surface of the composite matrix with an increase in boron-10 relative to the formation and removal of the B₂O₃ and metal oxides.

### Additional Applications of Composite Matrices

The shielding devices and compositions disclosed herein may be exposed to various environmental stresses while being used to shield against radiation. Wear and tear on shielding materials can occur as a result of environmental stresses during normal operating environments which can involve substantial mechanical and/or thermal cycling. Nuclear reactors can produce high temperatures as a result of the gamma radiation emitted from the fission process, the thermal energy created from the collision of atomic nuclei, and heat produced from radioactive decay of fission products. For example, the high temperature gas-cooled reactor (HTGR) may conceptually achieve temperatures of up to 1000 degrees Celsius. There are also different types of wear mechanisms, including, for example, abrasion wear, adhesion wear, attrition wear, diffusion wear, fatigue wear, edge chipping (or premature wear), and oxidation wear (or corrosive wear). For example, radiation shielding materials may be subject to wear mechanisms depending on the operating environment. Abrasion wear occurs when the hard particle or debris, such as chips, passes over or abrades the surface of a radiation shield. Adhesion wear or attrition wear occurs when debris removes microscopic fragments from a radiation shield. Diffusion wear occurs when atoms in a crystal lattice move from a region of high concentration to a region of low concentration and the move weakens the surface structure of a radiation shield. Fatigue wear occurs at a microscopic level when two surfaces slide in contact with each other under high pressure, generating surface cracks. Edge chipping or premature wear occurs as small breaking away of materials from the surface of a radiation shield. Oxidation wear or corrosive wear occurs as a result of a chemical reaction between the surface of a radiation shield and oxygen. In some embodiments, a composite matrix described herein is used to make, modify, or combine with a radiation shield.

### Manufacturing Applications

Described herein are radiation shielding devices or components thereof, wherein the shielding devices or components thereof comprise a surface or body comprising a composite matrix of Formula I, II, III, or IV. In some embodiments, the surface or body is manufactured by turning, milling, grinding, drilling, Electrical Discharge Manufacturing (EDM), Electrochemical Machining (ECM), water jet cutting, plasma cutting, or laser machining. In some embodiments, the radiation shielding devices or components thereof are manufactured using EDM. In some embodiments, EDM comprises spark machining, spark eroding, die sinking, wire burning, wire erosion, and laser ablation.

EDM is a primary technique used in the machining of extremely hard metals or other hard materials that are difficult to machine through traditional techniques such as turning, milling, grinding, and drilling. EDM is incompatible with ceramics with low electrical conductivity, including useful super hard ceramics such as SiC and B₄C. However, composite matrices such as those of Formula I, II, III, or IV (e.g., including ceramic composites of (W₁₋ₓMoₓB₄)_{z}(Q)ₙ or (WB₄)_{z}(Q)ₙ) are compatible with EDM. One competing material with comparable properties to the claimed (W₁₋ₓMoₓB₄)_{z}(Q)ₙ and (WB₄)_{z}(Q)ₙ composites is cubic boronitirde. While of comparable hardness and toughness, pure cubic boronitride is not compatible with EDM and therefore can be more difficult to machine or costly to manufacture. However, introducing WB₄ to form composite matrices of (WB₄)_{z}(BN)ₙ can overcome such limitations.

### Certain Terminologies

Unless defined otherwise, all technical and scientific terms used herein have the same meaning as is commonly understood by one of skill in the art to which the claimed subject matter belongs. It is to be understood that the detailed description are exemplary and explanatory only and are not restrictive of any subject matter claimed. In this application, the use of the singular includes the plural unless specifically stated otherwise. It must be noted that, as used in the specification, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment.

Reference in the specification to “some embodiments”, “an embodiment”, “one embodiment” “another embodiment” or “other embodiments” means that a particular feature, structure, or characteristic described in connection with the embodiments is included in at least some embodiments, but not necessarily all embodiments, of the disclosure.

As used herein, ranges and amounts can be expressed as “about” a particular value or range. About also includes the exact amount. Hence “about 5 GPa” means “about 5 GPa” and also “5 GPa.” Generally, the term “about” includes an amount that would be expected to be within experimental error, e.g., +5%, ±10% or 15%. In some embodiments, “about” includes ±5%. In some embodiments, “about” includes ±10%. In some embodiments, “about” includes 15%. In some embodiments, when refereeing to X-ray powder diffraction peaks at 2 theta, the term “about” includes ±0.3 Angstroms.

The term “partially” is meantto describe an amountthatis less that is less than 95%.

The term “completely” is meantto describe an amount that is equal to or more than 95%.

The term “thermodynamically stable” or “stable” describes a state of matter that that is in chemical equilibrium with its environment at 23° C. and at 1 atmosphere of pressure. Stable states described herein do not consume or release energy at 23° C. and 1 atm.

The term “composite matrix” and “composite” can be used interchangeably, and refers to a collection of atoms wherein one component is crystalline WB₄ or W₁₋ₓMoₓB₄ with variables M and x described above, and a second component. The second component can be one or more ceramics Q as described above. The at least one component of crystalline WB₄ or W₁₋ₓMoₓB₄ exhibits X-ray powder diffraction peaks as disclosed herein. In some embodiments, the composite matrix comprises crystalline WB₄ or W₁₋ₓMoₓB₄. Crystalline WB₄ or W₁₋ₓMoₓB₄ may optionally include excess boron leftover from the formation of the crystalline WB₄ or W₁₋ₓMoₓB₄. In some embodiments, the composite matrix comprises crystalline WB₄ or W₁₋ₓMoₓB₄, and one or more ceramics Q. In some embodiments, the composite matrix comprises crystalline WB₄ or W₁₋ₓMoₓB₄, one or more ceramics Q, and grain boundaries between crystalline WB₄ or W₁₋ₓMoₓB₄ and Q. In some embodiments, the second component can be an alloy of two or more metals T as described above. In some embodiments, the composite matrix includes both one or more ceramics Q and an alloy of one or more metals T.

The term “grain boundaries” is meant to describe the material at the interface between crystalline WB₄ or W₁₋ₓMoₓB₄ and Q. In some embodiments, grain boundaries bind the composite together and provide a layer between the WB₄ or W₁₋ₓMoₓB₄ and Q so as to reduce reactivity between the two components. The grain boundaries comprise the byproducts of a chemical reaction between WB₄ or W₁₋ₓMoₓB₄ and Q, and optionally WB₄, W₁₋ₓMoₓB₄, Q, or starting materials leftover from the synthesis of Q, WB₄, or W₁₋ₓMoₓB₄ such as boron. Grain boundaries may comprise, for example, lower metal borides such as WB₂, WB, MB, or MB₂.

The term “x” is to be construed as a molar ratio.

The terms “z,” “q,” and “n” are to be construed as volume ratios. The values of z, q, and n are described herein as decimals and/or percentages. When z, q, and n are described as decimals, the terms can be converted to volume percent by multiplying by 100%. For example, if n is described as a range of 0.001 to 0.999, this is equivalent to a range of 0.1% to 99.9% by volume.

The section headings used herein are for organizational purposes only and are not to be construed as limiting the subject matter described.

### EXAMPLES

These examples are provided for illustrative purposes only and not to limit the scope of the claims provided herein.

### Example 1. X-ray Diffraction

Powder XRD was carried out on a Bruker D8 Discover Powder X-ray Diffractometer (Bruker Corporation, Germany)utilizing Cu_{Kα}, X-ray radiation (λ=1.5418 Å). The following scan parameters were used: 5-100°2θ range, time per step of 0.3 sec, step size of 0.0353° with a scan speed of 0.10550/sec. In order to determine the phases present in the powder X-ray diffraction data, the Joint Committee on Powder Diffraction Standards (JCPDS) database was utilized. The composition and purity of the samples were determined on an FEI Nova 230 high resolution scanning electron microscope (FEI Company, U.S.A.) with an UltraDry EDS detector (Thermo Scientific, U.S.A.). Rietveld refinement utilizing Maud software was carried out to determine the cell parameters.

Table 2 shows X-ray powder diffraction data collected from the crystalline WB₄ synthesized by the methods disclosed herein. Table 2 contains the location of each diffraction peak in terms of Miller indices (h,k,l), distance (Angstroms), and 2 theta (degrees). The diffraction data was collected at 293 K with an X-ray diffractometer utilizing a Copper radiation source (λ=1.5418 Å).

TABLE 2

| No. | h | k | l | d[A] | 2 Theta[deg] | I[%] |
|---|---|---|---|---|---|---|
| 1 | 1 | 0 | 0 | 4.51000 | 19.668 | 4.0 |
| 2 | 1 | 0 | 1 | 3.67000 | 24.232 | 100.0 |
| 3 | 0 | 0 | 2 | 3.17000 | 28.127 | 30.0 |
| 4 | 1 | 1 | 0 | 2.59800 | 34.495 | 65.0 |
| 5 | 2 | 0 | 0 | 2.25000 | 40.041 | 2.0 |
| 6 | 2 | 0 | 1 | 2.12500 | 42.507 | 25.0 |
| 7 | 1 | 1 | 2 | 2.01000 | 45.068 | 80.0 |
| 8 | 1 | 0 | 3 | 1.91100 | 47.543 | 20.0 |
| 9 | 2 | 0 | 2 | 1.83600 | 49.613 | 2.0 |
| 10 | 2 | 1 | 0 | 1.70000 | 53.888 | 2.0 |
| 11 | 2 | 1 | 1 | 1.64400 | 55.881 | 25.0 |
| 12 | 0 | 0 | 4 | 1.58400 | 58.195 | 10.0 |
| 13 | 2 | 0 | 3 | 1.54000 | 60.026 | 10.0 |
| 14 | 3 | 0 | 0 | 1.50100 | 61.753 | 20.0 |
| 15 | 3 | 0 | 2 | 1.35600 | 69.231 | 20.0 |
| 16 | 1 | 1 | 4 | 1.35300 | 69.407 | 20.0 |
| 17 | 2 | 1 | 3 | 1.32500 | 71.092 | 10.0 |
| 18 | 2 | 2 | 0 | 1.30000 | 72.675 | 8.0 |
| 19 | 3 | 1 | 1 | 1.22500 | 77.926 | 10.0 |
| 20 | 1 | 0 | 5 | 1.22000 | 78.306 | 4.0 |
| 21 | 2 | 2 | 2 | 1.20200 | 79.710 | 20.0 |
| 22 | 2 | 1 | 4 | 1.16100 | 83.132 | 2.0 |
| 23 | 4 | 0 | 0 | 1.12500 | 86.426 | 2.0 |
| 24 | 4 | 0 | 1 | 1.10900 | 87.989 | 4.0 |
| 25 | 2 | 0 | 5 | 1.10500 | 88.390 | 4.0 |
| 26 | 3 | 0 | 4 | 1.09000 | 89.934 | 20.0 |
| 27 | 3 | 1 | 3 | 1.07500 | 91.542 | 6.0 |
| 28 | 4 | 0 | 2 | 1.06100 | 93.106 | 2.0 |
| 29 | 0 | 0 | 6 | 1.05700 | 93.565 | 2.0 |
| 30 | 3 | 2 | 0 | 1.03400 | 96.313 | 2.0 |
| 31 | 3 | 2 | 1 | 1.02000 | 98.085 | 6.0 |
| 32 | 2 | 1 | 5 | 1.01700 | 98.475 | 6.0 |
| 33 | 2 | 2 | 4 | 1.00300 | 100.349 | 6.0 |
| 34 | 4 | 0 | 3 | 0.99300 | 101.743 | 2.0 |
| 35 | 4 | 1 | 0 | 0.98300 | 103.187 | 8.0 |
| 36 | 1 | 1 | 6 | 0.97900 | 103.779 | 10.0 |
| 37 | 2 | 0 | 6 | 0.95600 | 107.366 | 2.0 |
| 38 | 4 | 1 | 2 | 0.93900 | 110.238 | 16.0 |
| 39 | 3 | 2 | 3 | 0.92800 | 112.211 | 6.0 |

Data collected at ambient temperature (293 K), radiation source Cu_{Ka} (λ = 1.5418 Å)

### Example 2. Synthesis and Properties of Composite Matrices

Crystalline W_{0.95}Cr_{0.05}B₄ and the ceramic were mixed until a uniform mixture is achieved. Mixing is performed via tumbling or low-speed milling. The mixture was compacted using a 80 MPa force at to generate a pellet. The pellet was placed in a graphite die with a h-BN coating. Plasma Spark Sintering (SPS) was used to heat the sample. The samples were pressured to 50-100 MPa heated to between 1300-1500° C. at a ramp rate of 200° C./min. The maximum temperature and maximum pressure was held for 1 to 5 mins. The samples were cooled to room temperature to afford the composites of Table 3.

TABLE 3

| | Vickers | Palmquist | |
|---|---|---|---|
| | Hardness* | Toughness | Density |
| Composite Matrices | (MPa) | (MPa m^{1/2}) | (g/cm³) |
| (W_{0.95}Cr_{0.05}B₄)_{90%}(TiB₂)_{10%} | 24.5-25.6 | 2.8 | 6.75 |
| (W_{0.95}Cr_{0.05}B₄)_{85%}(TiB₂)_{15%} | 23.3-24.1 | 3.5 | 6.35 |
| (W_{0.95}Cr_{0.05}B₄)_{90%}(SiC)_{10%} | 22.8-23.2 | 4.4 | 6.3 |
| (W_{0.95}Cr_{0.05}B₄)_{85%}(SiC)_{15%} | 19.7-21.5 | 4.6 | 6.1 |
| (W_{0.95}Cr_{0.05}B₄)_{90%}(B₄C)_{10%} | 23.2-24.1 | — | 6.3 |
| (W_{0.95}Cr_{0.05}B₄)_{85%}(B₄C)_{15%} | 21.5-22.4 | — | 5.9 |

*1 kg or 9.8 N Force load, average of 10 measurements

Hardness measurements were done on polished samples using a load-cell type multi-Vickers hardness tester (Leco, U.S.A.) with a pyramidal diamond indenter tip. Under each applied load: 0.49, 0.98, 1.96, 2.94 and 4.9N, 10 indents were made in randomly chosen spots on the sample surface. The lengths of the diagonals of the indents were measured using a high-resolution optical microscope, Zeiss Axiotech 100HD (Carl Zeiss Vision GmbH, Germany) with a 500× magnification. Vickers hardness values (Hᵥ, in GPa) were calculated using the following formula and the values of all 10 indents per load were averaged:

$${H}_{v} = \frac{1854.4 F}{{d}^{2}}$$

where d is the arithmetic average length of the diagonals of each indent in microns and F is the applied load in Newtons (N).

Fracture Toughness was determined using the Palmqvist method utilizing a Vickers microindentor with measurements of the crack length to determine the K ic of the material, such as seen in ASTM C₁₄₂₁ —18, ASTM STP36630S, and ASTM STP36628S. The crack length of the indentation must fall within the Palmqvist regime to qualify for this determination methodology for this composite material.

Density (p) measurements were performed utilizing a density determination kit (Mettler-Toledo, U.S.A.) by measuring the weights of the samples in air and in an auxiliary liquid (ethanol); the density was calculated using the following formula:

$$ρ = \frac{A}{A - B} ( {ρ}_{0} - {ρ}_{L} ) + {ρ}_{L}$$

where A is the weight of the sample in air, Bis the weight of the sample in the auxiliary liquid (ethanol), p₀ is the density of auxiliary liquid (ethanol—0.789 g/cm³), and ρ_{L} is the density of air (0.0012 g/cm³).

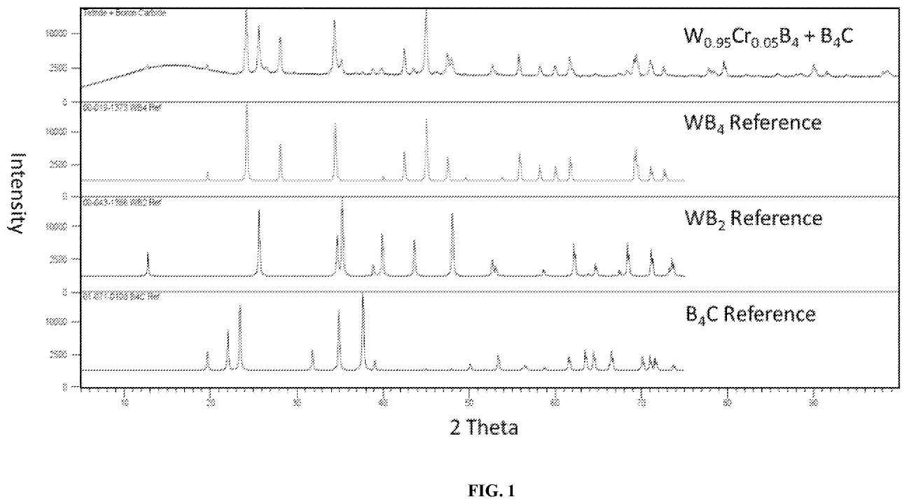

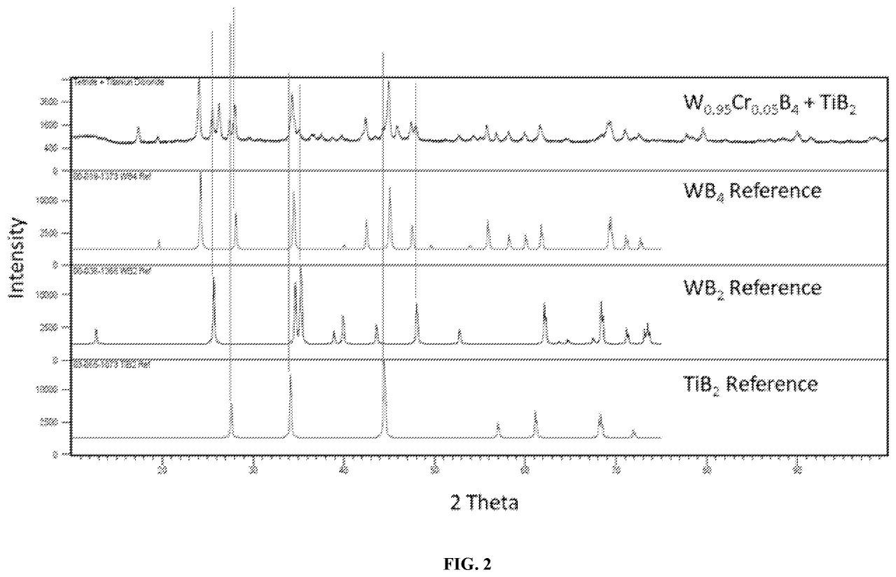

Composites (W_{0.95}Cr_{0.05}B₄)_{90%(}TiB₂)_{10%} and (W_{0.95}Cr_{0.05}B₄)_{90%}(B₄C)₁₀% were analyzed by X-ray Powder Diffraction. FIG. 1 shows a comparison of diffractograms W_{0.95}Cr_{0.05}B₄)_{90%}(B₄C)₁₀%, WB₄, WB₂, and B₄C. FIG. 2 shows a comparison of diffractograms W_{0.95}Cr_{0.05}B₄)_{90%}(TiB₂)_{10%}, WB₄, WB₂, and TiB₂. Note that the diffraction patterns of W_{0.95}Cr_{0.05}B₄ and WB₄ are near identical. Both figures show the presence of W_{0.95}Cr_{0.05}B₄, WB₂ (grain boundaries), and the ceramic in each of the composite matrices.

### Example 3. Radiation Shielding Using (W₁₋ₓMoₓB₄)_{z}(B₄C)ₙ Radiation Shielding Device

A composite matrix made up of (W₁₋ₓMoₓB₄)_{z}(B₄C)ₙ (see Table 3) is used to prepare radiation shielding devices that have a curved plating configuration. The curved plates are arranged together to form a blanket-shield assembly configured to surround the plasma generated by a tokamak plasma fusion reactor. The curved plates are then tested to determine the degree of radiation shielding and/or attenuation in milliSieverts/day or total radiation dosage that passes through the shield per unit area.

### Example 4. Radiation Shielding Using (W₁₋ₓMoₓB₄)_{z}(B₄C)ₙ Radiation Shielding Resin

Particles of a composite matrix made up of (W₁₋ₓMoₓB₄)_{z}(B₄C)ₙ (see Table 3) are combined with binders to form a liquid UV-curable resin. The liquid resin is then applied onto a metal substrate to form a surface coating at a desired level of thickness to form a blanket-shield. The resin is then cured by exposure to UV radiation from a UV lamp. The hardened resin is then tested to determine the degree of radiation shielding and/or attenuation in milliSieverts/day or total radiation dosage that passes through the shield per unit area.

### Example 5. Radiation Shield Capacity

A composite matrix made up of (W₁₋ₓMoₓB₄)_{z}(B₄C)ₙ (see Table 3) is used to prepare radiation shielding devices and the attenuation of the devices are measured against the bombardment of thermal neutrons and gamma rays. A sample of a known composition of particular dimensions (eg. 50 mm in dia., 2 mm thick) is be loaded into system and subjected to a beam of thermalized, collimated neutrons from a source, for a particular amount of time. The time exposure is determined by which “reference standard” (calibration material) is used to set up the experiment. Results are indicated by a measured fluence of thermal neutrons for the reference material and the test material.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### Additional Embodiments

Embodiment 1. A method of shielding a protected target, the method comprising: a) positioning a radiation shield comprising a composite matrix of Formula I, Formula II, Formula III, or Formula IV in the path of a potential source of radiation travelling to a protected target, wherein the radiation comprises atomic bombardment, nuclear radiation, or electromagnetic radiation, and optionally physical impingement; and b) reducing the exposure of the protected target to the radiation, wherein a composite matrix of Formula I, Formula II, Formula III, or Formula IV comprises: W₁₋ₓMoₓB4 (Formula I); (W1-xMxB4)z(Q)n (Formula II); (W1−xMxB4)z (T)q (Formula III); or (W1−xMxB4)_{z}(T)_{q}(Q)ₙ (Formula IV), wherein, M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al); Q is one or more ceramics, wherein each of the one or more ceramics comprises at least two elements, and at least one of the two elements is B (boron), C (carbon), Si (silicon), N (nitrogen), or O (oxygen); T is (i) at least one element that comprises a group 4, 5, 6, 7, 8, 9, 10, 11, 12, 13, or 14 transition metal element in the Periodic Table of Elements or (ii) an alloy which is a combination of two or more group 4, 5, 6, 7, 8, 9, 10, 11, 12, 13, or 14 transition metal elements in the Periodic Table of Elements; x is a molar ratio from 0 to 0.999; z is a volume percent from 0.001 to 0.999 (0.1% to 99.9%); n is a volume percent from 0.001 to 0.999 (0.10% to 99.9%); q is a volume percent from 0.001 to 0.999 (0.1% to 99.9%); the sum of n and z is 1 (100%) in Formula II; the sum of z and q is 1 (100%) in Formula III; the sum of z, q, and n is 1 (100%) in Formula IV; and optionally, the boron content of a composite matrix of Formula I, Formula II, Formula III, or Formula IV is isotopically enriched with boron-10 (10B), and wherein x is from 0.001 to 0.999 for a composite matrix of Formula I. Embodiment 2. The method of embodiment 1, wherein W1−x MoₓB₄ is a crystalline solid characterized by at least one X-ray diffraction pattern reflection at 2 theta=24.2±±0.3. Embodiment 3. The composite matrix of embodiment 2, wherein the crystalline solid is further characterized by at least one X-ray diffraction pattern reflection at 2 theta=34.5±±0.3 or 45.1±0.3. Embodiment 4. The method of embodiment 2 or 3, wherein the crystalline solid is further characterized by at least one X-ray diffraction pattern reflection at 2 theta=47.5±0.3, 61.8±0.3, 69.2±0.3, 69.4±0.3, 79.7±±0.3, 89.9±0.3, or 110.2±0.3. Embodiment 5. The method of any one of embodiments 2 to 4, wherein the crystalline solid is further characterized by at least five X-ray diffraction pattern reflections at 2 theta=28.1±±0.3, 34.5±±0.3, 42.5±±0.3, 45.1±±0.3, 47.5±±0.3, 55.9±±0.3, 61.8±±0.3, 69.2±±0.3, 69.4±±0.3, 79.7±0.3, 89.9±±0.3, or 110.2±0.3. Embodiment 6. The method of any one of embodiments 1 to 5, wherein x is 0.001 to 0.6. Embodiment 7. The method of embodiment 6, wherein x is 0.001 to 0.4. Embodiment 8. The method of any one of embodiments 1 to 7, wherein M is one or more of Cr, Ta, Mo, or Mn. Embodiment 9. The method of any one of embodiments 1 to 8, wherein M is Cr; Mn; Mo; Ta and Cr; or Ta and Mo. Embodiment 10. The method of embodiment 9, wherein M is Cr, and x is at least 0.001 and less than 0.4. Embodiment 11. The method of embodiment 10, wherein x is at least 0.01 and less than 0.3. Embodiment 12. The method of embodiment 11, wherein x is at least 0.01 and less than 0.10. Embodiment 13. The method of embodiment 12, wherein x is about 0.05. Embodiment 14. The method of embodiment 9, wherein M is Mo, and x is at least 0.001 and less than 0.4. Embodiment 15. The method of embodiment 14, wherein x is at least 0.001 and less than 0.2. Embodiment 16. The method of embodiment 15, wherein x is at least 0.001 and less than 0.05. Embodiment 17. The method of embodiment 16, wherein x is about 0.025. Embodiment 18. The method of embodiment 9, wherein M is Mn, and x is at least 0.001 and less than 0.4. Embodiment 19. The method of embodiment 18, wherein x is at least 0.001 and less than 0.2. Embodiment 20. The method of embodiment 19, wherein x is at least 0.001 and less than 0.06. Embodiment 21. The method of embodiment 20, wherein x is about 0.03. Embodiment 22. The method of embodiment 9, wherein M is Cr and Ta, and x is at least 0.001 and less than 0.4. Embodiment 23. The method of embodiment 22, wherein x is at least 0.001 and less than 0.3. Embodiment 24. The method of embodiment 23, wherein x is at least 0.03 and less than 0.2. Embodiment 25. The method of embodiment 24, wherein x is about 0.07. Embodiment 26. The method of embodiment 25, wherein W1−xMxB4 is W0.93Ta0.02Cr0.05B4. Embodiment 27. The method of embodiment 9, wherein M is Ta and Mo, and x is at least 0.01 and less than 0.4. Embodiment 28. The method of embodiment 27, whereinx is at least 0.001 and less than 0.3. Embodiment 29. The method of embodiment 28, wherein x is about 0.06. Embodiment 30. The method of embodiment 29, wherein W1−xMxB4 is W0.94Ta0.02Mo0.04B4. Embodiment 31. The method of embodiment 1, wherein the composite matrix is of Formula II, Formula III, or Formula IV and x is 0. Embodiment 32. The method of any one of embodiment 1 to 31, wherein the one or more ceramics comprises at least B, C, Si, or N. Embodiment 33. The method of embodiment 32, wherein the one or more ceramic s comprises at least B, C, or Si. Embodiment 34. The method of any one of embodiment 1 to 31, wherein the one or more ceramics comprises at least O. Embodiment 35. The method of embodiment 33, wherein the one or more ceramics comprises at least B. Embodiment 36. The method of embodiment 33, wherein the one or more ceramics comprises at least C. Embodiment 37. The method of embodiment 33, wherein the one or more ceramics comprises at least N. Embodiment 38. The method of embodiment 33, wherein the one or more ceramics comprises at least Si. Embodiment 39. The method of any one of embodiment 1 to 38, wherein the one or more ceramics comprises one or more metal selected from Ti, Zr, Hf, V, Nb, Ta, Cr, Mo, W, Mn, Re, Fe, and Ru. Embodiment 40. The method of embodiment 39, wherein the one or more ceramics comprises one or more metal selected from Cr, Mo, W, Mn, Re, Fe, and Ru. Embodiment 41. The method of embodiment 40, wherein the one or more ceramics comprises one or more metal selected from Ti, Zr, Hf, V, Nb, and Ta. Embodiment 42. The method of any one of embodiment 1 to 31, wherein Q is one or more ceramics selected from TiB₂, TaB₂, FeB₄, RuB₂, Ru₂B₃, ReB₂, B₄C, B₄Si, cubic-BN, BCN, BC₂N, B₂O₃, B₆O, TiC, ZrC, VC, NbC, NbC₂, TaC, Cr₃C₂, MoC, MoC₂, SiC, TiN, ZrN, TiSi, TiSi₂, Ti₅Si₃, SiAlON, Si₃N₄, TiO₂, ZrO₂, Al₂O₃, and SiO₂. Embodiment 43. The method of embodiment 42, wherein Q is one or more ceramics selected from TiB₂, TaB₂, FeB₄, RuB₂, Ru₂B₃, ReB₂, B₄C, B₄Si, cubic-BN, BCN, BC₂N, B₂O₃, and B₆O. Embodiment 44. The method of embodiment 42, wherein Q is one or more ceramics selected from B₄C, BCN, BC₂N, TiC, ZrC, VC, NbC, NbC₂, TaC, MoC, MoC₂, and SiC. Embodiment 45. The method of embodiment 42, wherein Q is one or more ceramics selected from cubic-BN, BCN, BC₂N, TiN, ZrN, SiAlON, and Si₃N₄. Embodiment 46. The method of embodiment 42, wherein Q is one or more ceramics selected from cubic-BN, BCN, BC₂N, TiN, ZrN, SiAlON, and Si₃N₄. Embodiment 47. The method of embodiment 42, wherein Q is one or more ceramics selected from SiC, TiSi, TiSi₂, Ti₅Si₃, SiAlON, Si₃N₄, and SiO₂. Embodiment 48. The method of embodiment 42, wherein Q is one or more ceramics selected from TiB₂, SiC, or B₄C. Embodiment 49. The method of embodiment 1, wherein the M is Cr; x is 0.05; and Q is a ceramic selected from TiB₂, SiC, or B₄C, and n is 5-20%. Embodiment 50. The method of any one of embodiments 1 to 49, wherein n is from 1% to 50%. Embodiment 51. The method of embodiment 50, wherein n is from 5% to 40%. Embodiment 52. The method of embodiment 51, wherein n is from 10% to 30%. Embodiment 53. The method of embodiment 52, wherein n is from 10% to 20%. Embodiment 54. The method of embodiment 53, wherein n is from 10% to 15%. Embodiment 55. The method of any one of embodiment 1 to 54, wherein the Vicker's Hardness of the composite is from 18-30 GPa measured at 9.8 N (1 kg force load). Embodiment 56. The method of any one of embodiments 1 to 55, wherein the Palmquist Toughness of the composite is from 1-10 MPam1/2. Embodiment 57. The method of embodiment 56, wherein the Palmquist Toughness of the composite is from 2-8. Embodiment 58. The method of embodiment any one of embodiments 1 to 57, wherein the density is from 3-8 g/cm³. Embodiment 59. The method of embodiment 58, wherein the density is from 5-7 g/cm³. Embodiment 60. The method of any one of the embodiments 1 to 59, wherein T is an alloy comprising two or more Group 4, 5, 6, 7, 8, 9, 10, 11, 12, 13, or 14 elements. Embodiment 61. The method of any one of the embodiments 1 to 59, wherein T is an alloy comprising two to eight Group 4, 5, 6, 7, 8, 9, 10, 11, 12, 13, or 14 elements. Embodiment 62. The method of any one of the embodiments 1 to 59, wherein T is an alloy comprising at least one Group 8, 9, 10, 11, 12, 13 or 14 element in the Periodic Table of Elements. Embodiment 63. The method of any one of the embodiments 1 to 59, wherein T is an alloy comprising two or more, three or more, four or more, five or more, or six or more Group 4, 5, 6, 7, 8, 9, 10, 11, 12, 13, or 14 elements in the Periodic Table of Elements. Embodiment 64. The method of any one of the embodiments 1 to 59, wherein T is an alloy comprising at least one element selected from Cu, Ni, Co, Fe, Si, Al and Ti, or any combinations thereof. Embodiment 65. The method of any one of the embodiments 1 to 59, wherein T is an alloy comprising at least one element selected from Co, Ni, Fe, Si, Ti, W, Sn, Ta, or any combinations thereof. Embodiment 66. The method of any one of the embodiments 1 to 59, wherein T is an alloy comprising Co. Embodiment 67. The method of any one of the embodiments 1 to 59, wherein T is an alloy comprising Fe. Embodiment 68. The method of any one of the embodiments 1 to 59, wherein T is an alloy comprisingNi. Embodiment 69. The method of any one of the embodiments 1 to 59, wherein T is an alloy comprising Co and Ni. Embodiment 70. The method of any one of the embodiments 1 to 59, wherein T is an alloy comprising Co, Fe, and Ni. Embodiment 71. The method of any one of the embodiments 1 to 59, wherein T is an alloy comprising Sn. Embodiment 72. The method of any one of the embodiments 1 to 59, wherein T is an alloy comprising W. Embodiment 73. The method of any one of the embodiments 1 to 59, wherein T is an alloy comprising Cu. Embodiment 74. The method of any one of the embodiments 1 to 59, wherein T is an alloy comprising Al. Embodiment 75. The method of any one of the embodiments 1 to 59, wherein T is an alloy comprising Cr. Embodiment 76. The method of any one of the embodiments 1 to 59, wherein T is an alloy comprising Ti. Embodiment 77. The method of any one of the embodiments 1 to 59, wherein T is an alloy comprising from about 40 wt. % to about 60 wt. % of Cu, from about 10 wt. % to about 20 wt. % of Co, from 0 wt. % to about 7 wt. % of Sn, from about 5 wt. % to about 15 wt. % of Ni, and from about 10 wt. % to about 20 wt. % W. Embodiment 78. The method of any one of the embodiments 1 to 59, wherein T is an alloy comprising about 50 wt. % of Cu, about 20 wt. % of Co, about 5 wt. % of Sn, about 10 wt. % of Ni, and about 15 wt. % of W. Embodiment 79. The method of any one of the embodiments 1 to 59, wherein q is from 1% to 80%. Embodiment 80. The method of any one of the embodiments 1 to 59, wherein q is from 1% to 50%. Embodiment 81. The method of any one of the embodiments 1 to 59, wherein q is from 1% to 30%. Embodiment 82. The method of any one of the embodiments 1 to 59, wherein q is from 5% to 30%. Embodiment 83. The method of any one of the embodiments 1 to 82, wherein the boron content of the overall composite is isotopically enriched with boron-10 (10B). Embodiment 84. The method of embodiment 83, wherein the boron-10 content is at least 20%, at least 25%, at least 50%, at least 75%, at least 90%, at least 95%, or at least 99%. Embodiment 85. The method of any one of the embodiments 1 to 84, wherein the composite matrix comprises a composite matrix of Formula I or Formula II. Embodiment 86. The method of any one of the embodiments 1 to 85, wherein the composite matrix is composite matrix of Formula II. Embodiment 87. The method of embodiment 86, wherein the one or more ceramics comprises at least B or C. Embodiment 88. The method of embodiment 87, wherein Q is one or more ceramics selected from TiB₂, TaB₂, FeB₄, RuB₂, Ru₂B₃, ReB₂, B₄C, B₄Si, cubic-BN, BCN, BC₂N, B₂O₃, and B₆O. Embodiment 89. The method of embodiment 87, wherein Q is one or more ceramics selected from B₄C, BCN, BC₂N, TiC, ZrC, VC, NbC, NbC₂, TaC, MoC, MoC₂, and SiC. Embodiment 90. The method of embodiment 88 or 89, wherein Q is one or more ceramics selected from TiB₂, SiC, B₄Si, and B₄C. Embodiment 91. The method of embodiment 90, wherein Q is B₄C. Embodiment 92. The method of embodiment 90, wherein Q is TiB₂. Embodiment 93. The method of any one of embodiments 1 to 92, wherein the radiation is a byproduct of an atomic fusion or atomic fission reaction. Embodiment 94. The method of any one of embodiments 1 to 93, wherein the radiation is atomic bombardment. Embodiment 95. The method of embodiment 94, wherein the atomic bombardment comprises the bombardment of any atom, particle, or energy emitted from an atomic fusion or atomic fission reaction. Embodiment 96. The method of embodiment 95, wherein the atomic bombardment comprises bombardment by atoms, the particles that make up atoms, or any combination thereof. Embodiment 97. The method of embodiment 96, wherein the particles that make up an atom comprises neutrons, protons, electrons, or any combination thereof. Embodiment 98. The method of any one of embodiments 1 to 97, wherein the atomic bombardment is neutron bombardment. Embodiment 99. The method of embodiment 98, wherein the neutron bombardment is a byproduct of radioactive decay. Embodiment 10. The method of embodiment 98, wherein the neutron bombardment is a byproduct of nuclear fission or nuclear fusion. Embodiment 101. The method of embodiment 100, wherein the neutron bombardment is a byproduct of a nuclear fusion reaction. Embodiment 102. The method of embodiment 101, wherein the neutron bombardment is a byproduct of a thermonuclear fusion reaction. Embodiment 103. The method of embodiment 102, wherein the thermonuclear fusion reaction is a plasma fusion reaction. Embodiment 104. The method of embodiment 102, wherein the thermonuclear fusion reaction occurs within a fusion reactor with magnetic confinement. Embodiment 105. The method of embodiment 104, wherein the fusion reactor is a toroidal reactor such as a Z-pinch reactor, stellarator reactor, tokamak reactor, or compacted toroid reactor. Embodiment 106. The method of any one of the embodiments 104 or 105, wherein the fusion reactor is tokamak reactor. Embodiment 107. The method of any one of embodiments 1 to 92, wherein the radiation is atomic bombardment, nuclear radiation, electromagnetic radiation, or any combination thereof, wherein the radiation is a byproduct of a fusion reaction produced by thermonuclear fusion. Embodiment 108. The method of embodiment 107, wherein thermonuclear fusion comprises inertial confinement fusion, inertial electrostatic confinement, beam-beam/beam-target fusion, muon-catalyzed fusion, antimatter initialized fusion, pyroelectric fusion, or hybrid nuclear fusion-fission. Embodiment 109. The method of embodiment 107, wherein the thermonuclear fusion reaction occurs within a fusion reactor with magnetic confinement such as a Z-pinch reactor, stellarator reactor, tokamak reactor, or compacted toroid reactor. Embodiment 110. The method of embodiment 108, wherein the thermonuclear reaction is a beam-beam/beam-target fusion reaction. Embodiment 111. The method of embodiment 110, wherein the fusion reaction occurs within a fusion reactor such as a field-reverse configuration (FRC) reactor. Embodiment 112. The method of any one of embodiments 1 to 111, wherein radiation shield the reduces the exposure of the protected target to the radiation by at least 10%, at least 20%, at least 30%, at least 40%, at least 50%, at least 60%, at least 70%, at least 80%, at least 90%, at least 95%, or at least 99%. Embodiment 113. The method of any one of embodiments 1 to 92, wherein the radiation shield is resistant to physical impingement. Embodiment 114. The method of any one of embodiments 1 to 113, wherein the radiation shield is wear resistant to mechanical and thermal cycling. Embodiment 115. The method of any one of embodiments 1 to 114, wherein the radiation shield is configured to have a geometric shape. Embodiment 116. The method of embodiment 115, wherein the radiation shield is shaped as a plate, a cylinder, or a tile. Embodiment 117. The method of any one of embodiments 1-116, wherein the radiation shield comprises one or more additional layers of a radiation shielding material. Embodiment 118. The method of any one of embodiments 1-117, wherein the radiation shield comprises a structural component having a surface upon which the composite matrix is disposed. Embodiment 119. The method of embodiment 118, wherein the structural component is an enclosure or wall surrounding at least a portion of a nuclear reactor. Embodiment 120. The method of embodiment 118, wherein the structural component forms at least a portion of an aircraft hull, optionally wherein the structural component comprises aluminum, carbon fiber, ceramic, or any combination thereof.

Embodiment 121. A radiation shield configured to shield from radiation, the shield comprising: a composite matrix of Formula I, Formula II, Formula III, or Formula IV, wherein the radiation comprises atomic bombardment, nuclear radiation, or electromagnetic radiation, and optionally physical impingement; and wherein a composite matrix of Formula I, Formula II, Formula III, or Formula IV comprises: W1−xMxB4 (Formula I); (W1−xMxB4)z(Q)n (Formula II); (W1−xMxB4)z(T)q (Formula III); or (W1−xMxB4)z(T)q(Q)n (Formula IV), wherein, M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al); Q is one or more ceramics, wherein each of the one or more ceramics comprises at least two elements, and at least one of the two elements is B (boron), C (carbon), Si (silicon), N (nitrogen), or O (oxygen); T is (i) at least one element that comprises a group 4, 5, 6, 7, 8, 9, 10, 11, 12, 13, or 14 transition metal element in the Periodic Table of Elements or (ii) an alloy which is a combination of two or more group 4, 5, 6, 7, 8, 9, 10, 11, 12, 13, or 14 transition metal elements in the Periodic Table of Elements; x is a molar ratio from 0 to 0.999; z is a volume percent from 0.001 to 0.999 (0.1% to 99.9%); n is a volume percent from 0.001 to 0.999 (0.10% to 99.9%); q is a volume percent from 0.001 to 0.999 (0.1% to 99.9%); the sum of n and z is 1 (100%) in Formula II; the sum of z and q is 1 (100%) in Formula III; the sum of z, q, and n is 1 (100%) in Formula IV; wherein the composite matrix has a porosity of at least 10%; and optionally, the boron content of a composite matrix of Formula I, Formula II, Formula III, or Formula IV is isotopically enriched with boron-10 (10B), and wherein x is from 0.001 to 0.999 for a composite matrix of Formula I.

Embodiment 122. A liquid composition configured to form a radiation shield, the shield comprising: a composite matrix of Formula I, Formula II, Formula III, or Formula IV, wherein the radiation comprises atomic bombardment, nuclear radiation, or electromagnetic radiation, and optionally physical impingement; and wherein a composite matrix of Formula I, Formula II, Formula III, or Formula IV comprises: W1−xMxB4 (Formula I); (W1−xMxB4)z(Q)n (Formula II); (W1−xMxB4)z(T)q (Formula III); or (W1−xMxB4)z(T)q(Q)n (Formula IV), wherein, M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al); Q is one or more ceramics, wherein each of the one or more ceramics comprises at least two elements, and at least one of the two elements is B (boron), C (carbon), Si (silicon), N (nitrogen), or O (oxygen); T is (i) at least one element that comprises a group 4, 5, 6, 7, 8, 9, 10, 11, 12, 13, or 14 transition metal element in the Periodic Table of Elements or (ii) an alloy which is a combination of two or more group 4, 5, 6, 7, 8, 9, 10, 11, 12, 13, or 14 transition metal elements in the Periodic Table of Elements; x is a molar ratio from 0 to 0.999; z is a volume percent from 0.001 to 0.999 (0.1% to 99.9%); n is a volume percent from 0.001 to 0.999 (0.1% to 99.9%); q is a volume percent from 0.001 to 0.999 (0.1% to 99.9%); the sum of n and z is 1 (100%) in Formula II; the sum of z and q is 1 (100%) in Formula III; the sum of z, q, and n is 1 (100%) in Formula IV; and optionally, the boron content of a composite matrix of Formula I, Formula II, Formula III, or Formula IV is isotopically enriched with boron-10 (10B); and one or more binders configured to allow curing of the liquid composition to form a solid radiation shield.

Embodiment 123. A method of forming a solid radiation shield, comprising spraying or applying the liquid composition of embodiment 122 onto a surface of a structural component, and curing the liquid composition.

Embodiment 124. A liquid composition configured to form a radiation shield, the shield comprising: a composite matrix of Formula I, Formula II, Formula III, or Formula IV, wherein the radiation comprises atomic bombardment, nuclear radiation, or electromagnetic radiation, and optionally physical impingement; and wherein a composite matrix of Formula I, Formula II, Formula III, or Formula IV comprises: W1−xMxB4 (Formula I); (W1−xMxB4)z(Q)n (Formula II); (W1−xMxB4)z(T)q (Formula III); or (W1−xMxB4)z(T)q(Q)n (Formula IV), wherein, M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al); Q is one or more ceramics, wherein each of the one or more ceramics comprises at least two elements, and at least one of the two elements is B (boron), C (carbon), Si (silicon), N (nitrogen), or O (oxygen); T is (i) at least one element that comprises a group 4, 5, 6, 7, 8, 9, 10, 11, 12, 13, or 14 transition metal element in the Periodic Table of Elements or (ii) an alloy which is a combination of two or more group 4, 5, 6, 7, 8, 9, 10, 11, 12, 13, or 14 transition metal elements in the Periodic Table of Elements; x is a molar ratio from 0 to 0.999; z is a volume percent from 0.001 to 0.999 (0.1% to 99.9%); n is a volume percent from 0.001 to 0.999 (0.10% to 99.9%); q is a volume percent from 0.001 to 0.999 (0.1% to 99.9%); the sum of n and z is 1 (100%) in Formula II; the sum of z and q is 1 (100%) in Formula III; the sum of z, q, and n is 1 (100%) in Formula IV; and optionally, the boron content of a composite matrix of Formula I, Formula II, Formula III, or Formula IV is isotopically enriched with boron-10 (10B); and one or more binders to allow the liquid composition to form a thermoset plastic radiation shield.

Embodiment 125. A method of forming a solid radiation shield, comprising preparing the liquid composition of embodiment 124 and melting, pressing, or injection molding the liquid composition into the thermoset plastic radiation shield.

Embodiment 126. A method of regenerating the radiation shield of any one of embodiments 1 to 125 comprising: a) exposing the radiation shield to water for a period of time sufficient to form at least B₂O₃ and metal oxides, and b) removing the B₂O₃ and metal oxides to yield a surface of the composite matrix with an increase in boron-10 relative to the formation and removal of the B₂O₃ and metal oxides.

What is claimed is:

1. A method of shielding a protected target, the method comprising:
a) positioning a radiation shield comprising a composite matrix of Formula I, Formula II, Formula III, or Formula IV in the path of a potential source of radiation travelling to a protected target, wherein the radiation comprises atomic bombardment, nuclear radiation, or electromagnetic radiation, and optionally physical impingement; and
b) reducing the exposure of the protected target to the radiation,
wherein a composite matrix of Formula I, Formula II, Formula III, or Formula IV comprises:
W₁₋ₓMoₓB₄ (Formula I);
(W₁₋ₓMoₓB₄)_{z}(Q)ₙ (Formula II);
(W₁₋ₓMoₓB₄)_{z}(T)_{q} (Formula III); or
(W₁₋ₓMoₓB₄)_{z}(T)_{q}(Q)ₙ (Formula IV),
wherein,
M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al);
Q is one or more ceramics, wherein each of the one or more ceramics comprises at least two elements, and at least one of the two elements is B (boron), C (carbon), Si (silicon), N (nitrogen), or O (oxygen);
T is (i) at least one element that comprises a group 4, 5, 6, 7, 8, 9, 10, 11, 12, 13, or 14 transition metal element in the Periodic Table of Elements or (ii) an alloy which is a combination of two or more group 4, 5, 6, 7, 8, 9, 10, 11, 12, 13, or 14 transition metal elements in the Periodic Table of Elements;
x is a molar ratio from 0 to 0.999;
z is a volume percent from 0.001 to 0.999 (0.1% to 99.9%);
n is a volume percent from 0.001 to 0.999 (0.1% to 99.9%);
q is a volume percent from 0.001 to 0.999 (0.1% to 99.9%);
the sum of n and z is 1 (100%) in Formula II;
the sum of z and q is 1 (100%) in Formula III;
the sum of z, q, and n is 1 (100%) in Formula IV;
and optionally, the boron content of a composite matrix of Formula I, Formula II, Formula III, or Formula IV is isotopically enriched with boron-10 (¹⁰B), and
wherein x is from 0.001 to 0.999 for a composite matrix of Formula I.

2. The method of claim 1, wherein W₁₋ₓMoₓB₄ is a crystalline solid characterized by at least one X-ray diffraction pattern reflection at 2 theta=24.2±±0.3.

3. The composite matrix of claim 2, wherein the crystalline solid is further characterized by at least one X-ray diffraction pattern reflection at 2 theta=34.5±±0.3 or 45.1±±0.3.

4. The method of any one of claims 1 to 3, wherein x is 0.001 to 0.6.

5. The method of any one of claims 1 to 4, wherein M is one or more of Cr, Ta, Mo, or Mn.

6. The method of any one of claims 1 to 3, wherein x is 0.

7. The method of any one of claims 1 to 6, wherein the composite matrix is of Formula II or Formula IV.

8. The method of claim 7, wherein the one or more ceramics comprises at least B, C, or Si.

9. The method of any one of claim 7 to 8, wherein the one or more ceramics comprises one or more metal selected from Ti, Zr, Hf, V, Nb, Ta, Cr, Mo, W, Mn, Re, Fe, and Ru.

10. The method of any one of claim 7 to 9, wherein Q is one or more ceramics selected from TiB₂, TaB₂, FeB₄, RuB₂, Ru₂B₃, ReB₂, B₄C, B₄Si, cubic-BN, BCN, BC₂N, B₂O₃, B₆O, TiC, ZrC, VC, NbC, NbC₂, TaC, Cr₃C₂, MoC, MoC₂, SiC, TiN, ZrN, TiSi, TiSi₂, Ti₅Si₃, SiAlON, Si₃N₄, TiO₂, ZrO₂, Al₂O₃, and SiO₂.

11. The method of claim 10, wherein Q is one or more ceramics selected from TiB₂, SiC, or B₄C.

12. The method of any one of claims 7 to 11, wherein n is from 1% to 50%.

13. The method of claim 12, wherein the Palmquist Toughness of the composite is from 2-8 g/cm³.

14. The method of any one of the claims 1 to 13, wherein T is an alloy comprising at least one element selected from Cu, Ni, Co, Fe, Si, Al and Ti, or any combinations thereof.

15. The method of any one of the claims 1 to 14, wherein the boron content of the overall composite is isotopically enriched with boron-10 (¹⁰B).

16. The method of claim 15, wherein the boron-10 content is at least 20%, at least 25%, at least 50%, at least 75%, at least 90%, at least 95%, or at least 99%.

17. The method of any one of claims 1 to 16, wherein the radiation is a byproduct of an atomic fusion or atomic fission reaction.

18. The method of any one of claims 1 to 17, wherein the radiation is atomic bombardment.

19. The method of claim 18, wherein the atomic bombardment comprises the bombardment of any atom, particle, or energy emitted from an atomic fusion or atomic fission reaction.

20. The method of 19, wherein the atomic bombardment comprises bombardment by atoms, the particles that make up atoms, or any combination thereof.

21. The method of claim 20, wherein the particles that make up an atom comprises neutrons, protons, electrons, or any combination thereof.

22. The method of claim 21, wherein the atomic bombardment is neutron bombardment.

23. The method of claim 17, wherein the fusion reaction occurs within a fusion reactor with magnetic confinement.

24. The method of claim 23, wherein the fusion reactor is a toroidal reactor such as a Z-pinch reactor, stellarator reactor, tokamak reactor, or compacted toroid reactor.

25. The method of any one of the claim 23 or 24, wherein the fusion reactor is tokamak reactor.

26. The method of any one of claims 1 to 25, wherein radiation shield the reduces the exposure of the protected target to the radiation by at least 10%, at least 20%, at least 30%, at least 40%, at least 50%, at least 60%, at least 70%, at least 80%, at least 90%, at least 95%, or at least 99%.

27. The method of any one of claims 1 to 26, wherein the radiation shield comprises a structural component having a surface upon which the composite matrix is disposed.

28. The method of claim 27, wherein the structural component is an enclosure or wall surrounding at least a portion of a nuclear reactor.

29. The method of claim 27, wherein the structural component forms at least a portion of an aircraft hull, optionally wherein the structural component comprises aluminum, carbon fiber, ceramic, or any combination thereof.

30. A radiation shield configured to shield from radiation, the shield comprising:
a composite matrix of Formula I, Formula II, Formula III, or Formula IV,
wherein the radiation comprises atomic bombardment, nuclear radiation, or electromagnetic radiation, and optionally physical impingement; and
wherein a composite matrix of Formula I, Formula II, Formula III, or Formula IV comprises:
W₁₋ₓMoₓB₄ (Formula I);
(W₁₋ₓMoₓB₄)_{z}(Q)ₙ (Formula II);
(W₁₋ₓMoₓB₄)_{z}(T)_{q} (Formula III); or
(W₁₋ₓMoₓB₄)_{z}(T)_{q}(Q)ₙ (Formula IV),
wherein,
M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al);
Q is one or more ceramics, wherein each of the one or more ceramics comprises at least two elements, and at least one of the two elements is B (boron), C (carbon), Si (silicon), N (nitrogen), or O (oxygen);
T is (i) at least one element that comprises a group 4, 5, 6, 7, 8, 9, 10, 11, 12, 13, or 14 transition metal element in the Periodic Table of Elements or (ii) an alloy which is a combination of two or more group 4, 5, 6, 7, 8, 9, 10, 11, 12, 13, or 14 transition metal elements in the Periodic Table of Elements;
x is a molar ratio from 0 to 0.999;
z is a volume percent from 0.001 to 0.999 (0.1% to 99.9%);
n is a volume percent from 0.001 to 0.999 (0.1% to 99.9%);
q is a volume percent from 0.001 to 0.999 (0.1% to 99.9%);
the sum of n and z is 1 (100%) in Formula II;
the sum of z and q is 1 (100%) in Formula III;
the sum of z, q, and n is 1 (100%) in Formula IV;
wherein the composite matrix has a porosity of at least 10%;
and optionally, the boron content of a composite matrix of Formula I, Formula II, Formula III, or Formula IV is isotopically enriched with boron-10 (¹⁰B), and
wherein x is from 0.001 to 0.999 for a composite matrix of Formula I.

31. A liquid composition configured to form a radiation shield, the shield comprising:
a composite matrix of Formula I, Formula II, Formula III, or Formula IV,
wherein the radiation comprises atomic bombardment, nuclear radiation, or electromagnetic radiation, and optionally physical impingement; and
wherein a composite matrix of Formula I, Formula II, Formula III, or Formula IV comprises:
W₁₋ₓMoₓB₄ (Formula I);
(W₁₋ₓMoₓB₄)_{z}(Q)ₙ (Formula II);
(W₁₋ₓMoₓB₄)_{z}(T)_{q} (Formula III); or
(W₁₋ₓMoₓB₄)_{z}(T)_{q}(Q)ₙ (Formula IV),
wherein,
M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al);
Q is one or more ceramics, wherein each of the one or more ceramics comprises at least two elements, and at least one of the two elements is B (boron), C (carbon), Si (silicon), N (nitrogen), or O (oxygen);
T is (i) at least one element that comprises a group 4, 5, 6, 7, 8, 9, 10, 11, 12, 13, or 14 transition metal element in the Periodic Table of Elements or (ii) an alloy which is a combination of two or more group 4, 5, 6, 7, 8, 9, 10, 11, 12, 13, or 14 transition metal elements in the Periodic Table of Elements;
x is a molar ratio from 0 to 0.999;
z is a volume percent from 0.001 to 0.999 (0.1% to 99.9%);
n is a volume percent from 0.001 to 0.999 (0.1% to 99.9%);
q is a volume percent from 0.001 to 0.999 (0.1% to 99.9%);
the sum of n and z is 1 (100%) in Formula II;
the sum of z and q is 1 (100%) in Formula III;
the sum of z, q, and n is 1 (100%) in Formula IV;
and optionally, the boron content of a composite matrix of Formula I, Formula II, Formula III, or Formula IV is isotopically enriched with boron-10 (¹⁰B); and
one or more binders configured to allow curing of the liquid composition to form a solid radiation shield.

32. A method of forming a solid radiation shield, comprising spraying or applying the liquid composition of claim 31 onto a surface of a structural component, and curing the liquid composition.

33. A liquid composition configured to form a radiation shield, the shield comprising:
a composite matrix of Formula I, Formula II, Formula III, or Formula IV,
wherein the radiation comprises atomic bombardment, nuclear radiation, or electromagnetic radiation, and optionally physical impingement; and
wherein a composite matrix of Formula I, Formula II, Formula III, or Formula IV comprises:
W₁₋ₓMoₓB₄ (Formula I);
(W₁₋ₓMoₓB₄)_{z}(Q)ₙ (Formula II);
(W₁₋ₓMoₓB₄)_{z}(T)_{q} (Formula III); or
(W₁₋ₓMoₓB₄)_{z}(T)_{q}(Q)ₙ (Formula IV),
wherein,
M is one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), ruthenium (Ru), hafnium (Hf), tantalum (Ta), rhenium (Re), osmium (Os), iridium (Ir), lithium (Li), yttrium (Y) and aluminum (Al);
Q is one or more ceramics, wherein each of the one or more ceramics comprises at least two elements, and at least one of the two elements is B (boron), C (carbon), Si (silicon), N (nitrogen), or O (oxygen);
T is (i) at least one element that comprises a group 4, 5, 6, 7, 8, 9, 10, 11, 12, 13, or 14 transition metal element in the Periodic Table of Elements or (ii) an alloy which is a combination of two or more group 4, 5, 6, 7, 8, 9, 10, 11, 12, 13, or 14 transition metal elements in the Periodic Table of Elements;
x is a molar ratio from 0 to 0.999;
z is a volume percent from 0.001 to 0.999 (0.1% to 99.9%);
n is a volume percent from 0.001 to 0.999 (0.1% to 99.9%);
q is a volume percent from 0.001 to 0.999 (0.1% to 99.9%);
the sum of n and z is 1 (100%) in Formula II;
the sum of z and q is 1 (100%) in Formula III;
the sum of z, q, and n is 1 (100%) in Formula IV;
and optionally, the boron content of a composite matrix of Formula I, Formula II, Formula III, or Formula IV is isotopically enriched with boron-10 (¹⁰B); and
one or more binders to allow the liquid composition to form a thermoset plastic radiation shield.

34. A method of forming a solid radiation shield, comprising preparing the liquid composition of claim 33 and melting, pressing, or injection molding the liquid composition into the thermoset plastic radiation shield.

35. A method of regenerating the radiation shield of any one of claims 1 to 34 comprising:
a) exposing the radiation shield to water for a period of time sufficient to form at least B₂O₃ and metal oxides, and
b) removing the B₂O₃ and metal oxides to yield a surface of the composite matrix with an increase in boron-10 relative to the formation and removal of the B₂O₃ and metal oxides.
